(19) United States
(12) Patent Application Publication
(10) Pub. No.: US 2014/0358698 A1
(43) Pub. Date: Dec. 4, 2014

(54) CONCEPTS FOR ADVERTISING OPPORTUNITIES

(71) Applicant: IZEA, INC., Orlando, FL (US)

(72) Inventor: Edward Murphy, Apopka, FL (US)

(73) Assignee: IZEA, INC., Orlando, FL (US)

(21) Appl. No.: 14/294,433

(22) Filed: Jun. 3, 2014

Related U.S. Application Data
(60) Provisional application No. 61/830,391, filed on Jun. 3, 2013.

(51) Int. Cl. G06Q 30/02

(52) U.S. Cl. CPC G06Q 30/0275
USPC 705/14.71

(57) ABSTRACT

Methods, systems, apparatus, and computer program products are provided for providing advertising opportunities. The concepts for providing advertising opportunities may comprise (i) receiving information associated with an advertising opportunity; (ii) receiving one or more bids associated with the advertising opportunity, wherein each of the one or more bids is associated with an influencer profile; (iii) providing a notification that the one or more bids have been received, the notification provided in accordance with the advertiser profile; and (iv) receiving input indicating advertiser approval of at least one of the one or more bids.

### CROSS-REFERENCE TO RELATED APPLICATIONS

This application claims priority to U.S. Provisional Application Ser. No. 61/830,391 filed Jun. 3, 2013, which is hereby incorporated herein in its entirety.

### BACKGROUND

Embodiments of the present invention are related to providing advertising opportunities. In various embodiments, advertising opportunities harnessing the power of social media are provided.

Social media provides new and expanding avenues for individuals to connect. These avenues for connection may provide peer-to-peer connection, but also provide celebrities or other people or groups having influence over a following or fan-base to connect with that following or fan-base.

### BRIEF SUMMARY

Embodiments of the present invention provide advertising opportunities. For example, influencers/publishers may create a user profile (or a set of associated user profiles) indicating the reach they may have (e.g., indications of size of following or fan-base, demographics related to following or fan-base, and/or the like). In some embodiments, advertisers may also create a user profile. Influencers/publishers and advertisers may then contract with one another for influencers/publishers to provide advertising content in exchange for payment.

In one aspect, methods for providing advertising opportunities are provided. In one embodiment, the method comprises (i) receiving, via one or more processors, information associated with an advertising opportunity, wherein (a) the information comprises an opportunity type and instructions for carrying out the advertising opportunity and (b) the advertising opportunity is associated with an advertiser profile; (ii) receiving, via the one or more processors, one or more bids associated with the advertising opportunity, wherein each of the one or more bids is associated with an influencer profile; (iii) providing, via the one or more processors, a notification that the one or more bids have been received, the notification provided in accordance with the advertiser profile; and (iv) receiving, via the one or more processors, input indicating advertiser approval of at least one of the one or more bids.

In another aspect, systems for providing advertising opportunities are provided. In one embodiment, the system comprises at least one memory storage area, the at least one memory storage area configured to store at least one or more advertiser profiles and one or more influencer profiles. The system also comprises at least one processor. The at least one processor may be configured to at least (i) receive information associated with an advertising opportunity, wherein (a) the information comprises an opportunity type and instructions for carrying out the advertising opportunity and (b) the advertising opportunity is associated with one of the one or more advertiser profiles; (ii) receive one or more bids associated with the advertising opportunity, wherein each of the one or more bids is associated with one of the one or more influencer profiles; (iii) provide a notification that the one or more bids have been received, the notification provided in accordance with the one of the one or more advertiser profiles; and (iv) receive input indicating advertiser approval of at least one of the one or more bids.

In yet another, computer program products for providing advertising opportunities are provided. In one embodiment, a non-transitory computer program product comprising at least one computer-readable storage medium having computer-readable program code portions embodied therein is provided. The computer-readable portions may comprise an executable portion configured for receiving a plurality of data. The data may comprise user profile data associated with one or more advertiser profiles; and user profile data associated with one or more influencer profiles. Additionally, the computer-readable portions may comprise (i) an executable portion configured for receiving information associated with an advertising opportunity, wherein (a) the information comprises an opportunity type and instructions for carrying out the advertising opportunity and (b) the advertising opportunity is associated with one of the one or more advertiser profiles; (ii) an executable portion configured for receiving one or more bids associated with the advertising opportunity, wherein each of the one or more bids is associated with one of the one or more influencer profiles; (iii) an executable portion configured for providing a notification that the one or more bids have been received, the notification provided in accordance with the one of the one or more advertiser profiles; and (iv) an executable portion configured for receiving input indicating advertiser approval of at least one of the one or more bids.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a block diagram of a system architecture that may be used to provide advertising opportunities, in accordance and an embodiment of the present invention;

FIG. 2 provides a schematic of an enterprise computing entity according to one embodiment of the present invention;

FIG. 3 provides a schematic representation of an influencer/publisher computing entity that can be used in conjunction with embodiments of the present invention;

FIGS. 4A and 4B provide a flowchart illustrating processes and operations that may be completed in creating and/or updating a user profile, in accordance with embodiments of the present invention;

FIGS. 5-15 and 23-42, 43A, 43B, 44-67, 68A, 68B, 69, 71-77, 78A, 78B, 79A, 79B, 80-84, 85A-85G, 86-90, 91A, 91B, 91C, 92-95, 96A, 96B, 97-110, 111A, 111B, and 112-126 provide various input and output in accordance with embodiments of the present invention; and

FIGS. 16-22, 70A, and 70B provide a flowchart illustrating processes and operations that may be completed in providing advertising opportunities, in accordance with embodiments of the present invention.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### I. COMPUTER PROGRAM PRODUCTS, METHODS, AND COMPUTING ENTITIES

Embodiments of the present invention may be implemented in various ways, including as computer program products that comprise articles of manufacture. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory, multimedia memory cards (MMC), secure digital (SD) memory cards, Memory Sticks, and/or the like. Further, a non-volatile computer-readable storage medium may also include conductive-bridging random access memory (CBRAM), phase-change random access memory (PRAM), ferroelectric random-access memory (FeRAM), resistive random-access memory (RRAM), Silicon-Oxide-Nitride-Oxide-Silicon memory (SONOS), racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Rambus in-line memory module (RIMM), dual in-line memory module (DIMM), single in-line memory module (SIMM), video random access memory VRAM, cache memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. However, embodiments of the present invention may also take the form of an entirely hardware embodiment performing certain steps or operations.

Embodiments of the present invention are described below with reference to block diagrams and flowchart illustrations. Thus, it should be understood that each block of the block diagrams and flowchart illustrations, respectively, may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### II. EXEMPLARY SYSTEM ARCHITECTURE

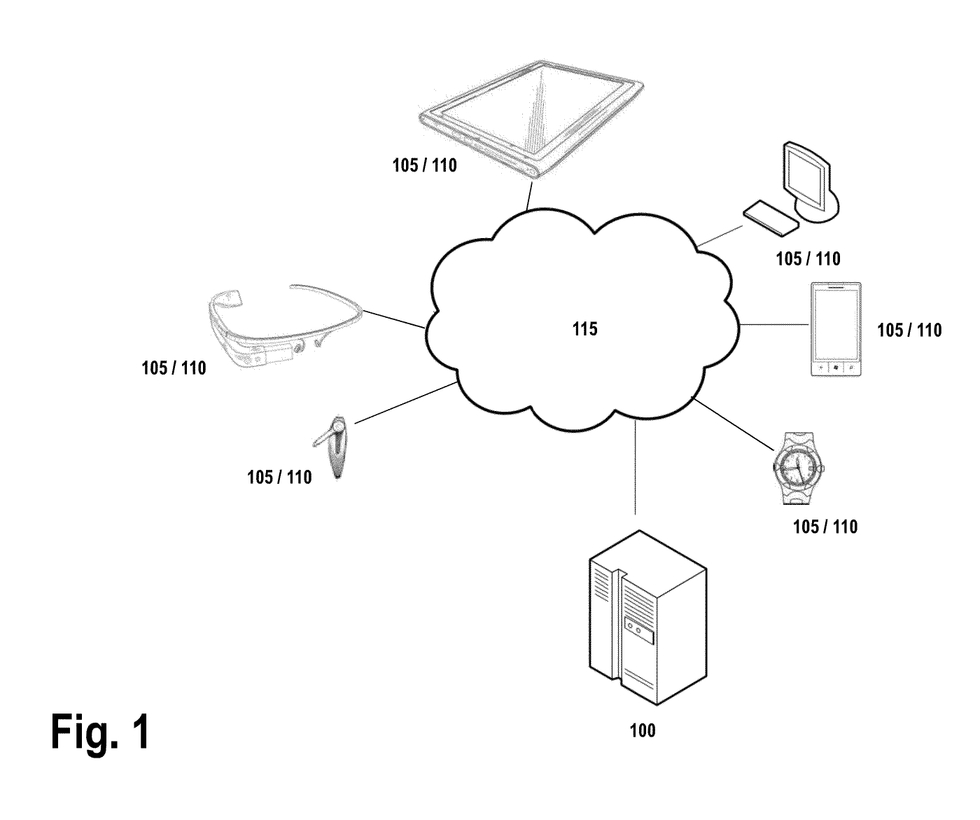

FIG. 1 provides an illustration of an exemplary embodiment of the present invention. As shown in FIG. 1, this particular embodiment may include one or more enterprise computing entities 100, one or more influencer/publisher computing entities 105, one or more advertiser computing entities 110, and one or more networks 115. Each of these components, entities, devices, systems, and similar words used herein interchangeably may be in direct or indirect communication with, for example, one another over the same or different wired or wireless networks. Additionally, while FIG. 1 illustrates the various system entities as separate, standalone entities, the various embodiments are not limited to this particular architecture.

### Enterprise Computing Entity

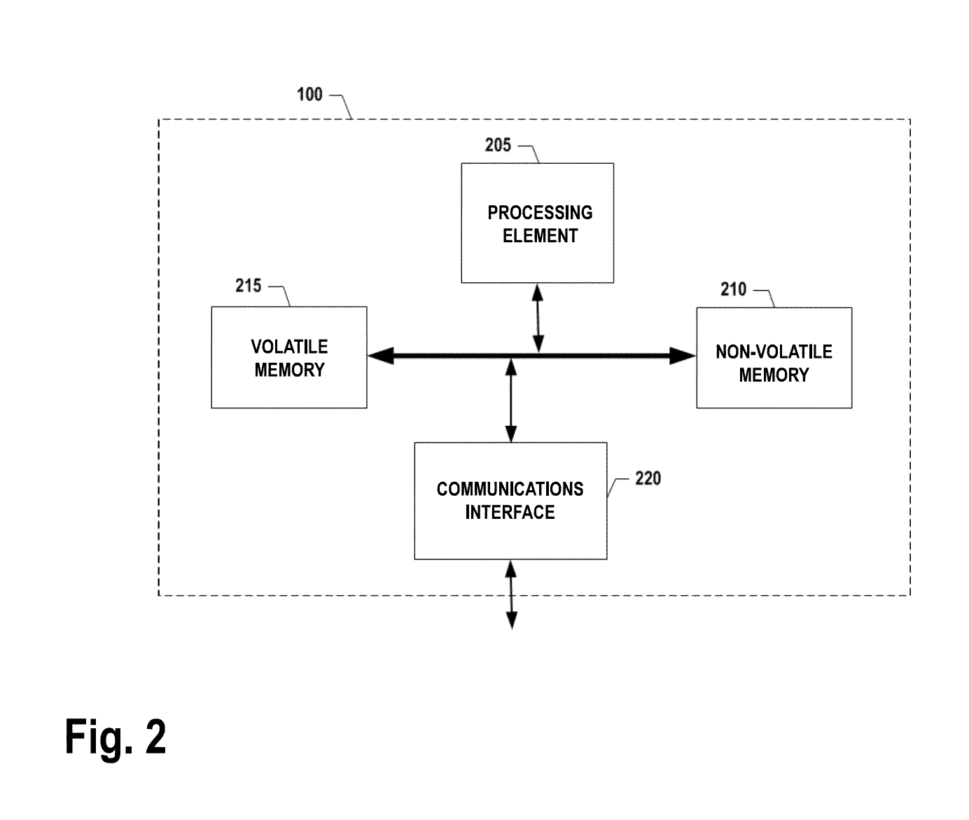

FIG. 2 provides a schematic of an enterprise computing entity 100 according to one embodiment of the present invention. In general, the terms device, system, computing entity, entity, and/or similar words used herein interchangeably may refer to, for example, one or more computers, computing entities, mobile phones, desktops, tablets, notebooks, laptops, distributed systems, watches, glasses, key fobs, radio frequency identification (RFID) tags, ear pieces, scanners, cameras, wristbands, kiosks, input terminals, servers, blades, gateways, switches, processing devices, processing entities, relays, routers, network access points, base stations, the like, and/or any combination of devices or entities adapted to perform the functions, operations, and/or processes described herein. The enterprise computing entity 100 may also include, be associated with, and/or be in communications with an influencer/publisher database, advertiser database, and/or the like. Thus, reference to the enterprise computing entity 100 may also refer to such systems. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the enterprise computing entity 100 may also include one or more communications interfaces 220 for communicating with various computing entities, such as by communicating data, content, information, and/or similar terms used herein interchangeably that can be transmitted, received, operated on, processed, displayed, stored, and/or the like. For instance, the enterprise computing entity 100 may communicate with influencer/publisher computing entities 105, advertiser computing entities 110, and/or various other computing entities.

As shown in FIG. 2, in one embodiment, the enterprise computing entity 100 may include or be in communication with one or more processing elements 205 (also referred to as processors, processing circuitry, and/or similar terms used herein interchangeably) that communicate with other elements within the enterprise computing entity 100 via a bus, for example. As will be understood, the processing element 205 may be embodied in a number of different ways. For example, the processing element 205 may be embodied as one or more complex programmable logic devices (CPLDs), microprocessors, multi-core processors, coprocessing entities, application-specific instruction-set processors (ASIPs), and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the enterprise computing entity 100 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 210 as described above, such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a structured collection of records or data that is stored in a computer-readable storage medium, such as via a relational database, hierarchical database, and/or network database.

In one embodiment, the enterprise computing entity 100 may further include or be in communication with volatile media (also referred to as volatile storage, memory, memory storage, memory circuitry and/or similar terms used herein interchangeably). In one embodiment, the volatile storage or memory may also include one or more volatile storage or memory media 215 as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the enterprise computing entity 100 with the assistance of the processing element 205 and operating system.

As indicated, in one embodiment, the enterprise computing entity 100 may also include one or more communications interfaces 220 for communicating with influencer/publisher computing entities 105, advertiser computing entities, and/or various other computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the enterprise computing entity 100 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), 802.16 (WiMAX), ultra wideband (UWB), infrared (IR) protocols, Bluetooth protocols, wireless universal serial bus (USB) protocols, and/or any other wireless protocol.

Although not shown, the enterprise computing entity 100 may include or be in communication with one or more input elements, such as a keyboard input, a mouse input, a touch screen/display input, audio input, pointing device input, joystick input, keypad input, and/or the like. The enterprise computing entity 100 may also include or be in communication with one or more output elements (not shown), such as audio output, video output, screen/display output, motion output, movement output, and/or the like.

As will be appreciated, one or more of the computing entity's 100 components may be located remotely from other enterprise computing entity 100 components, such as in a distributed system. Furthermore, one or more of the components may be combined and additional components performing functions described herein may be included in the enterprise computing entity 100. Thus, the enterprise computing entity 100 can be adapted to accommodate a variety of needs and circumstances.

### Exemplary Influencer/Publisher Computing Entity

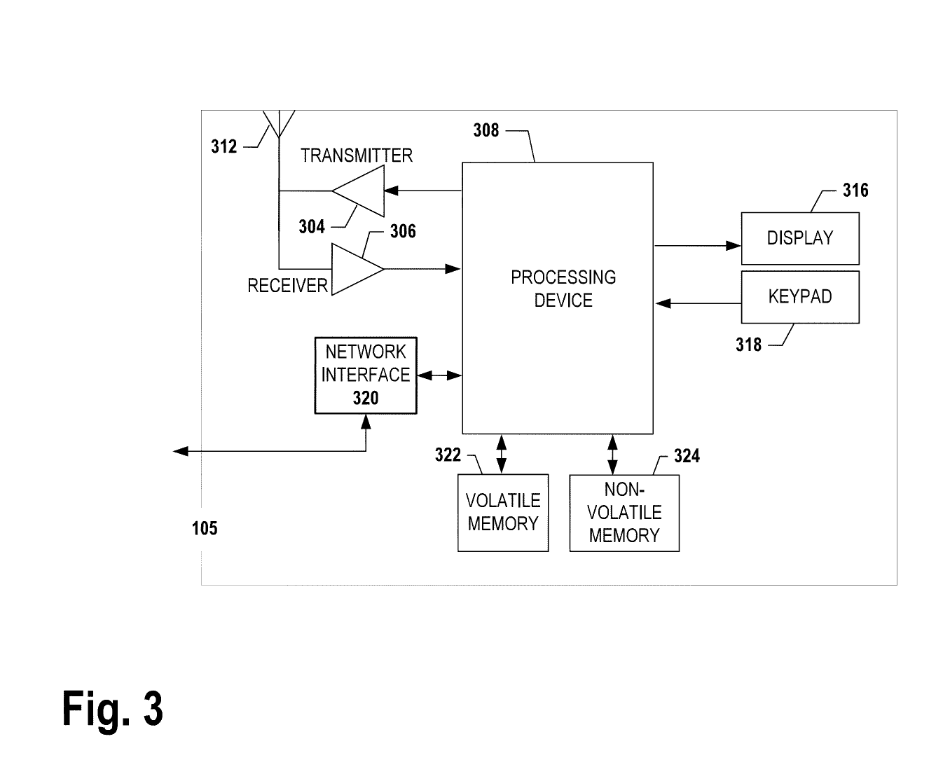

In one embodiment, an influencer/publisher (user) may be any individual, group of individuals, family, company, organization, entity, department within an organization, representative of an organization and/or person, and/or the like that has or purports to have influence over others and/or publishes content for others. The term influencer/publisher as used herein also includes those who may represent an influencer/publisher, such as managers, agents, public relations representatives, and/or the like. Thus, as will be recognized, the term “influencer” and “publisher” are used generically for illustrative purposes in describing certain embodiments herein. FIG. 3 provides an illustrative schematic representative of an influencer/publisher computing entity 105 that can be used in conjunction with embodiments of the present invention. In general, the terms device, system, computing entity, entity, and/or similar words used herein interchangeably may refer to, for example, one or more computers, computing devices, computing entities, mobile phones, desktops, tablets, notebooks, laptops, distributed systems, watches, glasses, key fobs, RFID tags, ear pieces, scanners, cameras, wristbands, kiosks, input terminals, servers, blades, gateways, switches, processing devices, processing entities, relays, routers, network access points, base stations, the like, and/or any combination of devices or entities adapted to perform the functions, operations, and/or processes described herein. Influencer/publisher computing entities 105 can be operated by various parties. As shown in FIG. 3, the influencer/publisher computing entity 105 can include an antenna 312, a transmitter 304 (e.g., radio), a receiver 306 (e.g., radio), and a processing element 308 (such as those described above with regard to the enterprise computing entity 100) that provides signals to and receives signals from the transmitter 304 and receiver 306, respectively.

The signals provided to and received from the transmitter 304 and the receiver 306, respectively, may include signaling information in accordance with air interface standards of applicable wireless systems. In this regard, the influencer/publisher computing entity 105 may be capable of operating with one or more air interface standards, communication protocols, modulation types, and access types. More particularly, the influencer/publisher computing entity 105 may operate in accordance with any of a number of wireless communication standards and protocols, such as those described above with regard to the enterprise computing entity 100. In a particular embodiment, the influencer/publisher computing entity 105 may operate in accordance with multiple wireless communication standards and protocols, such as UMTS, CDMA2000, 1xRTT, WCDMA, TD-SCDMA, LTE, E-UTRAN, EVDO, HSPA, HSDPA, Wi-Fi, WiMAX, UWB, IR, Bluetooth, USB, and/or the like.

Via these communication standards and protocols, the influencer/publisher computing entity 105 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The influencer/publisher computing entity 105 can also download changes, add-ons, and updates, for instance, to its firmware, software (e.g., including executable instructions, applications, program modules), and operating system.

According to one embodiment, the influencer/publisher computing entity 105 may include a location determining device and/or functionality. For example, the influencer/publisher computing entity 105 may include a Global Positioning System (GPS) module adapted to acquire, for example, latitude, longitude, altitude, geocode, course, and/or speed data. In one embodiment, the GPS module acquires data, sometimes known as ephemeris data, by identifying the number of satellites in view and the relative positions of those satellites.

The influencer/publisher computing entity 105 may also comprise a user interface (that can include a display 316 coupled to a processing element 308) and/or a user input interface (coupled to a processing element 308). For example, the user interface may be an appropriate application, browser, dashboard, user interface, and/or similar words used herein interchangeably executing on and/or accessible via the influencer/publisher computing entity 105 to interact with and/or cause display of information from the enterprise computing entity 100, as described herein. The user input interface can comprise any of a number of devices allowing the influencer/publisher computing entity 105 to receive data, such as a keypad 318 (hard or soft), a touch display, voice or motion interfaces, or other input device. In embodiments including a keypad 318, the keypad 318 can include (or cause display of) the conventional numeric (0-9) and related keys (#, *), and other keys used for operating the influencer/publisher computing entity 105 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The influencer/publisher computing entity 105 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the influencer/publisher computing entity 105. As indicated, this may include an influencer/publisher application that is resident on the entity or accessible through a browser or other user interface for communicating with the enterprise computing entity 100, advertiser computing entity 110, and/or various other computing entities.

In another embodiment, the influencer/publisher computing entity 105 may include one or more components that are functionally similar to those of the enterprise computing entity 100, as described in greater detail above.

### Exemplary Advertiser Computing Entity

In one embodiment, an advertiser (user) may be an individual, a family, a company, an organization, an entity, a department within an organization, a representative of an organization and/or person (e.g., representative of an advertiser), and/or the like. The term advertiser as used herein also includes those who may represent an advertiser, such as advertising agencies, public relations representatives, and/or the like. In one embodiment, an advertiser may be seeking to hire one or more influencers/publishers for advertising opportunities. Thus, as will be recognized, the term “advertiser” is used generically for illustrative purposes in describing certain embodiments herein. In one embodiment, an advertiser may operate an advertiser computing entity 110 that includes one or more components that are functionally similar to those of the enterprise computing entity 100 and/or the influencer/publisher computing entity 105. For example, in one embodiment, each advertiser computing entity 110 may include one or more processing elements, one or more display device/input devices (e.g., including user interfaces), volatile and non-volatile storage or memory, and/or one or more communications interfaces. For example, the user interface may be an appropriate application, browser, dashboard, user interface, and/or similar words used herein interchangeably executing on and/or accessible via the advertiser computing entity 110 to interact with and/or cause display of information from the enterprise computing entity 100, as described herein. This may also enable to the advertiser computing entity 110 to communicate with various other computing entities, such as influencer/publisher computing entities 105, and/or various other computing entities.

These architectures are provided for exemplary purposes only and are not limiting to the various embodiments. The term computing entity may refer to one or more computers, computing entities, mobile phones, desktops, tablets, notebooks, laptops, distributed systems, watches, glasses, key fobs, RFID tags, ear pieces, scanners, cameras, wristbands, kiosks, input terminals, servers, blades, gateways, switches, processing devices, processing entities, relays, routers, network access points, base stations, the like, and/or any combination of devices or entities adapted to perform the functions, operations, and/or processes described herein.

### III. EXEMPLARY SYSTEM OPERATION

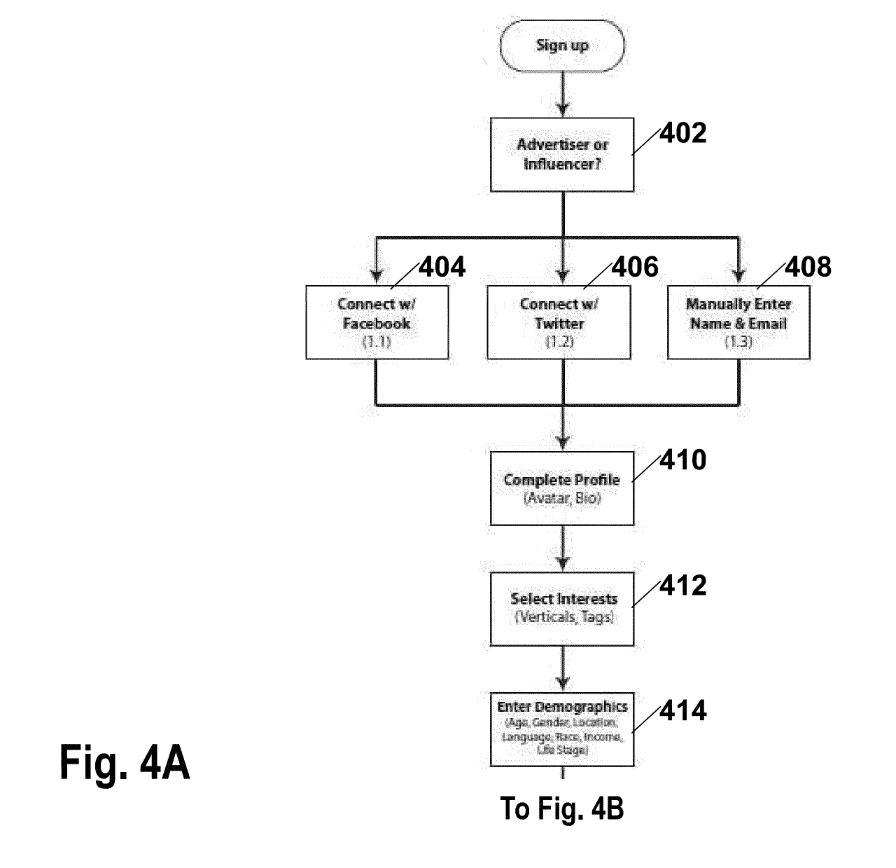

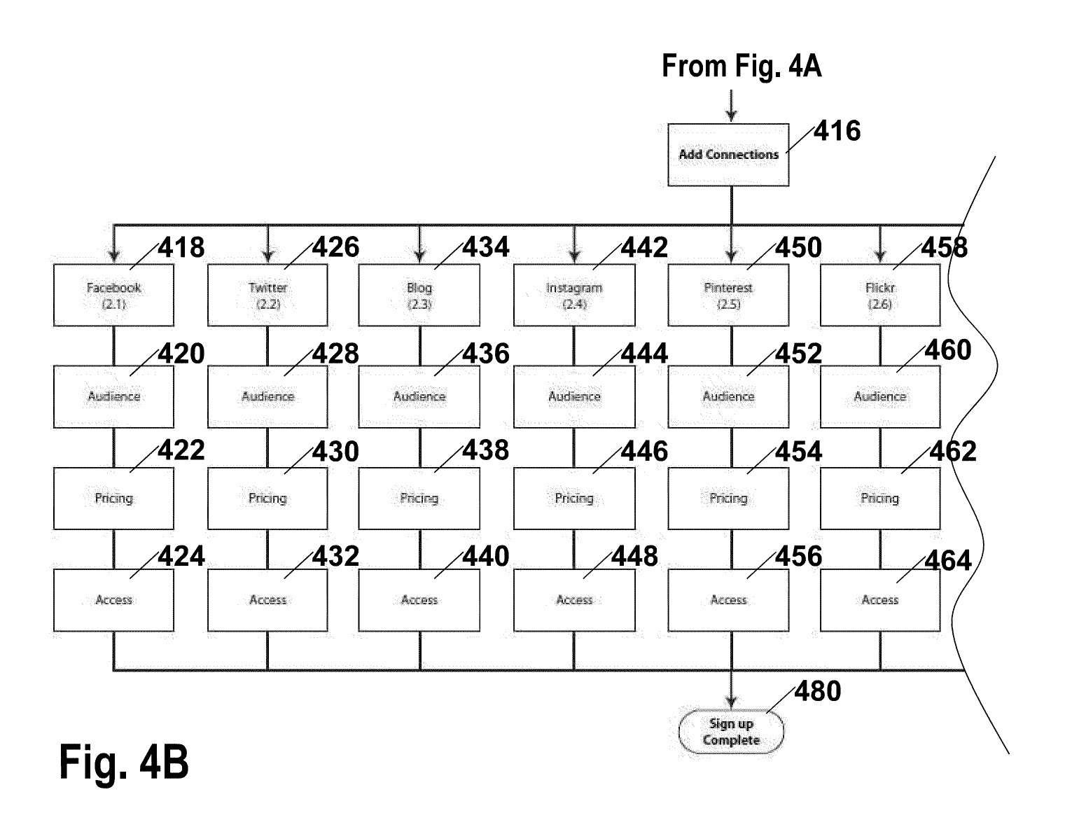

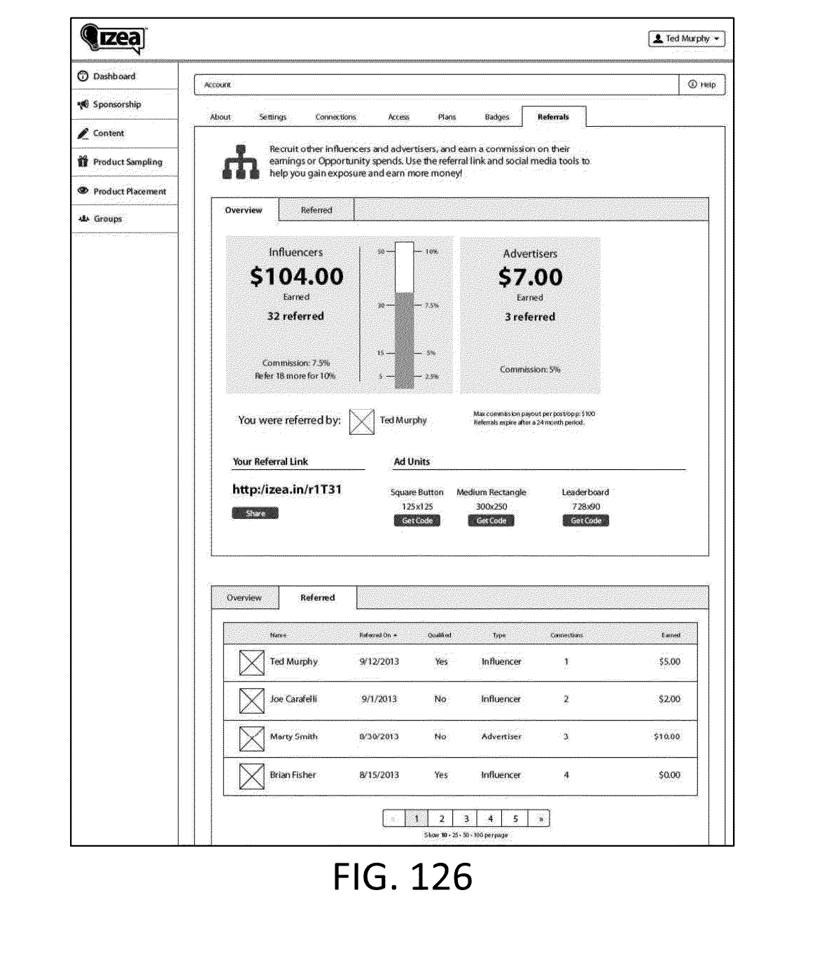

Reference will now be made to FIGS. 4-126. In particular, details regarding various embodiments of the concepts for advertising opportunities described herein and in the attached Figures and Appendices, which are herein incorporated in their entireties by reference. Specifically, the documents attached as FIGS. 1-126 illustrate various embodiments of concepts for advertising opportunities.

### Influencer/Publisher Profiles

As noted, an influencer/publisher may be any individual, group of individuals, family, company, organization, entity, department within an organization, representative of an organization and/or person, and/or the like. For example, Michael Jordan (or http://www.nike.com/jumpman23 or https://twitter.com/Jumpman23) may be an influencer/publisher over or have a following of those who have an interest in basketball. In another example, Michael Crichton (http://www.michaelcrichton.net) may be an influencer/publisher over or have a following of those who have an interest in books related to science fiction, medical fiction, and thriller genres. In still another example, Lil Wayne (http://www.youngmoney.com) may be an influencer/publisher over or have a following of those who enjoy hip hop music. In an entity context, talent agencies may be influencers/publishers (e.g., the individuals represented by the talent agencies may also be influencers/publishers for whom the talent agencies review and manage advertising opportunities). For example, talent agencies such as Creative Artists Agency (CAA), William Morris Agency, and International Creative Management (ICM) may represent various influencers/publishers (e.g., actors, models, celebrities, artists) and pursue and obtain advertising opportunities for the influencers/publishers they represent. Similarly, blog networks may be influencers/publishers for their respective audiences, whether it be individual writers or blogs or a network as a whole. For instance, AOL (http://www.aol.com), Gawker (http://gawker.com), and Buzzfeed (http://www.buzzfeed.com) may pursue and obtain opportunities to blog about, report on, or cover products, services, offerings, opportunities, positions, events, shows, programs, and/or the like for which they can receive payment or some other incentive. Similar to blog networks, crossover publishers (e.g., Bonner, Time, Hearst) may pursue and obtain opportunities to write articles about, publish pictures of, or cover products, services, offerings, opportunities, positions, events, shows, programs, and/or the like for which they can receive payment or some other incentive. As will be recognized, almost any individual, group, or entity can be an influencer/publisher.

In one embodiment, each influencer/publisher may have an influencer/publisher profile accessible via the enterprise computing entity 100. An influencer/publisher may also have multiple profiles and/or sub-profiles with varying rights and/or privileges (with a variety of usernames, passwords, authentication protocols, and/or the like for accessing the same). For example, for an individual influencer/publisher (e.g., Kim Kardashian), there may be multiple sub-profiles for with varying rights and/or privileges, such as an owner profile for the actual influencer/publisher (e.g., Kim Kardiashian's profile), a bidder or bidwriter profile for those who have authorization to bid (e.g., offer to perform or carry out) on behalf of the owner (e.g., Kim's agents or managers), a copywriter profile for those who can create content on behalf of the owner (e.g., Kim Kardashian's talent agency), and/or the like (e.g., administrators, managers, and/or the like). Similarly, blog networks, talent agencies, and/or the like may also have multiple profiles or sub-profiles. As used herein, the terms influencer/publisher and influencer/publisher profile may be used herein interchangeably with the terms bidder, bidwriter, copywriter, owner, and/or the like and the corresponding profiles. Further, such roles may be defined with different privileges and rights with regard to the corresponding influencer/publisher. For instance, bidders and bidwriters may only have privileges related to making bids for the influencer/publisher. Copywriters may only have privileges related to writing content for the influencer/publisher, while the influencer/publisher (and potentially his or her manager) may have privileges for all the functionality provided by the enterprise computing entity 100.

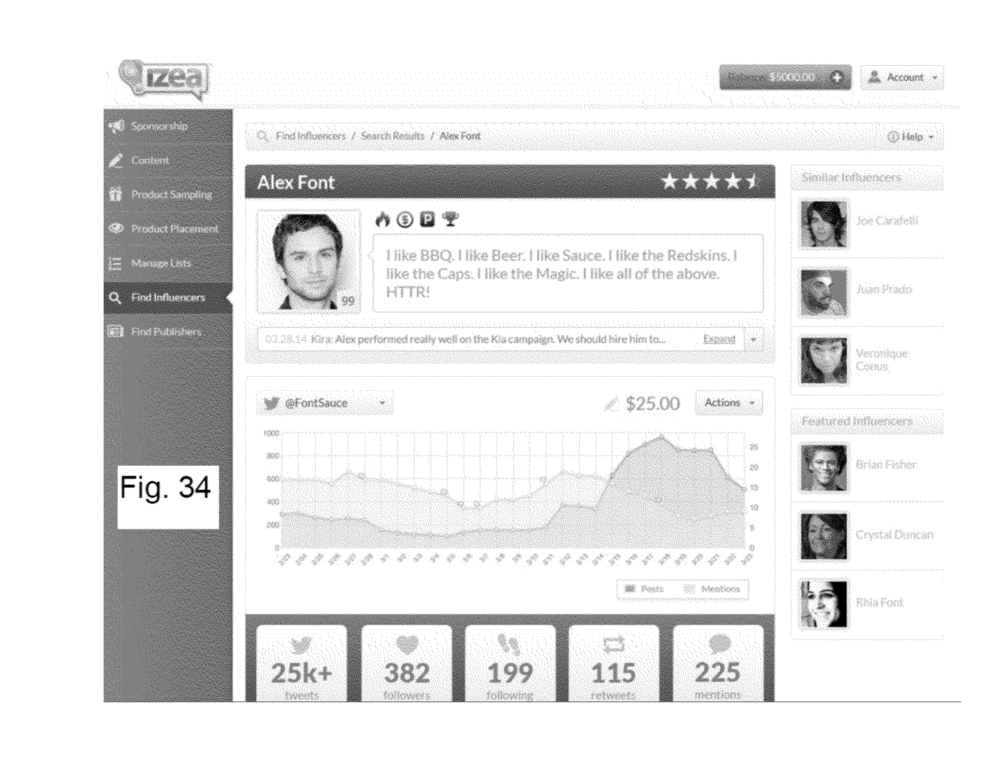

As will be recognized, the enterprise computing entity 100 may provide a single domain (izea.com), for instance, through which all influencers/publishers and advertisers communicate with one another to perform the various functions described herein (e.g., operated by an independent third party of the influencers/publishers and advertisers, such as izea.com). In another embodiment, the enterprise computing entity 100 may be used to implement white label marketplaces. To do so, in one embodiment, the enterprise computing entity 100 can group certain influencers/publishers (e.g., individuals, talent agencies, blog networks, crossover publishers, and/or the like). For example, as shown in FIG. 37, all of the influencers/publishers represented by CAA may be accessible via the enterprise computing entity 100 through the appropriate section, search, and/or the like. In this embodiment, the influencers/publishers represented by CAA may be identified by performing the functions described herein. In another embodiment, the enterprise computing entity 100 may be used to implement white label marketplaces in which influencers/publishers (e.g., individuals, talent agencies, blog networks, crossover publishers, and/or the like) and/or advertisers (e.g., individuals, advertising agencies, companies, public relations firms, and/or the like) have unique domains (e.g., influencers/publishers.caa.com) that provide the appearance that they (not an izea.com, for instance) support the backbone of the enterprise computing entity 100. In other words, influencers/publishers (e.g., individuals, talent agencies, blog networks, crossover publishers, and/or the like) may have unique domains through which advertisers (e.g., individuals, advertising agencies, companies, public relations firms, and/or the like) can provide advertising opportunities for the influencers/publishers (e.g., via application programming interfaces (APIs) in communication with the enterprise computing entity 100). For instance, CAA (e.g., influencers/publishers.caa.com) and ICM (e.g., opportunities.icm.com) may both have respective white label marketplaces through which advertisers can provide advertising opportunities for influencers/publishers represented by such agencies (e.g., those represented by the same using multiple profiles or sub-profiles for the represented influencers/publishers). For example, CAA and ICM may provide one or more profiles or sub-profiles for those they represent to interact via the white label marketplace. Further, the enterprise computing entity 100 may configure the white label marketplaces such that only select advertisers (e.g., individuals, advertising agencies, companies, public relations firms, and/or the like) have the ability to interact with a given influencer/publisher, such as creating a white label marketplace between CAA and Digitas for those they represent respectively. As will be recognized, this approach expands the opportunities for influencers/publishers to offer the services of individuals or others they represent for advertising opportunities. As will be recognized, a variety of other approaches and techniques can be used to adapt to various needs and circumstances.

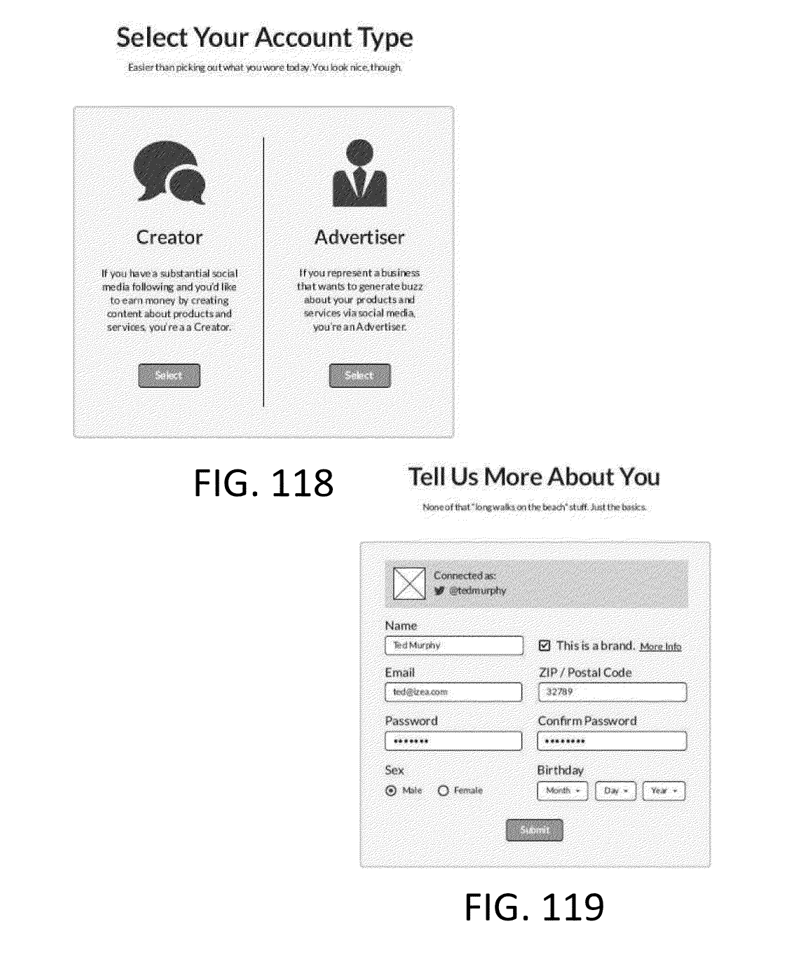

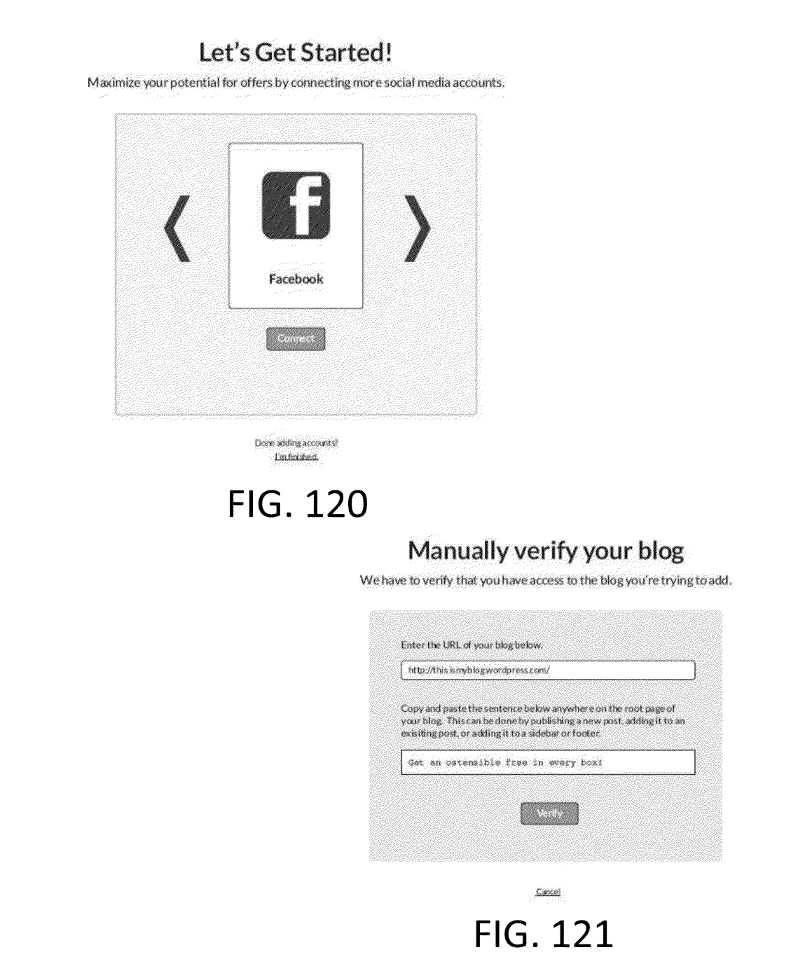

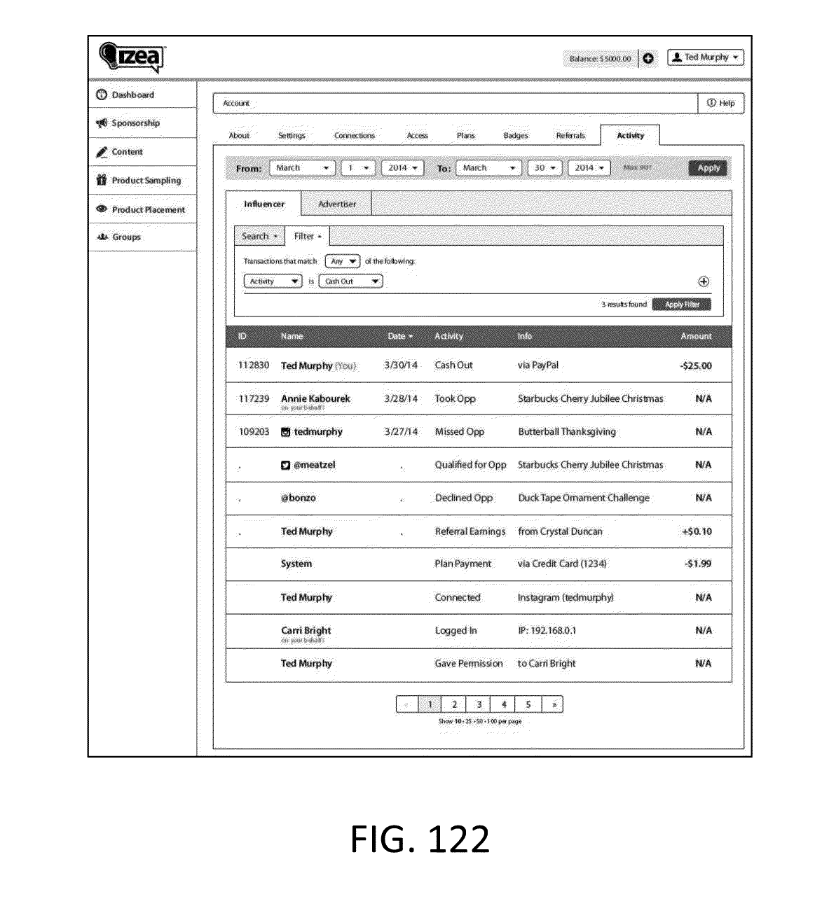

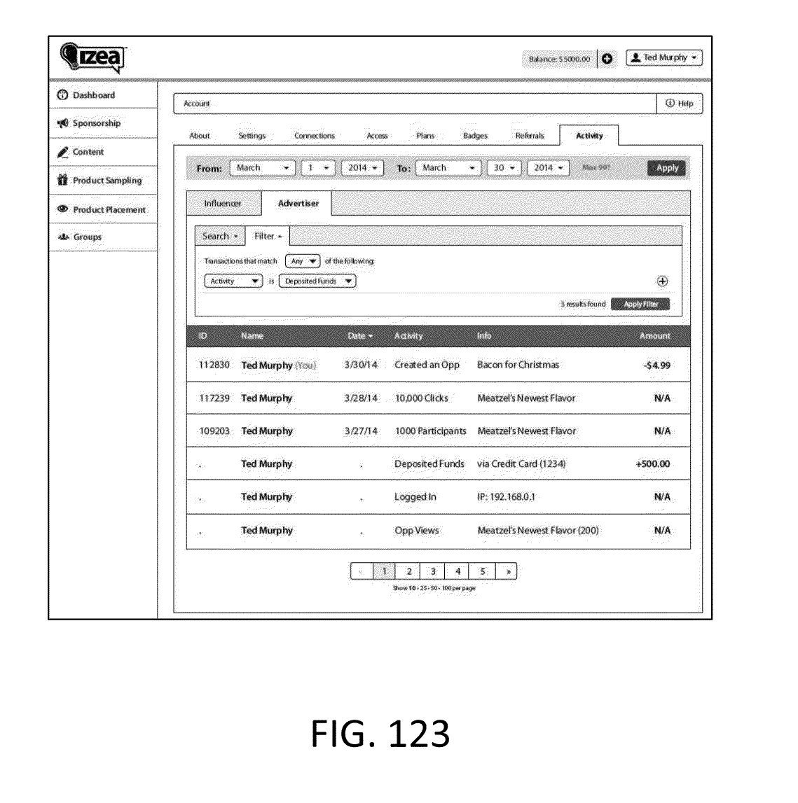

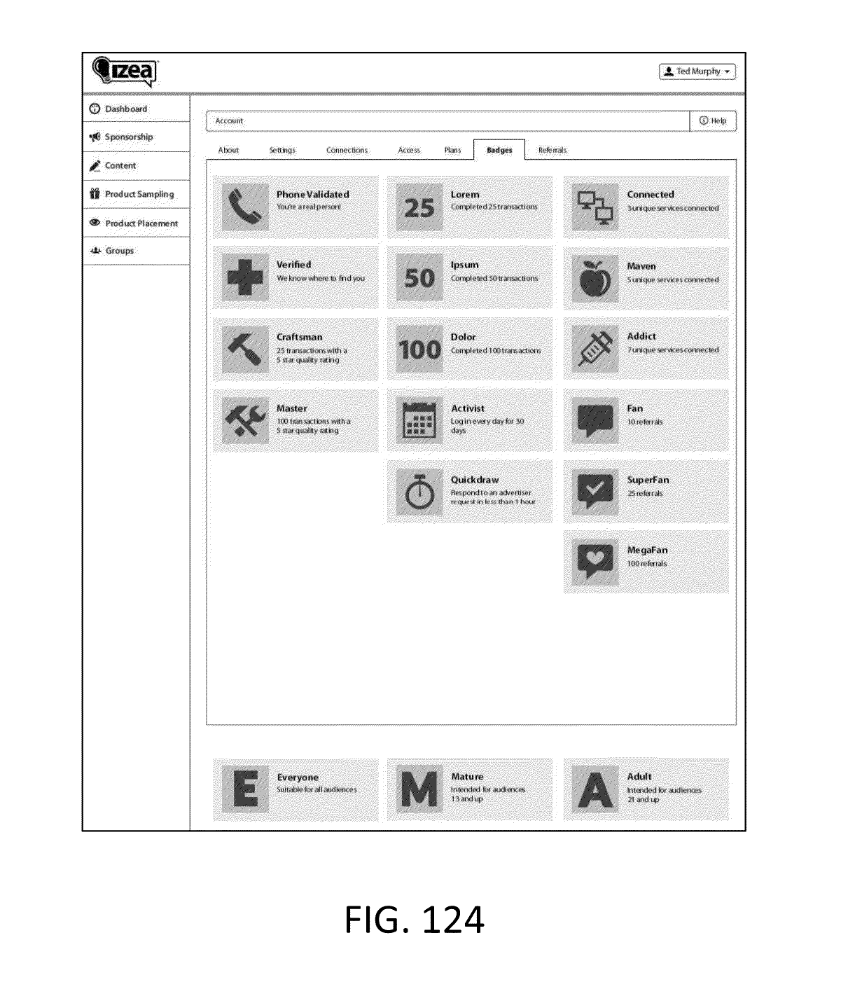

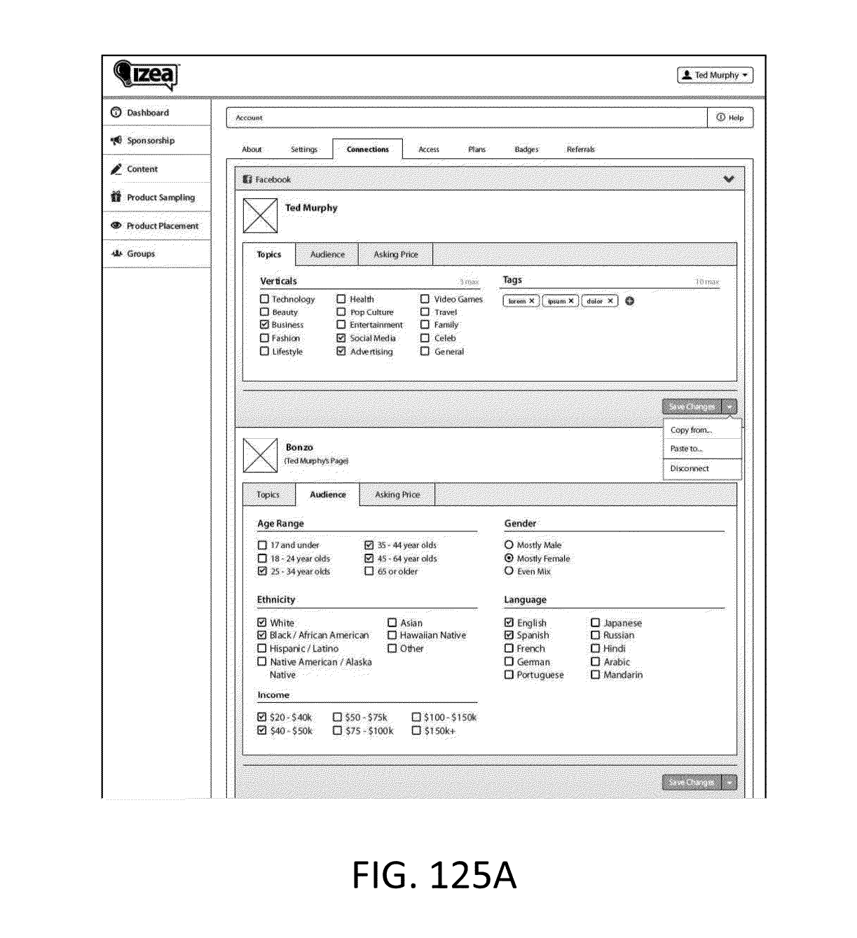

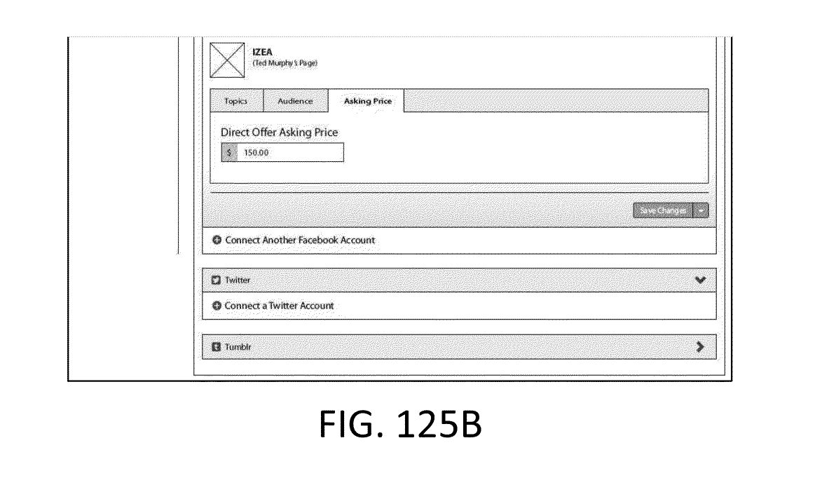

In one embodiment, as shown in FIGS. 4A and 4B, an influencer/publisher or someone on behalf of an influencer/publisher (e.g., operating an influencer/publisher computing entity 105 executing an influencer/publisher application, browser, dashboard, user interface, and/or the like) can input various information to create or update an influencer/publisher profile for storage and use by the enterprise computing entity 100 (e.g., via an influencer/publisher database), as shown in blocks 402-414 of FIG. 4A. Such profiles can be created, stored, edited, and/or customized manually, automatically, and/or semi-automatically to adapt to various needs and circumstances. For instance, in semi-automated or automated embodiments, the enterprise computing entity 100 may access an influencer's/publisher's existing accounts or profiles (such as social media accounts) to collect some or all accessible influencer/publisher information, such as by accessing Facebook, Twitter, Pinterest, Block, Flickr, Instagram, Blogs (e.g., Wordpress, Blogger, Typepad, Google Anyaltics, YouTube, LinkedIn, Vimeo, StumbleUpon, Reddit, and/or the like (also referred herein as Connections)) to collect the influencer's/publisher's information. In a manual embodiment, an influencer/publisher (e.g., operating an influencer/publisher computing entity 105 executing an influencer/publisher application, browser, dashboard, user interface, and/or the like) may manually input such information to create or update an influencer/publisher profile. FIGS. 117-121 illustrate various views of the profile sign up process according to an embodiment.

In one embodiment, an influencer/publisher profile may include an influencer/publisher name, gender, income (e.g., individual or household), email addresses, avatar, picture, birthday, text message addresses, social media accounts used, languages spoken, advertising rates, financial account information, phone numbers, addresses, and/or the like. The influencer/publisher may also input (or the enterprise computing entity 100 may collect/determine) the geographic area or areas in which the influencer/publisher lives or visits, such as United States (e.g., regions or areas within the same), Canada (e.g., regions or areas within the same), North America (e.g., regions or areas within the same), South America (e.g., regions or areas within the same), Europe (e.g., regions or areas within the same), Asia (e.g., regions or areas within the same), and Australia (e.g., regions or areas within the same), and/or the like. The influencer/publisher may also input (or the enterprise computing entity 100 may collect/determine) an age range of the influencer/publisher, such as 18+, 21+, Gen Y'ers, Gen X'ers, Baby Boomers. Seniors, and/or the like. The influencer/publisher may also input (or the enterprise computing entity 100 may collect/determine) areas of interest for the influencer/publisher, such as Technology, Beauty, Business, Fashion, Lifestyle, Health, Pop Culture, Entertainment, Social Media, Advertising, Video Games, Travel, Family, Celebrity, and/or the like. The areas of interest may correspond to the areas in which the influencer/publisher is willing to participate to influence or publish content to others. The influencer/publisher may also input (or the enterprise computing entity 100 may collect/determine) the influencer's/publisher's life stage, such as in college, kids in elementary, kids in high school, kids in college, and/or the like. And the influencer/publisher may input (or the enterprise computing entity 100 may collect/determine) the influencer's/publisher's profession or area of his or her profession, such as Agricultural, Mining, Utilities, Construction, Manufacturing, Transportation, Wholesale, Retail, Information, Financial, Real Estate, Professional, Management, Administrative, Education, Health Care, Arts/Entertainment, Food/Hospitality, Public/Government, Other, and/or the like. In one embodiment, an influencer/publisher (e.g., operating an influencer/publisher computing entity 105) may also input the prices for which the influencer/publisher is willing to accept advertising opportunities. Such prices may be referred as an “Ask Price” or a “Buy Now Price.” Such prices may be platform specific (e.g., Facebook, Twitter, etc.), opportunity specific (e.g., commenting, tweeting, etc.), and/or the like.

In one embodiment, the enterprise computing entity 100 may collect/determine information about the influencer/publisher or the influencer's/publisher's accounts, as indicated by blocks 416-464 of FIG. 4B. For example, for an influencer's/publisher's Facebook account, the enterprise computing entity 100 may collect/determine information regarding the influencer's/publisher's Likes, Friends, Subscribers, Posts, Comments, and/or the like. For a Twitter account, the enterprise computing entity 100 may collect/determine information regarding the influencer's/publisher's Followers, Friends, Tweets, Mentions, Retweets, Times Listed, and/or the like. For a Flickr account, the enterprise computing entity 100 may collect/determine information regarding the influencer's/publisher's Contacts, Photos, Photo Views, Photo Faves, Photo Comments, and/or the like. As will be recognized, various information from a variety of sources can be collected/determined by the enterprise computing entity 100 to store in association with an influencer's/publisher's profile. Such profile information may be updated regularly, periodically, continuously, and/or in response to certain triggers.

With the creation of an influencer/publisher profile, a variety of statistics, benchmarks, and/or other information can be maintained, evaluated, and/or determined by the enterprise computing entity 100. For example, with such influencer/publisher information, the enterprise computing entity 100 can determine or evaluate the influencer/publisher by assigning an Approval Rating to the influencer/publisher. The Approval Rating may provide an indication to advertisers as to how often an influencer's/publisher's content is being approved/accepted or rejected by other advertisers, such as by dividing the amount of approvals/acceptances by the number of rejections (e.g., if an influencer/publisher has attempted to take 10 opportunities and has been approved/accepted to complete 9 out of the 10, the approval rating would be 90%). In one embodiment, the influencer/publisher may be required to complete at least five transactions in order to be assigned an Approval Rating.

The enterprise computing entity 100 can determine or evaluate the influencer/publisher by assigning a Quality Score to the influencer/publisher. For example, each time an influencer/publisher participates in a transaction the advertiser is promoted to rate the quality of the content on a scale of 1 to 5. This is displayed as a star rating on the influencer's/publisher's profile. In one embodiment, the Quality Score can be an average of all ratings for the influencer/publisher. In one embodiment, the influencer/publisher may be required to complete at least five transactions in order to be assigned a score.

The enterprise computing entity 100 can also determine or evaluate the influencer/publisher by assigning an Influence Rank or InRank to the influencer/publisher. In one embodiment, the Influence Rank or InRank may be a number from 1-100 that measures the influencer's/publisher's reach, engagement, and overall influence. In one embodiment, to determine or evaluate the Influence Rank or InRank, the enterprise computing entity 100 may take into account all social connections while placing a weighted emphasis on activation and click quality.

In one embodiment, the enterprise computing entity 100 can assign badges to influencers/publishers. As will be recognized, badges may be graphical representations of achievements earned by influencers/publishers to encourage participation by influencers/publishers. Such badges may be transaction based, such as 25—25 completed transactions, 50—50 completed transactions, and/or 100—100 completed transactions. Such badges may also be quality based, such as Craftsman—25 transactions with a 5 star quality rating or Master—100 transactions with a 5 star quality rating. Such badges may also be social based, such as Connected—3 unique services connected, Maven—5 unique services connected, and Addict—7 unique services connected. Further, the badges may be referral based, such as Fan—10 referrals, Superfan—25 referrals, and/or Megafan—100 referrals. In other embodiments, such badges may be response-time based or community based, such as Quickdraw—respond to an advertiser change request in less than 1 hour or Activist—Login every day for 30 days. As will be recognized, a variety of other techniques and approaches (and combinations of the above) can be used to adapt to various needs and circumstances.

In one embodiment, through such profiles, influencers/publishers (e.g., individuals, talent agencies, blog networks, crossover publishers, and/or the like) may have to ability to “watch” advertisers, watch advertising opportunities over a configurable threshold, and/or the like. Similarly, influencers/publishers (e.g., operating influencer/publisher computing entities 105) may also have the ability to monitor their financials (e.g., receive notifications when they receive payment for completing an advertising opportunity, when they receive payment for a referral). As will be recognized, a variety of other approaches and techniques can be used to adapt to various needs and circumstances.

### Advertisers Profiles

As noted, an advertiser (user) may be an individual, a family, a company, an organization, an entity, a department within an organization, a representative of an organization and/or person, and/or the like seeking to hire one or more influencers/publishers (e.g., individuals, blog networks or individual writers, talent agencies or individual celebrities) for advertising (e.g., promoting, influencing, etc.) products, services, offerings, opportunities, positions, events, shows, programs, and/or the like interchangeably referred to herein as advertising opportunities. For example, The Coca-Cola Company may be an advertiser interested in hiring influencers/publishers to Tweet or write a blog about the great taste of a new Coca-Cola product; post a picture on Instagram of them drinking the new Coca-Cola product, wearing Coca-Cola gear, or visiting the World of Coke; or write a blog about the quality of the new Coca-Cola product. Further advertising agencies (representing a variety of individuals and entities) may also be advertisers. For example, advertising agencies (such as Ogilvy, Razorfish, and Digitas) may represent individuals or entities having an interest in using one or more influencers/publishers to advertise (e.g., promote, influence, etc.) a product, service, offering, opportunity, position, event, show, program, and/or the like. Similarly, public relations firms (such as Ketchum, Edelman, and Cohn & Wolfe) may represent individuals or entities having an interest in using one or more influencers/publishers to advertise a product, service, offering, opportunity, position, event, show, program, and/or the like. Similarly, blog networks and crossover publishers may be advertisers by having an interest in using one or more influencers/publishers to advertise (e.g., promote, influence, etc.) a product, service, article, photograph, blog, offering, opportunity, position, event, show, program, and/or the like. Thus, as will be recognized, an advertiser may be any individual, group of individuals, family, company, organization, entity, department within an organization, representative of an organization and/or person, and/or the like.

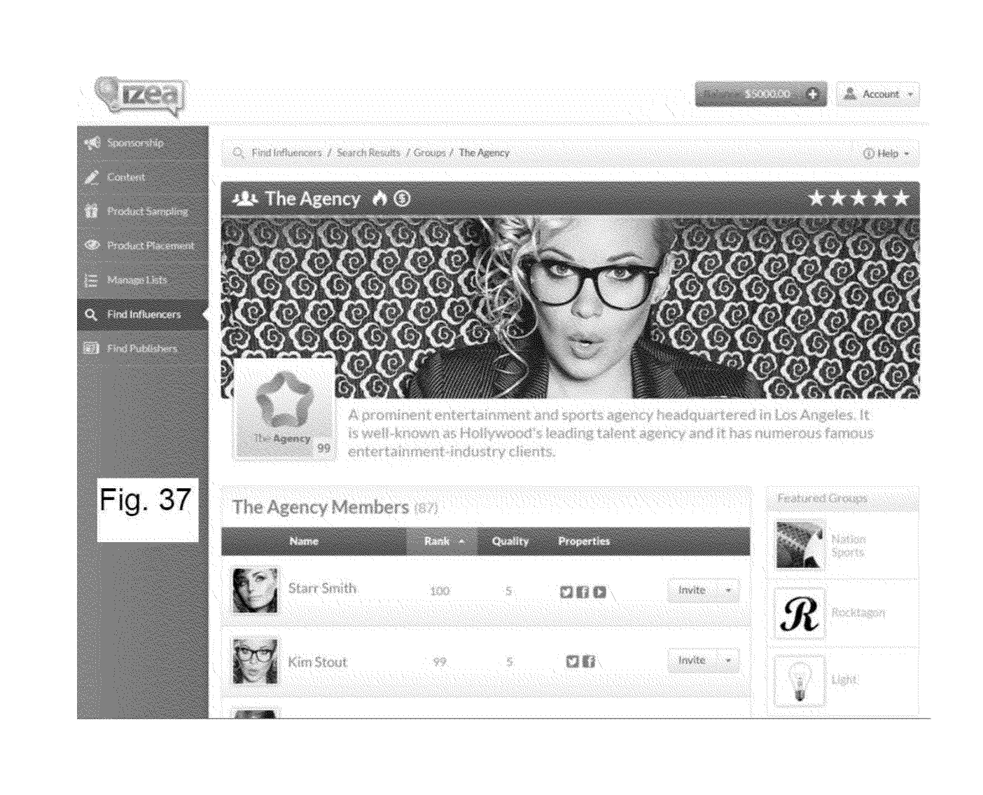

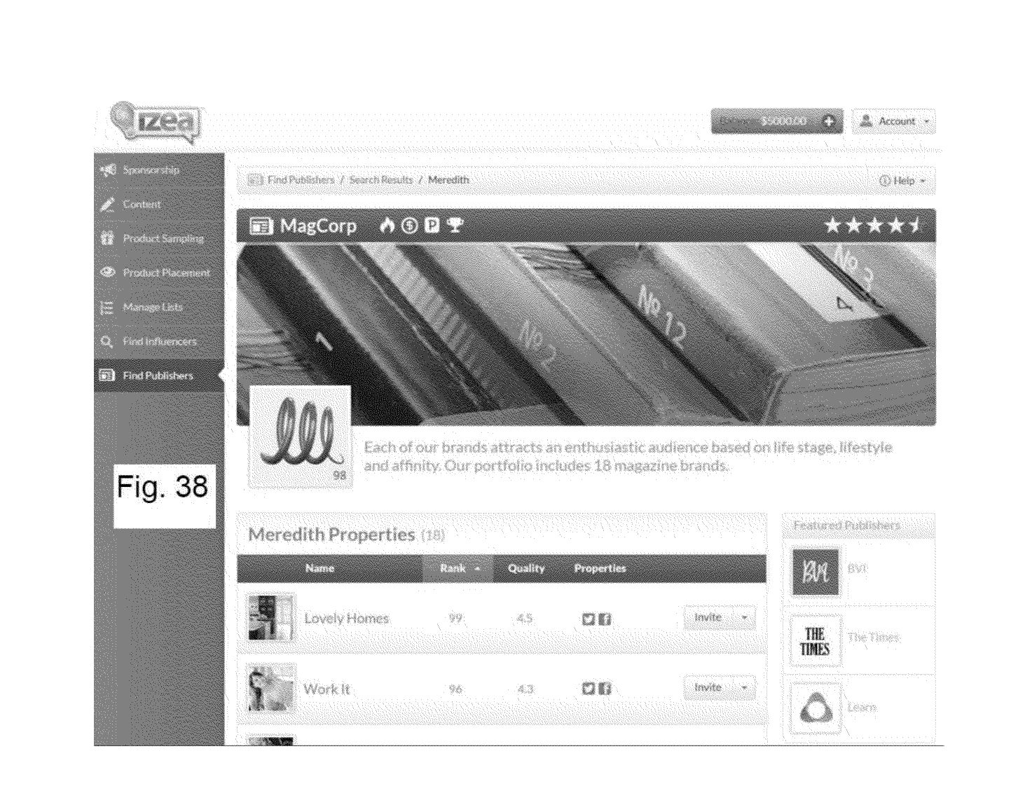

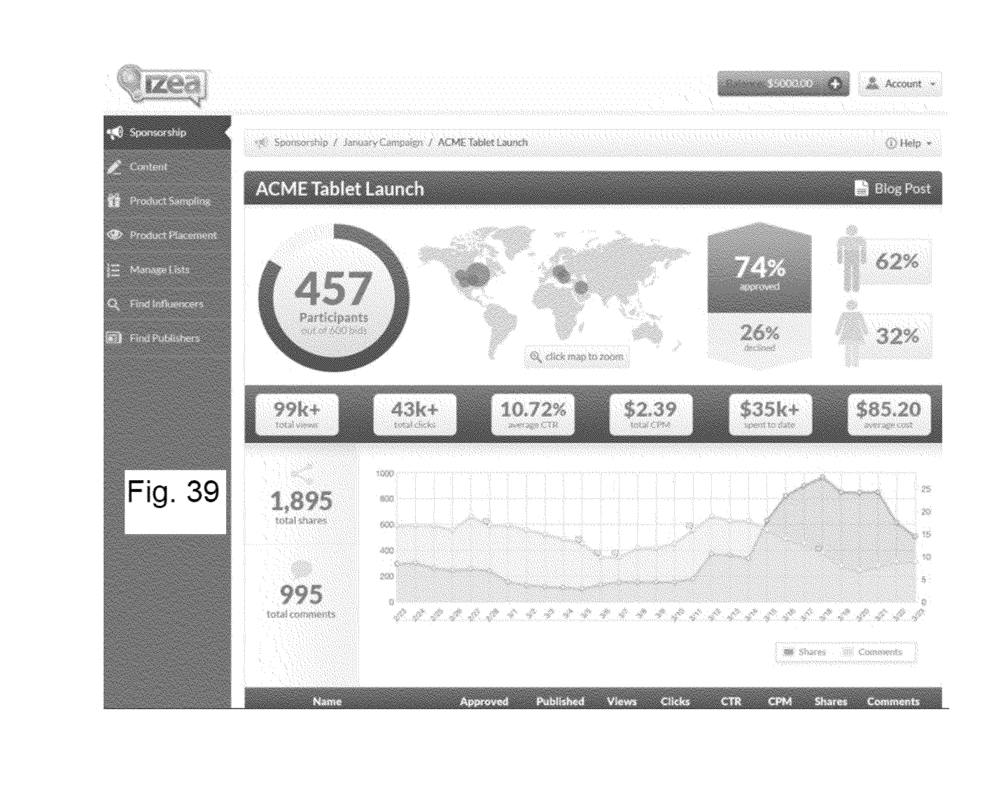

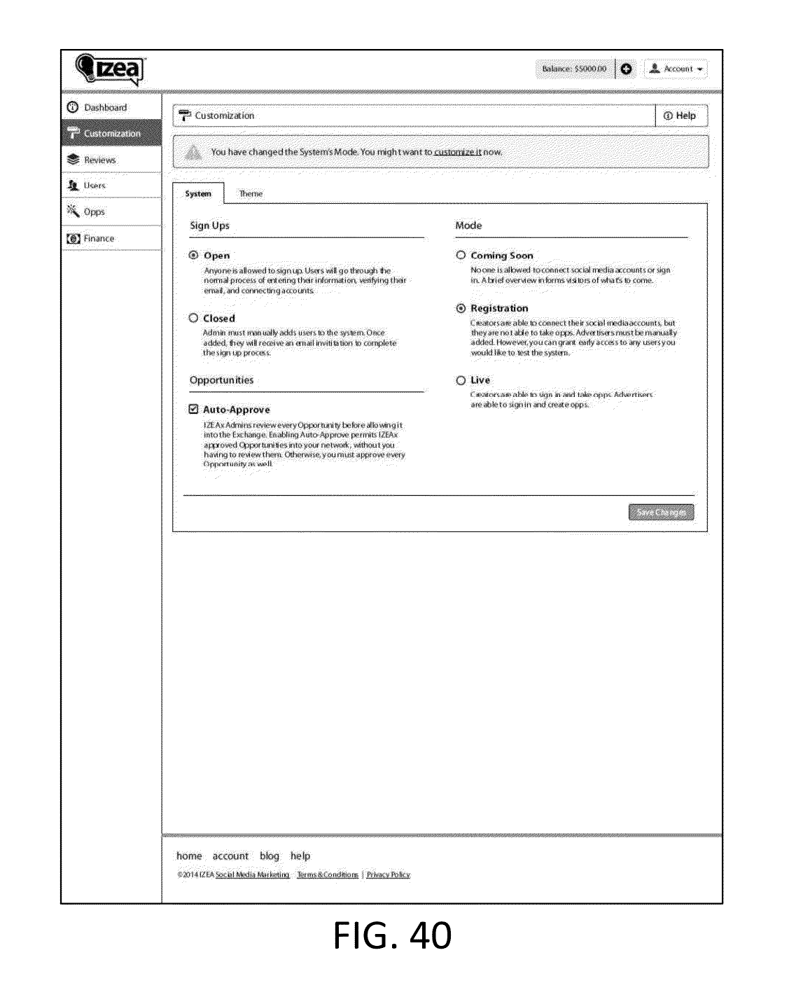

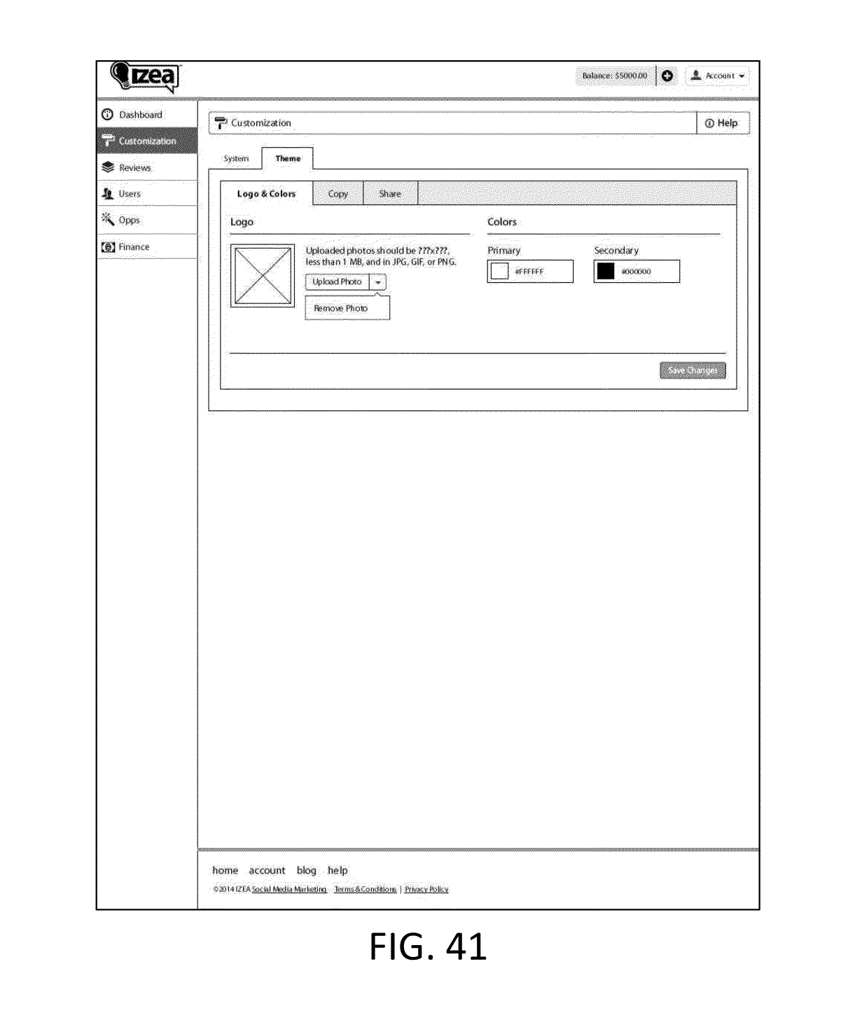

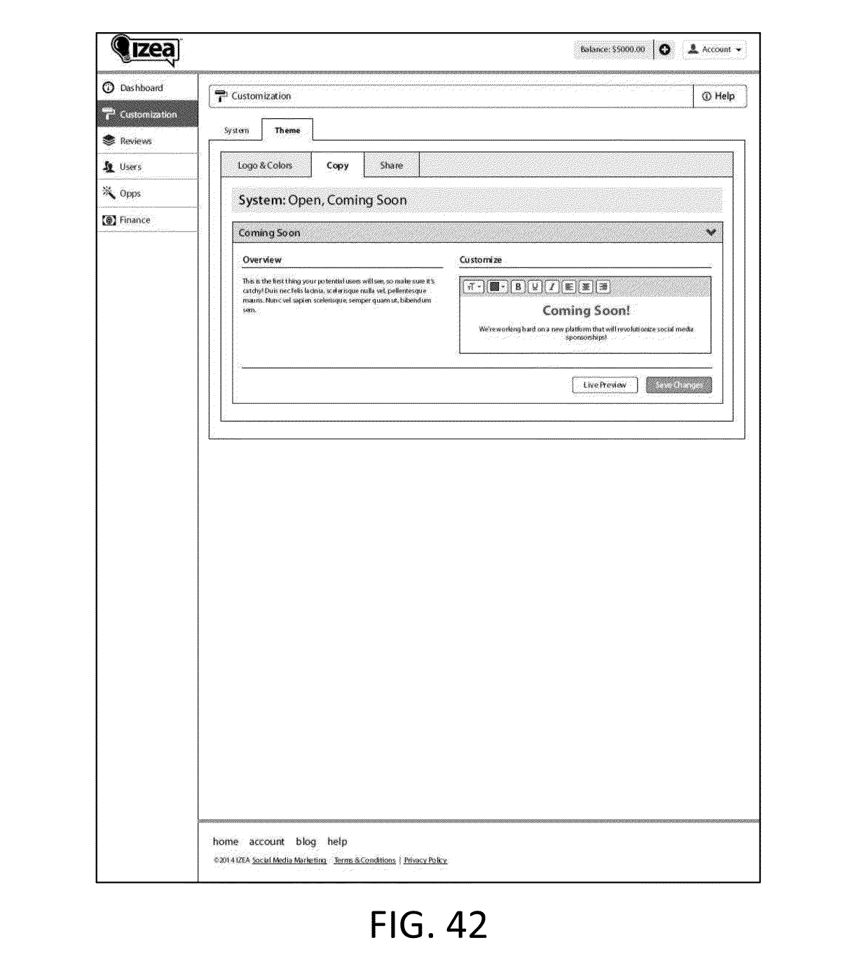

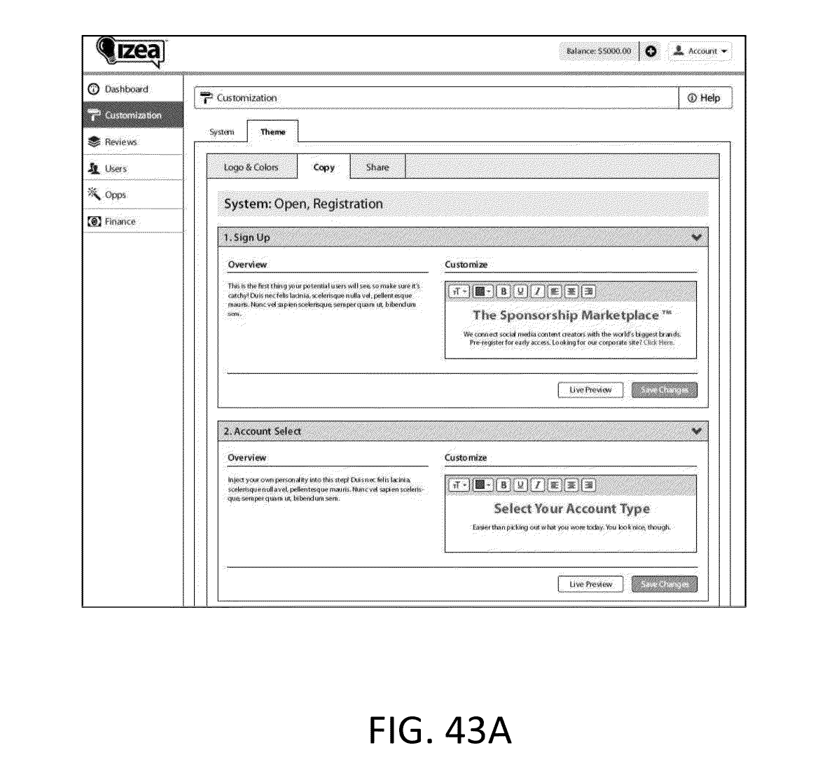

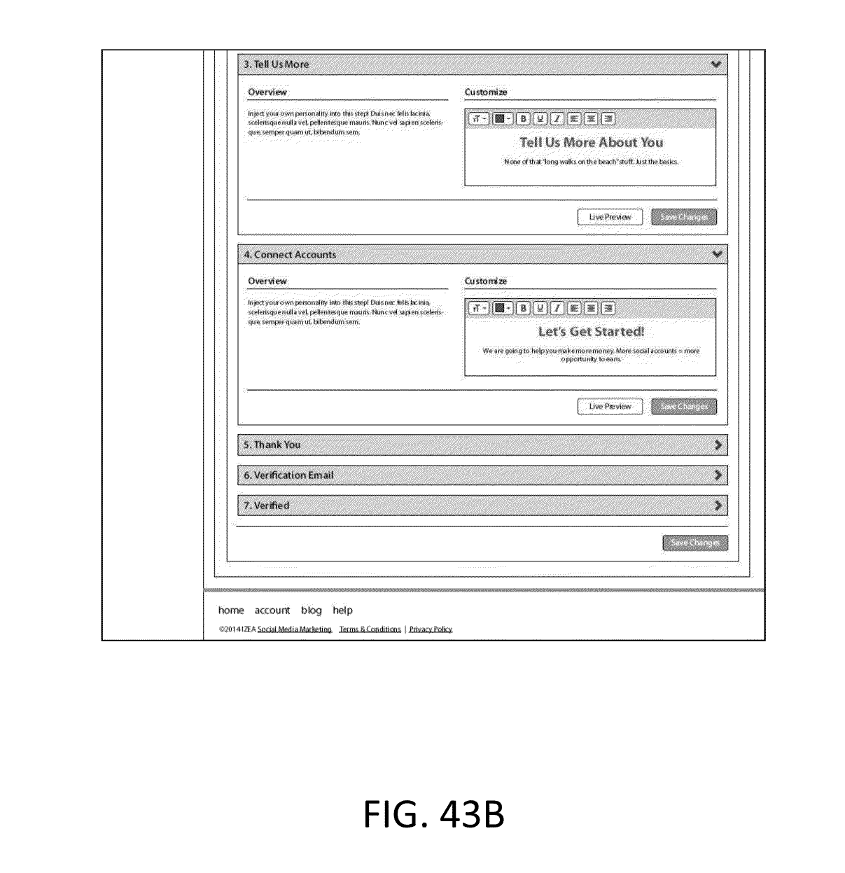

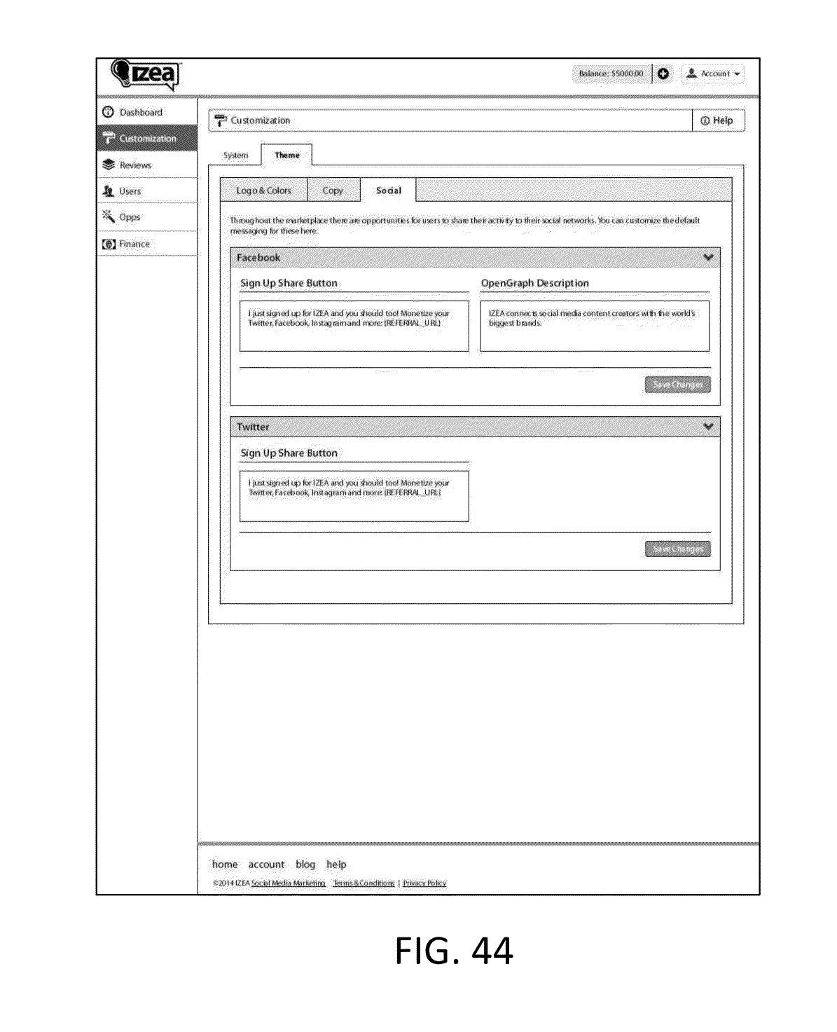

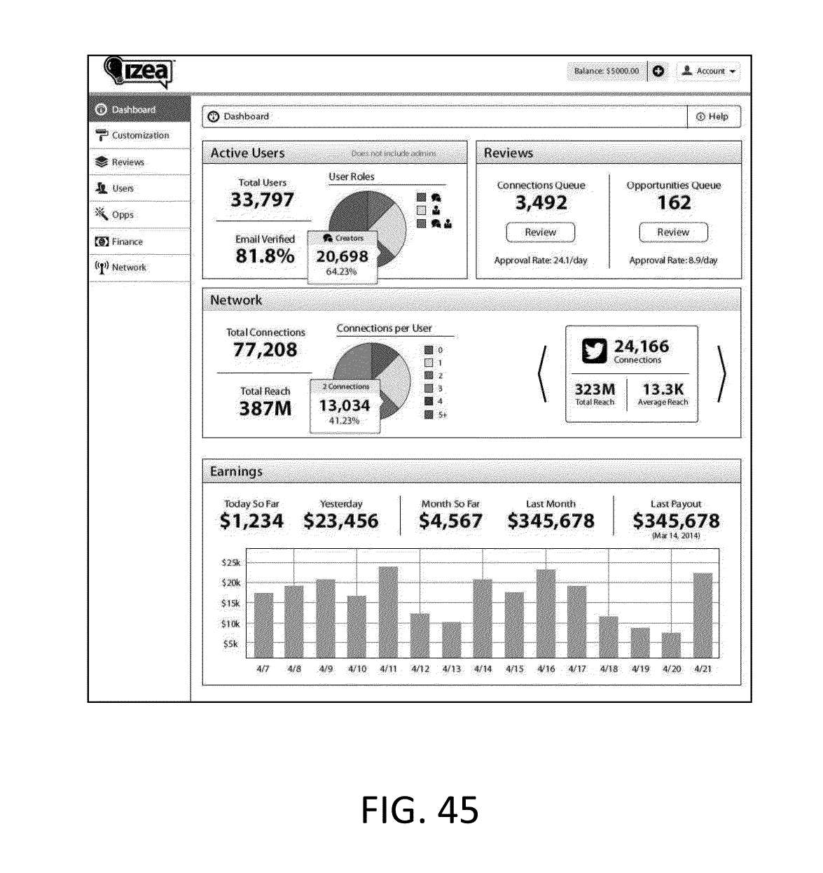

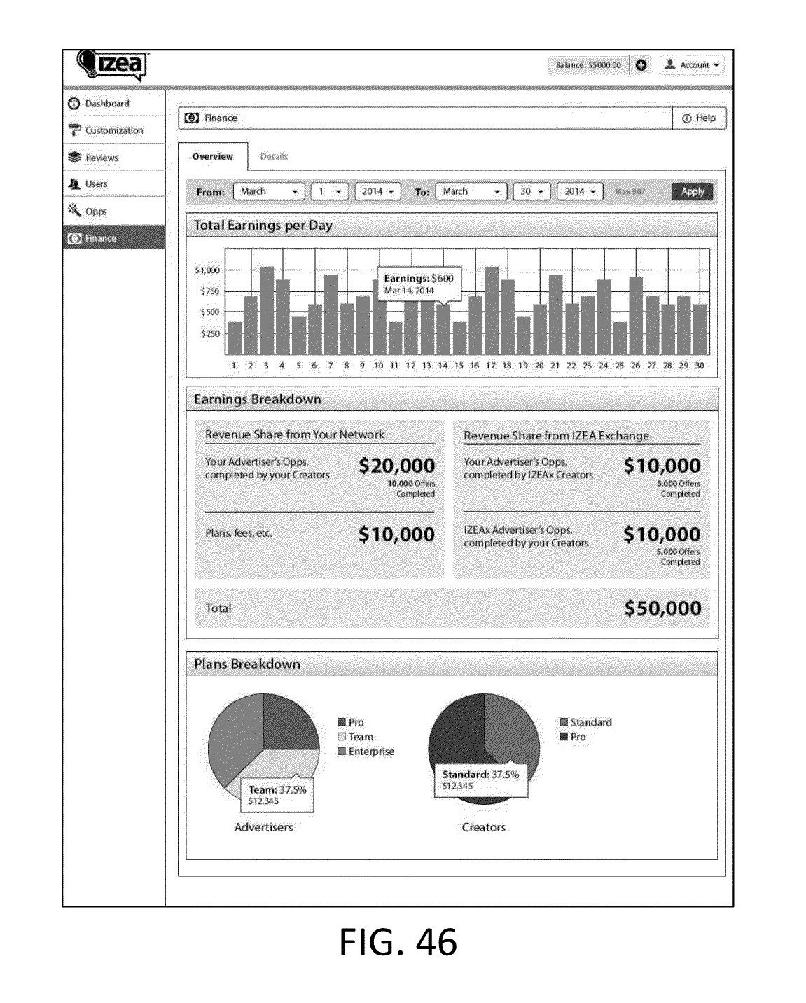

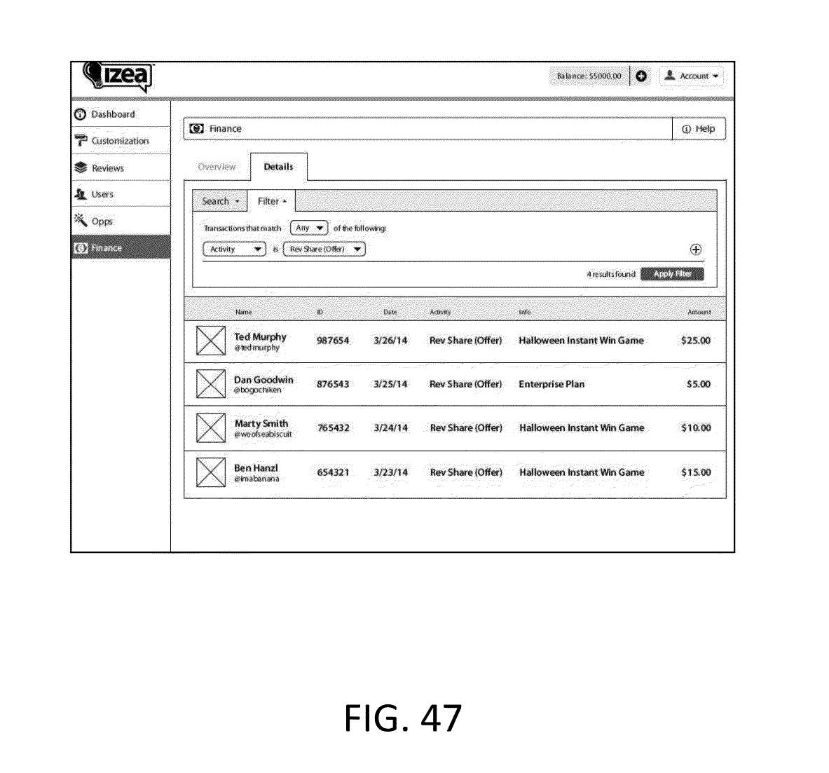

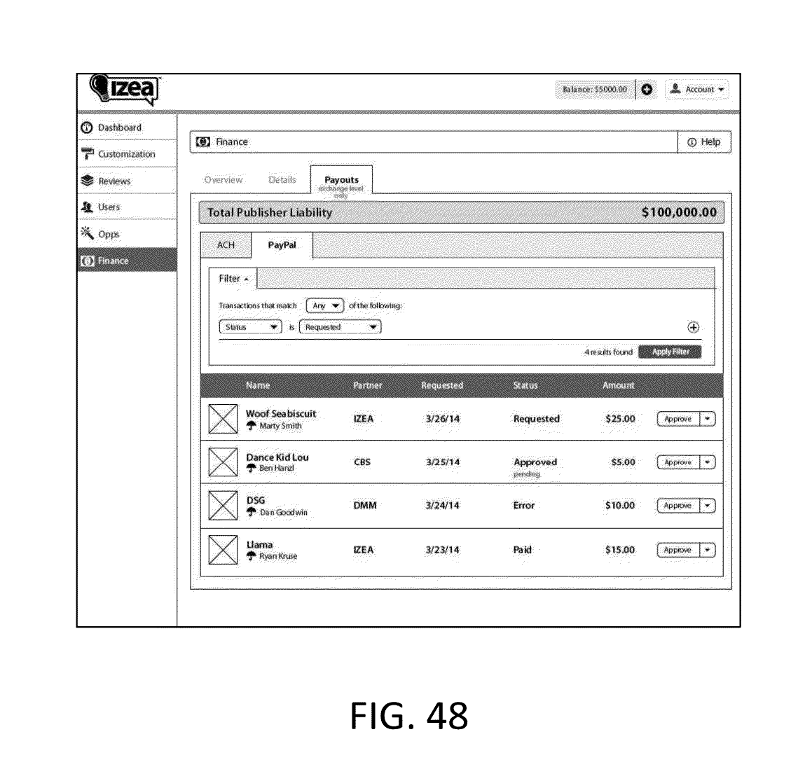

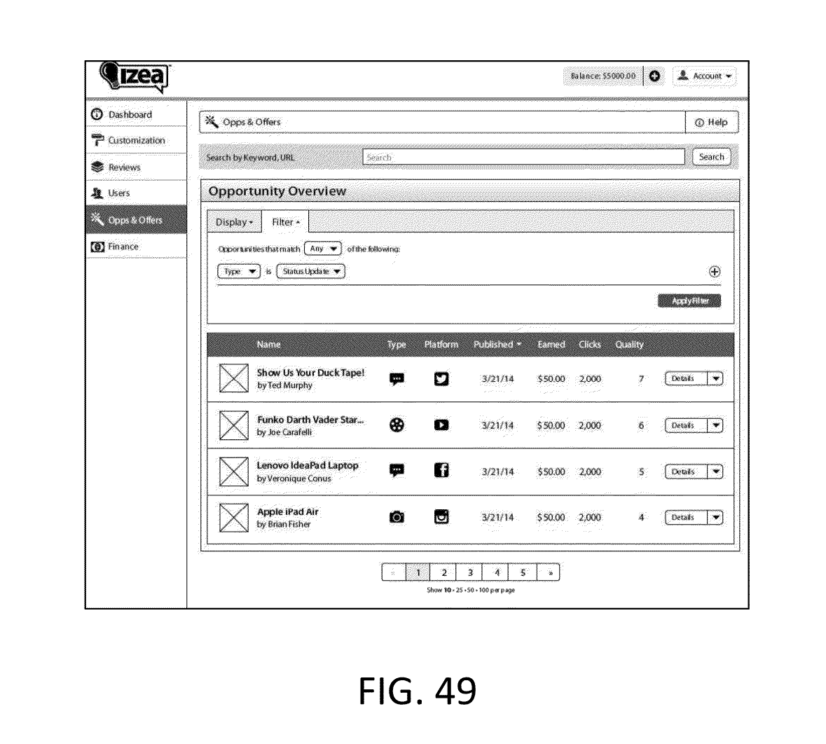

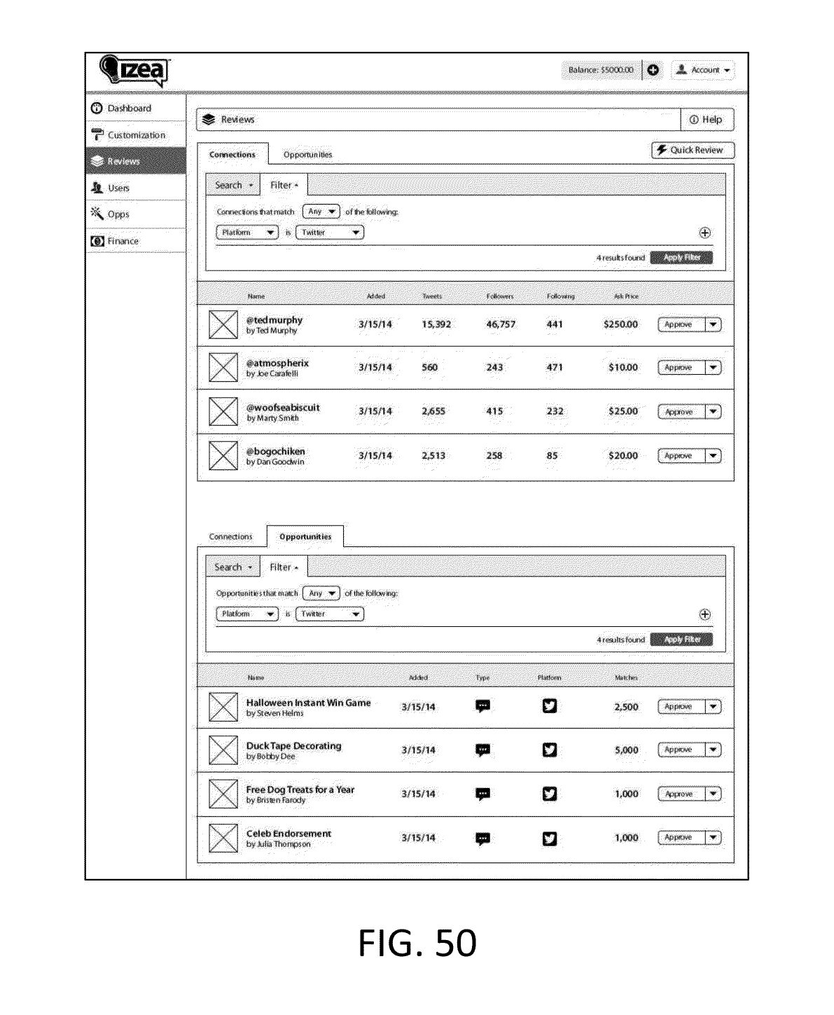

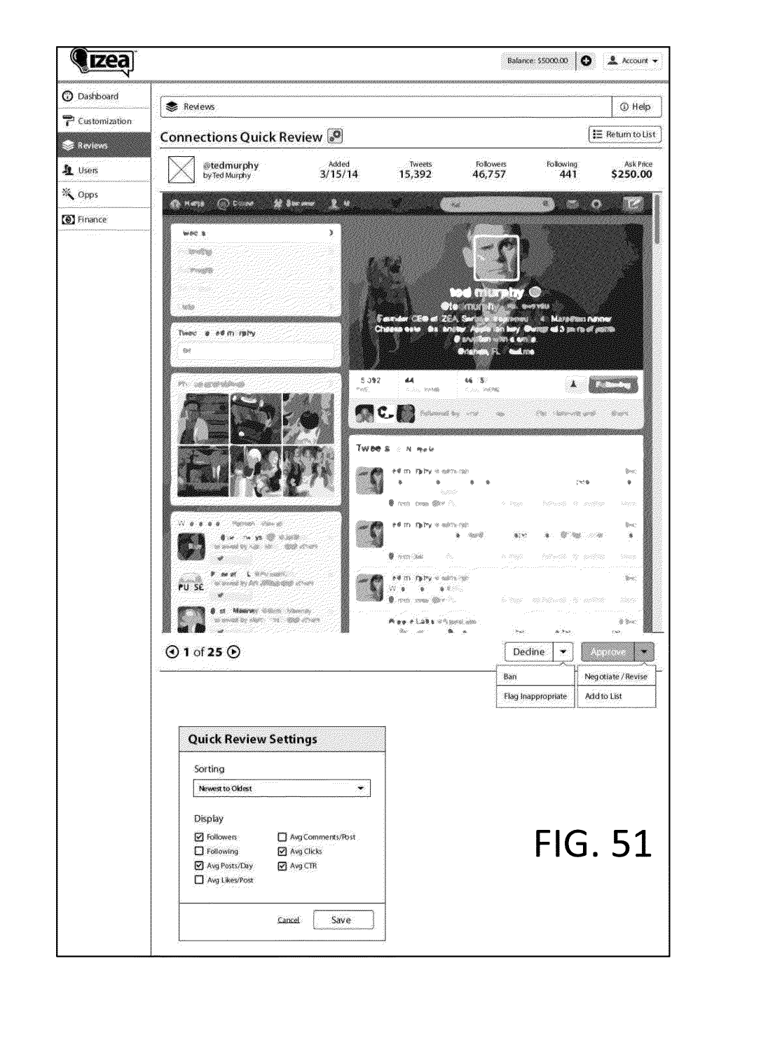

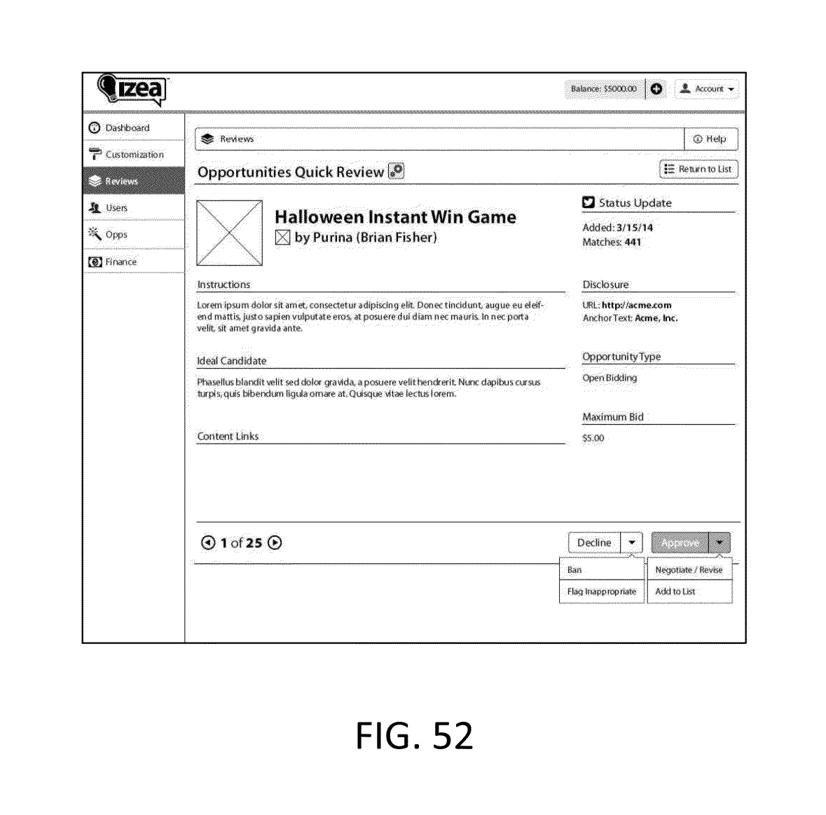

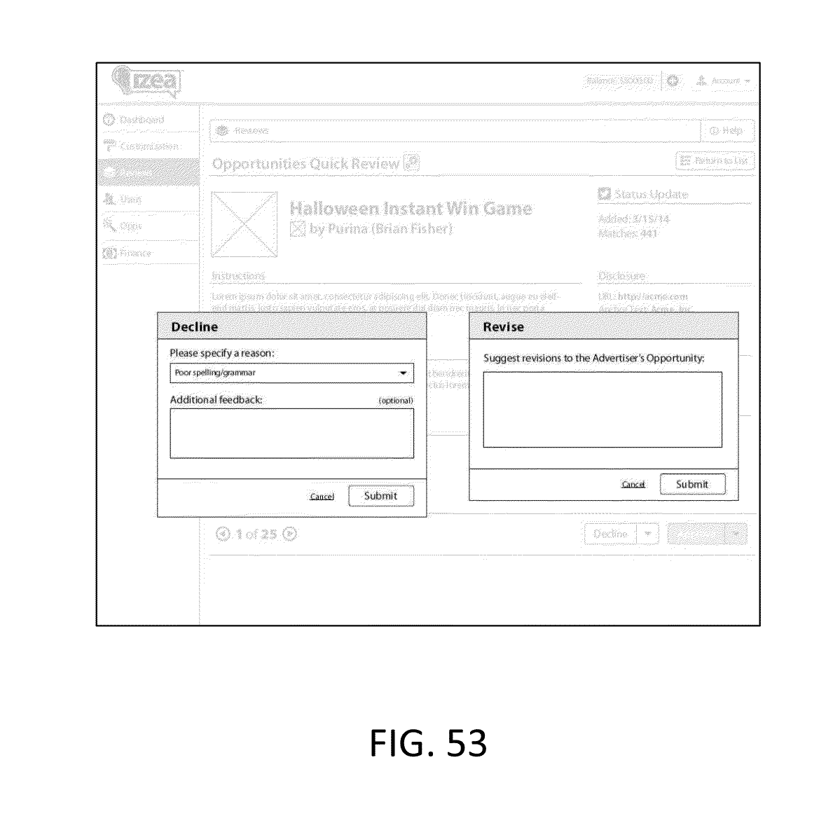

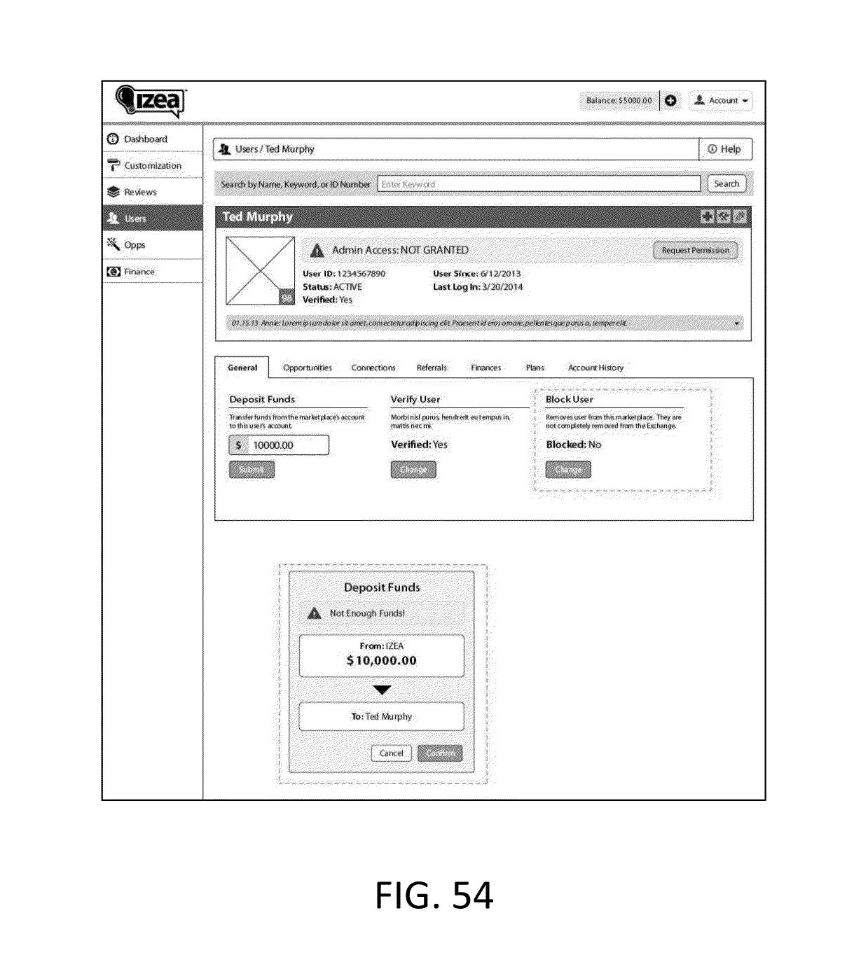

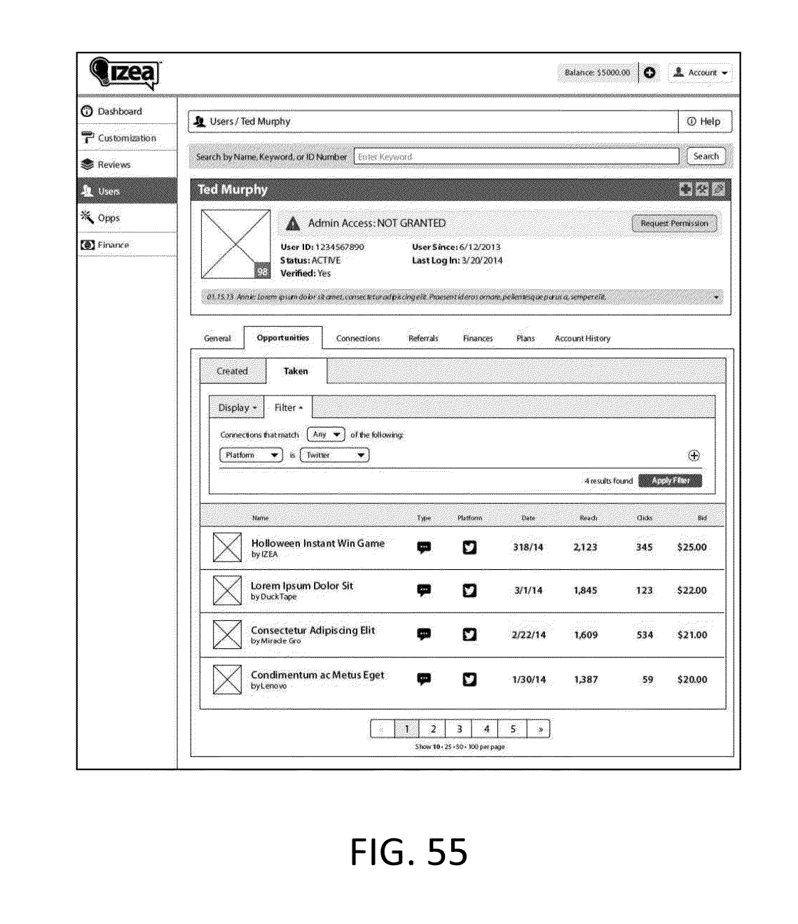

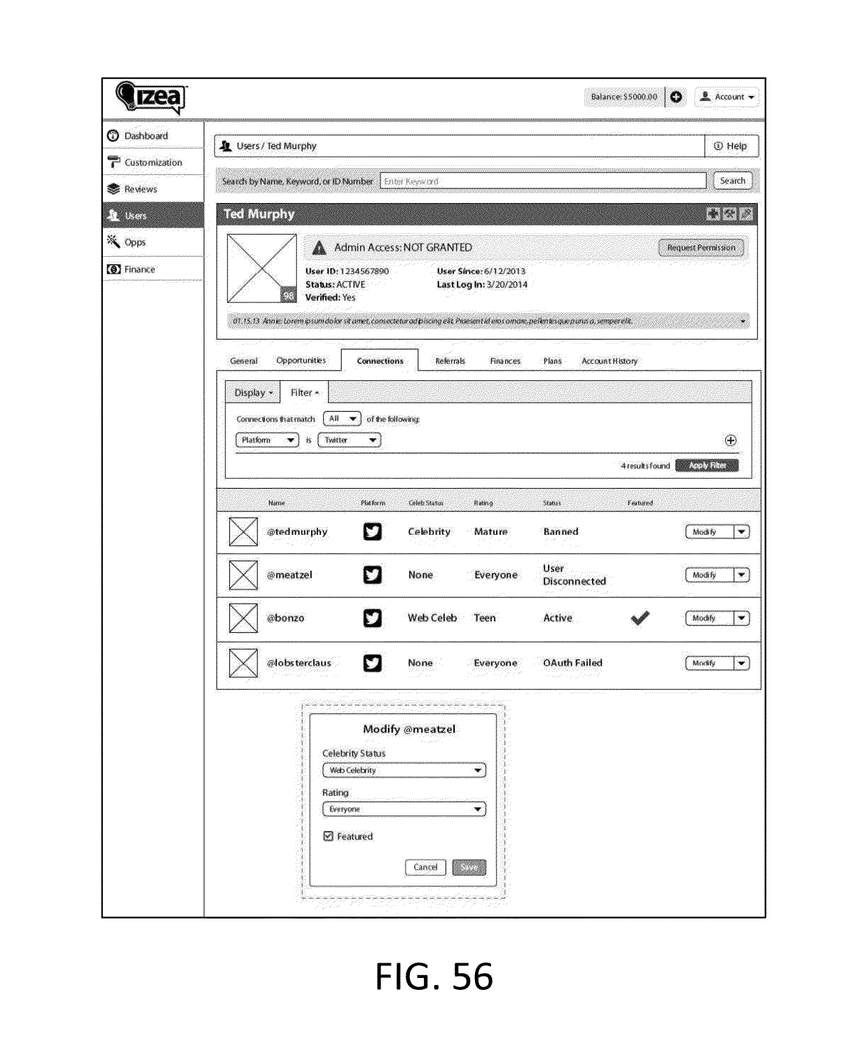

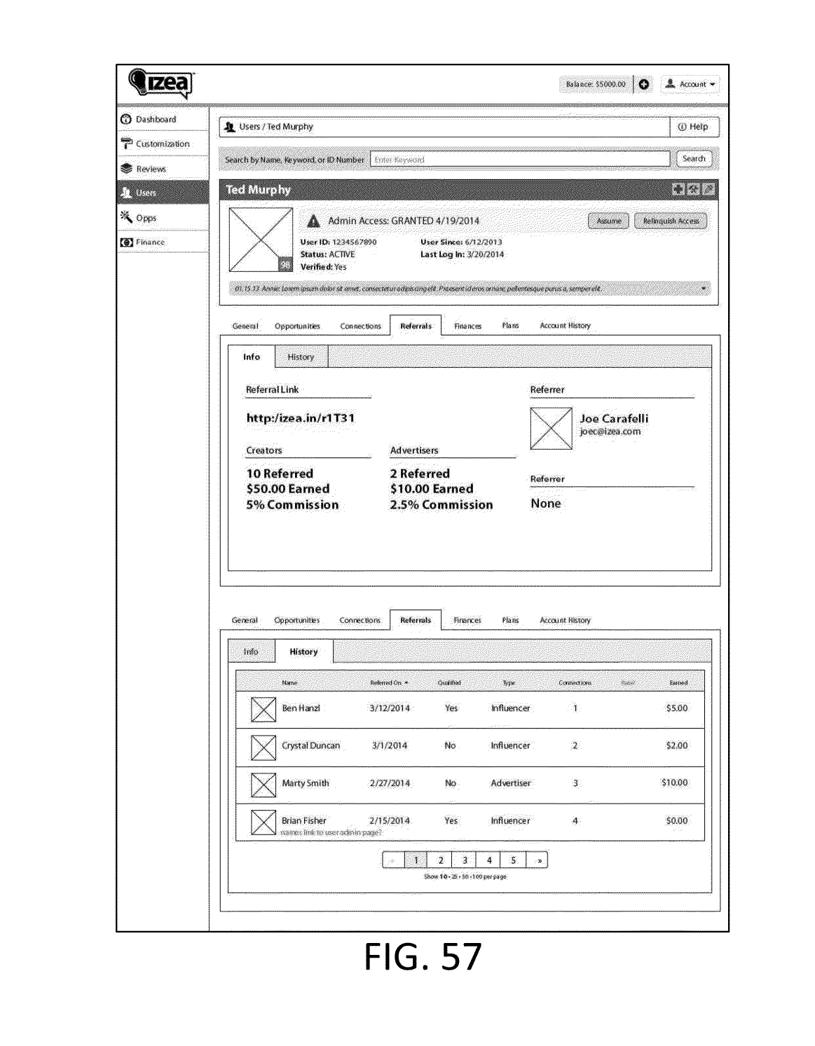

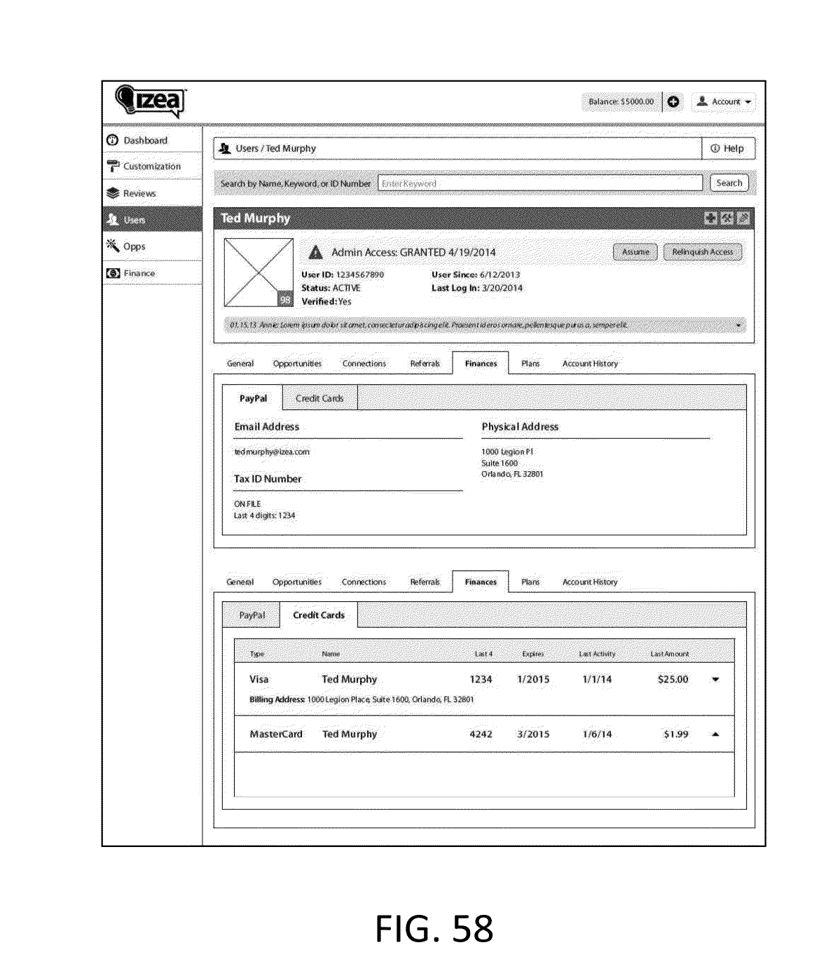

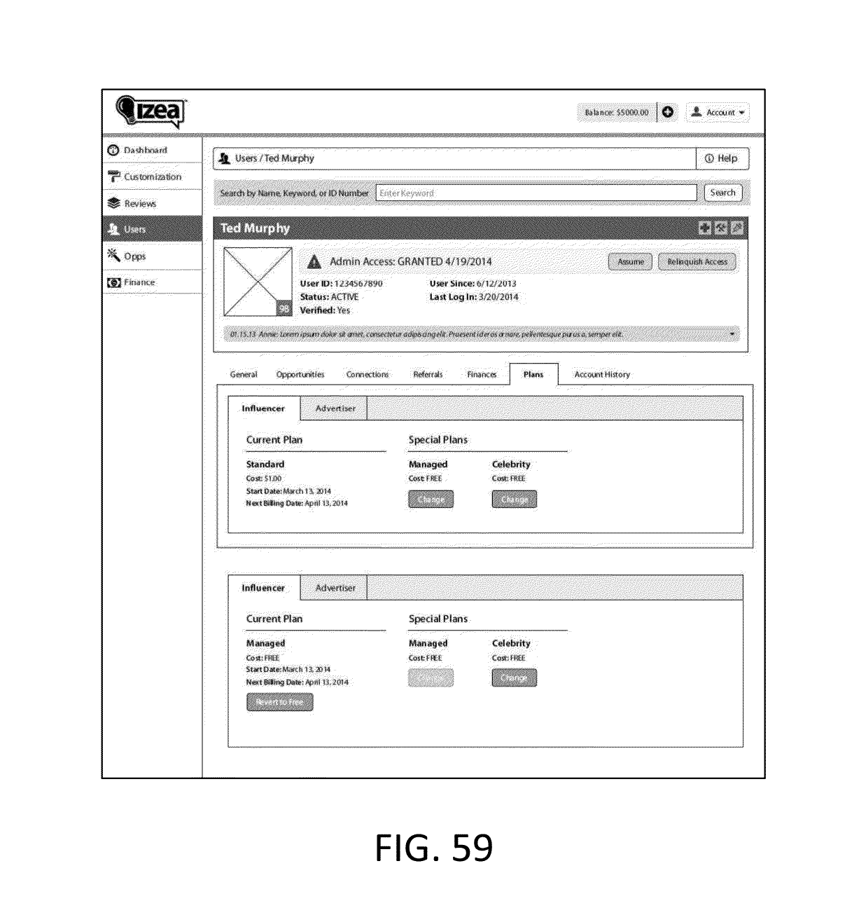

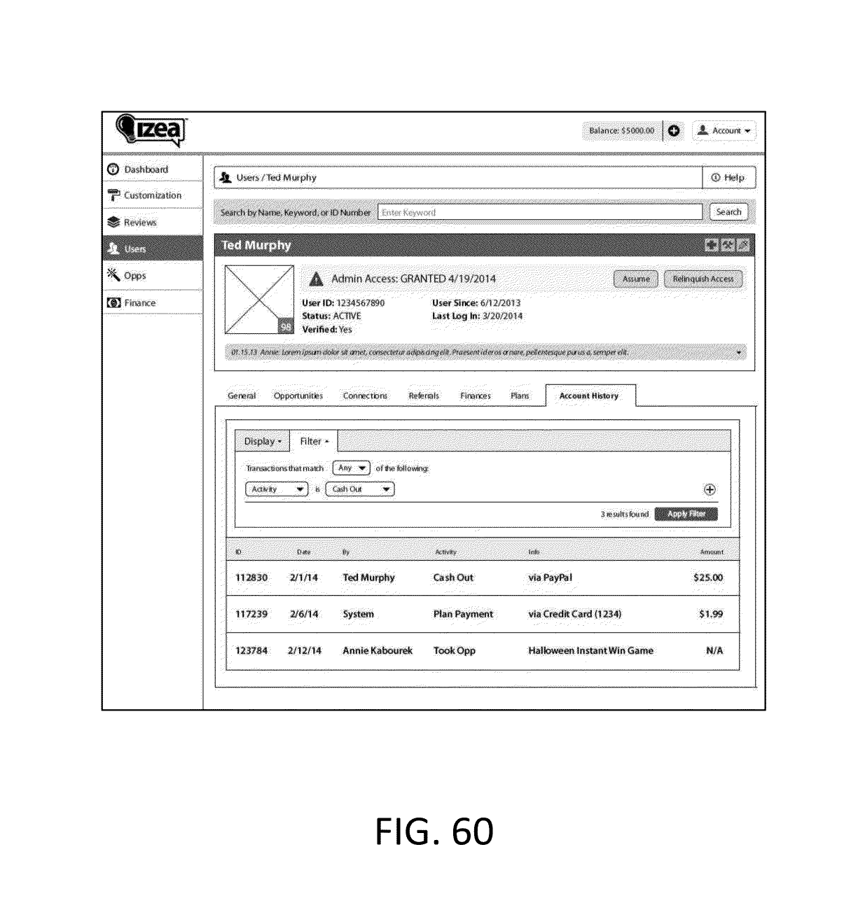

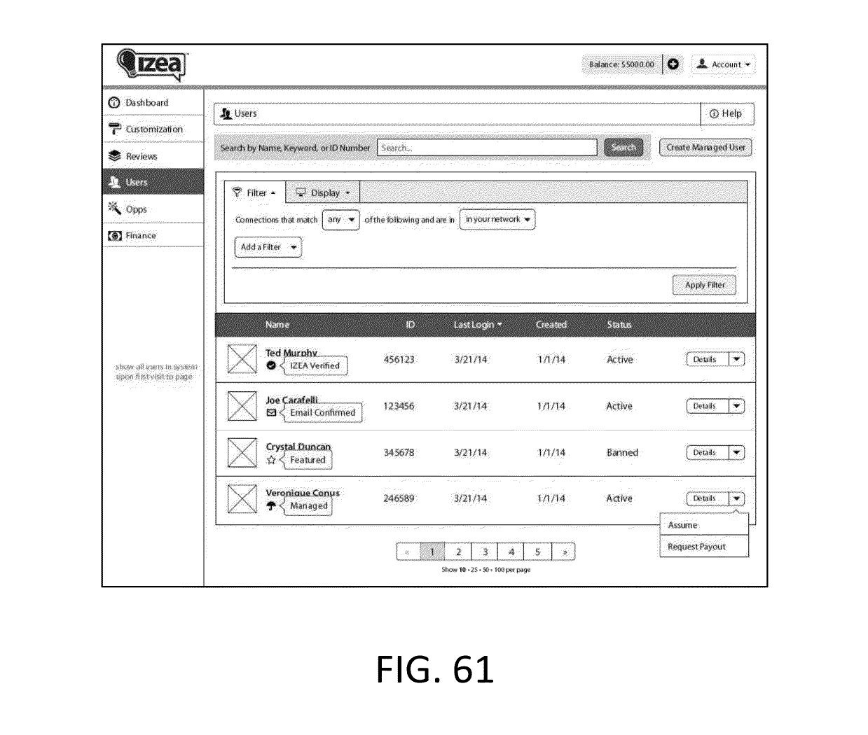

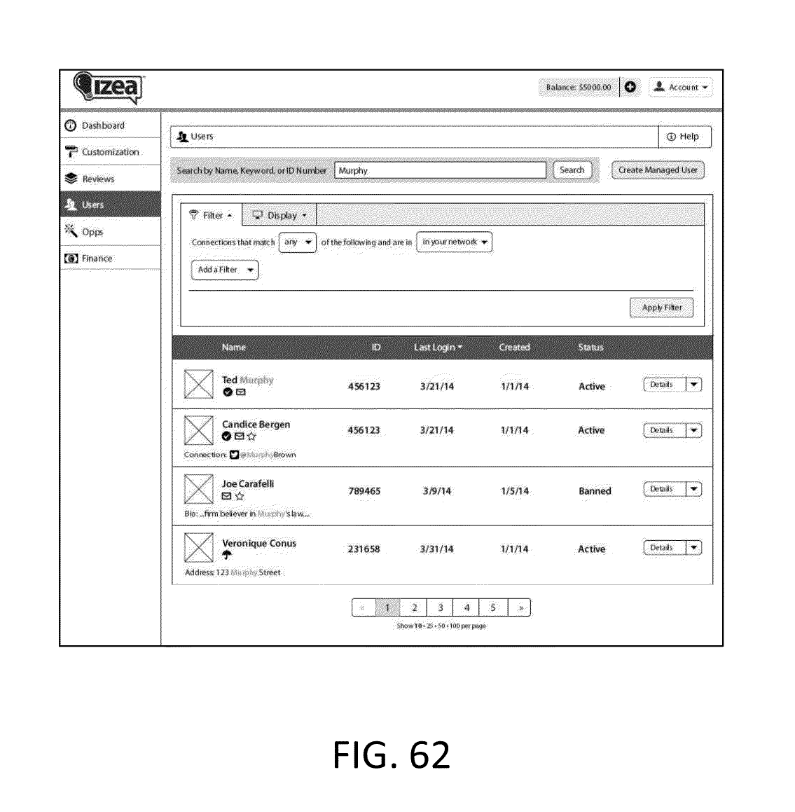

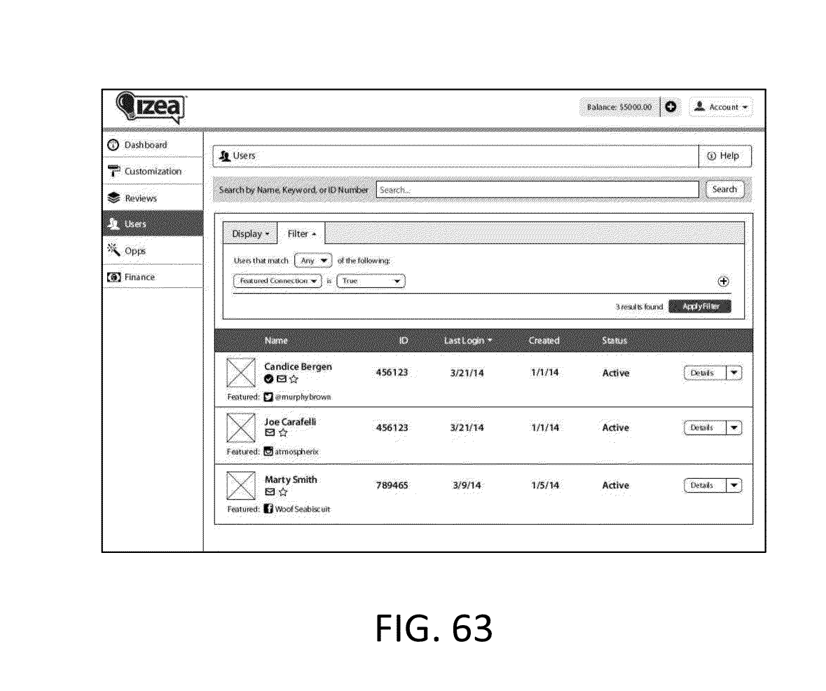

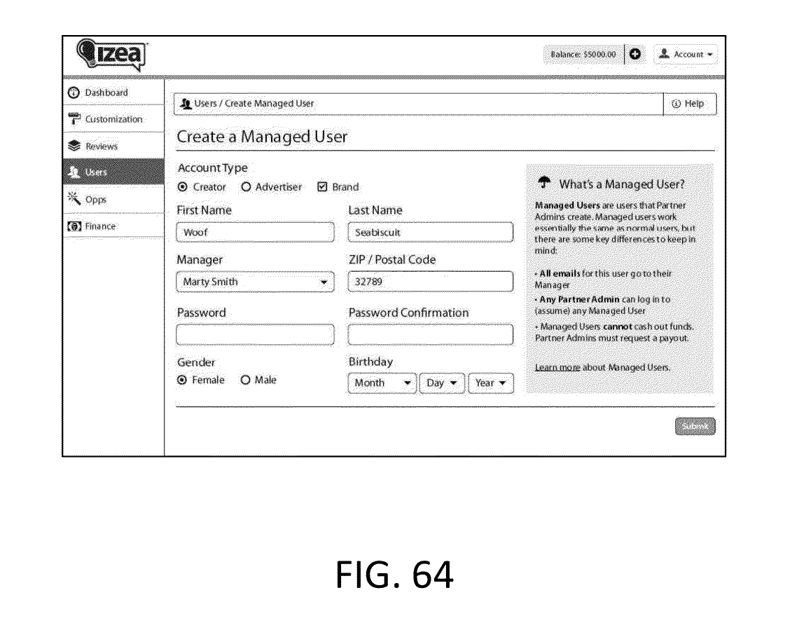

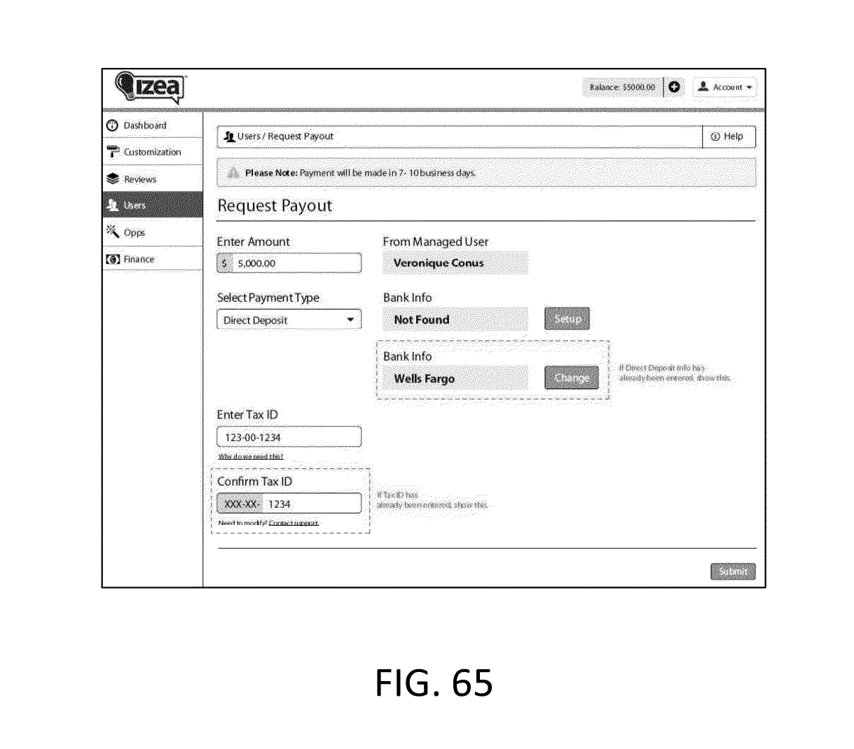

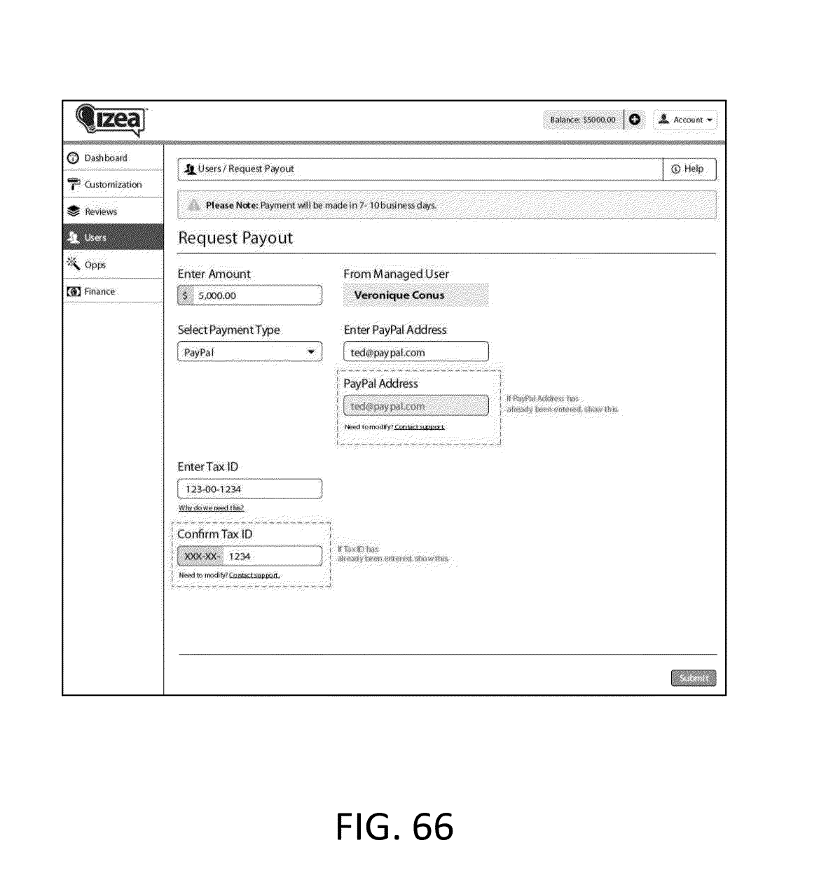

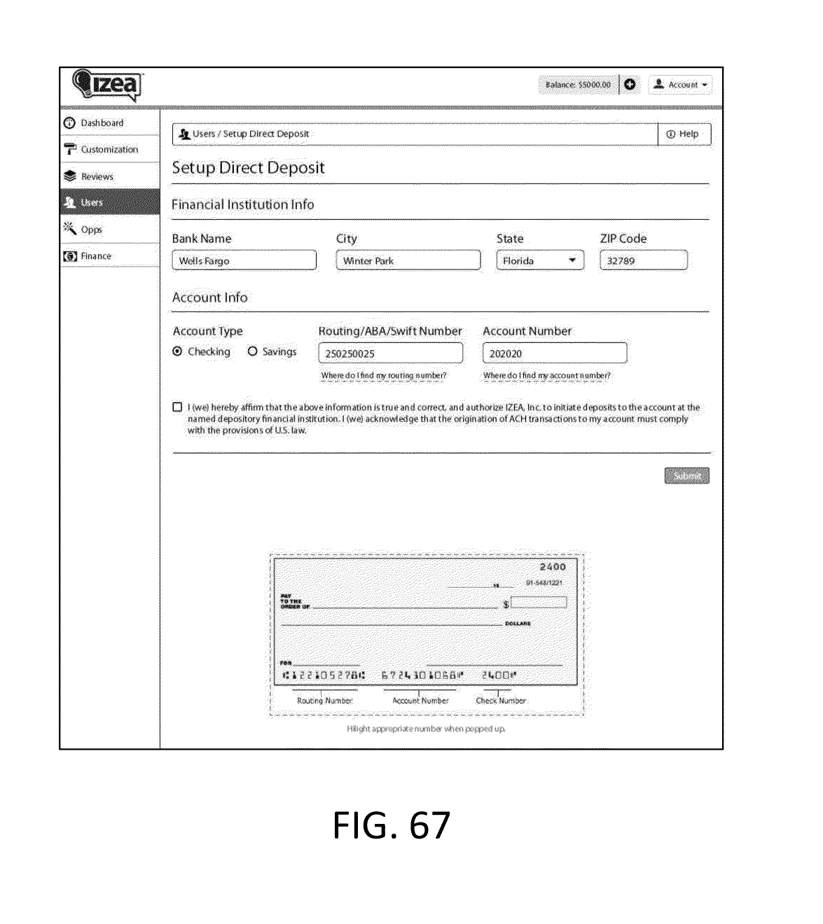

In one embodiment, each advertiser may have an advertiser profile accessible via the enterprise computing entity 100. An advertiser may also have multiple profiles and/or sub-profiles with varying rights and/or privileges (with a variety of usernames, passwords, authentication protocols, and/or the like for accessing the same)—similar to influencer/publisher profiles. Further, as previously described, the enterprise computing entity 100 may provide a single domain (izea.com), for instance, through which all advertisers and influencers/publishers communicate with one another to perform the functions described herein (e.g., operated by an independent third party of the influencers/publishers and advertisers, such as izea.com). In another embodiment, the enterprise computing entity 100 may be used to implement white label marketplaces. To do so, in one embodiment, the enterprise computing entity 100 can group certain advertisers (e.g., individuals, advertising agencies, companies, public relations firms, and/or the like) by advertising agency, publications firm, and/or the like. In so doing, all of the advertisers represented by Digitas, for example, may be accessible via the enterprise computing entity 100 through the appropriate section, search, and/or the like (similar to as shown in FIG. 37). In this embodiment, the advertisers represented by Digitas may be identified by performing the functions described herein. In another embodiment, the enterprise computing entity 100 may be used to implement white label marketplaces in which advertisers (e.g., individuals, advertising agencies, companies, public relations firms, and/or the like) and/or influencers/publishers (e.g., individuals, talent agencies, blog networks, crossover publishers, and/or the like) have unique domains (e.g., opportunities.digitas.com) that provide the appearance that they (not an izea.com, for instance) support the backbone of the enterprise computing entity 100 (e.g., via APIs in communication with the enterprise computing entity 100). In other words, advertisers (e.g., individuals, advertising agencies, companies, public relations firms, and/or the like) may have unique domains through which influencers/publishers (e.g., individuals, talent agencies, blog networks, crossover publishers, and/or the like) can accept and perform advertising opportunities. For instance, Digitas (e.g., opportunities.digitas.com) and Ketchum (e.g., opportunities.ketchum.com) may both have respective white label marketplaces through which they can provide advertising opportunities (e.g., on behalf of those they represent using multiple profiles or sub-profiles for the represented advertisers). For example, Digitas and Ketchum may provide one or more profiles or sub-profiles for those they represent to interact via the white label marketplace. Further, the enterprise computing entity 100 may configure the white label marketplaces such that only select influencers/publishers (e.g., individuals, talent agencies, blog networks, crossover publishers, and/or the like) have the ability to view and accept advertising opportunities offered by a given advertiser, such as creating a white label marketplace between Digitas and CAA. As will be recognized, this approach expands the opportunities for advertisers to offer the services of individuals or others they represent. As will be recognized, a variety of other approaches and techniques can be used to adapt to various needs and circumstances. FIGS. 40-42, 43A, 43B, and 44-67 show various views illustrating an example of administering a white label marketplace and as also described herein.

In one embodiment, as shown in FIGS. 4A and 4B, an advertiser or someone on behalf of an advertiser (e.g., operating an advertiser computing entity 110 executing an advertiser application, browser, dashboard, user interface, and/or the like) can input various information to create or update an advertiser profile for storage and use by the enterprise computing entity 100 (e.g., via an advertiser database). Such profiles can be created, stored, edited, and/or customized manually, automatically, and/or semi-automatically to adapt to various needs and circumstances.

In one embodiment, an advertiser profile may include an advertiser name, email addresses, avatar, picture, birthday, financial account information, phone numbers, addresses, and/or the like. The advertiser may also input (or the enterprise computing entity 100 may collect/determine) the geographic area of the advertiser or the geographic areas for which the advertiser is seeking influence, such as United States (e.g., regions or areas within the same), Canada (e.g., regions or areas within the same), North America (e.g., regions or areas within the same), South America (e.g., regions or areas within the same), Europe (e.g., regions or areas within the same), Asia (e.g., regions or areas within the same), and Australia (e.g., regions or areas within the same), and/or the like. The advertiser may also input an age range of the advertiser or age ranges of the people for whom the advertiser is seeking to influence or publish content, such as under 18, 18+, 21+, Gen Y'ers, Gen X'ers, Baby Boomers. Seniors, and/or the like. The advertiser may also input areas of interest to the advertiser or areas of interest of the people for whom the advertiser is seeking to influence or publish content, such as Technology, Beauty, Business, Fashion, Lifestyle, Health, Pop Culture, Entertainment, Social Media, Advertising, Video Games, Travel, Family, Celebrity, and/or the like. And the advertiser may also input the life stage of the advertiser or the life stages of the people for whom the advertiser is interested in influencing, such as in college, kids in elementary, kids in high school, kids in college, and/or the like. The advertiser may also input the advertiser's profession or area of his or her profession or the areas of the professions of the people for whom the advertiser is seeking to influence or publish content, such as Agricultural, Mining, Utilities, Construction, Manufacturing, Transportation, Wholesale, Retail, Information, Financial, Real Estate, Professional, Management, Administrative, Education, Health Care, Arts/Entertainment, Food/Hospitality, Public/Government, Other, and/or the like. As will be recognized, a variety of other techniques and approaches (and combinations of the above) can be used to adapt to various needs and circumstances.

In one embodiment, through such profiles, advertisers (e.g., individuals, advertising agencies, companies, public relations firms, and/or the like) may have to ability to “watch” influencers/publishers, watch bids over a configurable threshold, and/or the like. Similarly, advertiser (e.g., operating an advertiser computing entity) may also have the ability to receive notifications for bids, referrals, acceptances, and/or the like. As will be recognized, a variety of other approaches and techniques can be used to adapt to various needs and circumstances.

### Advertising Opportunities

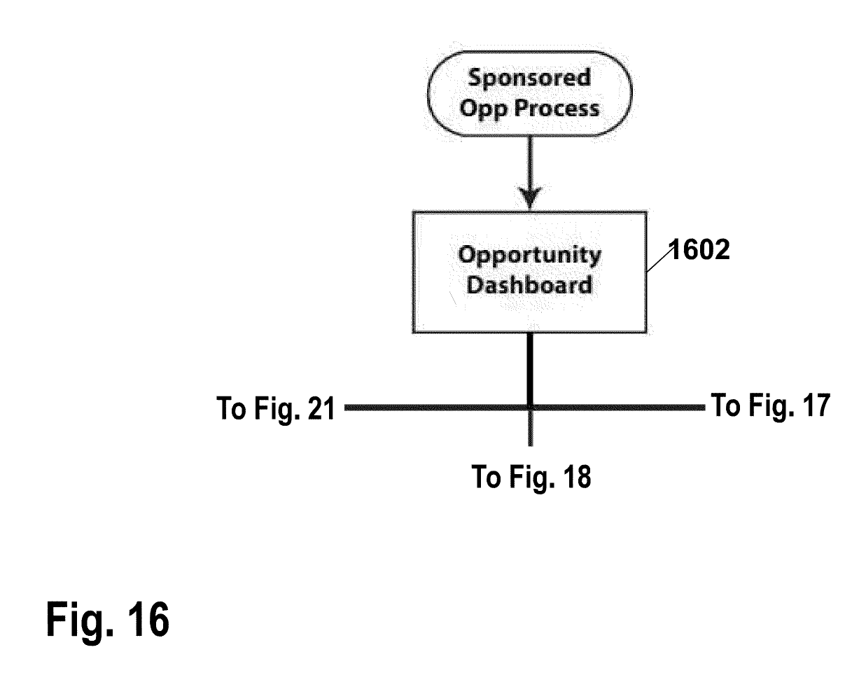

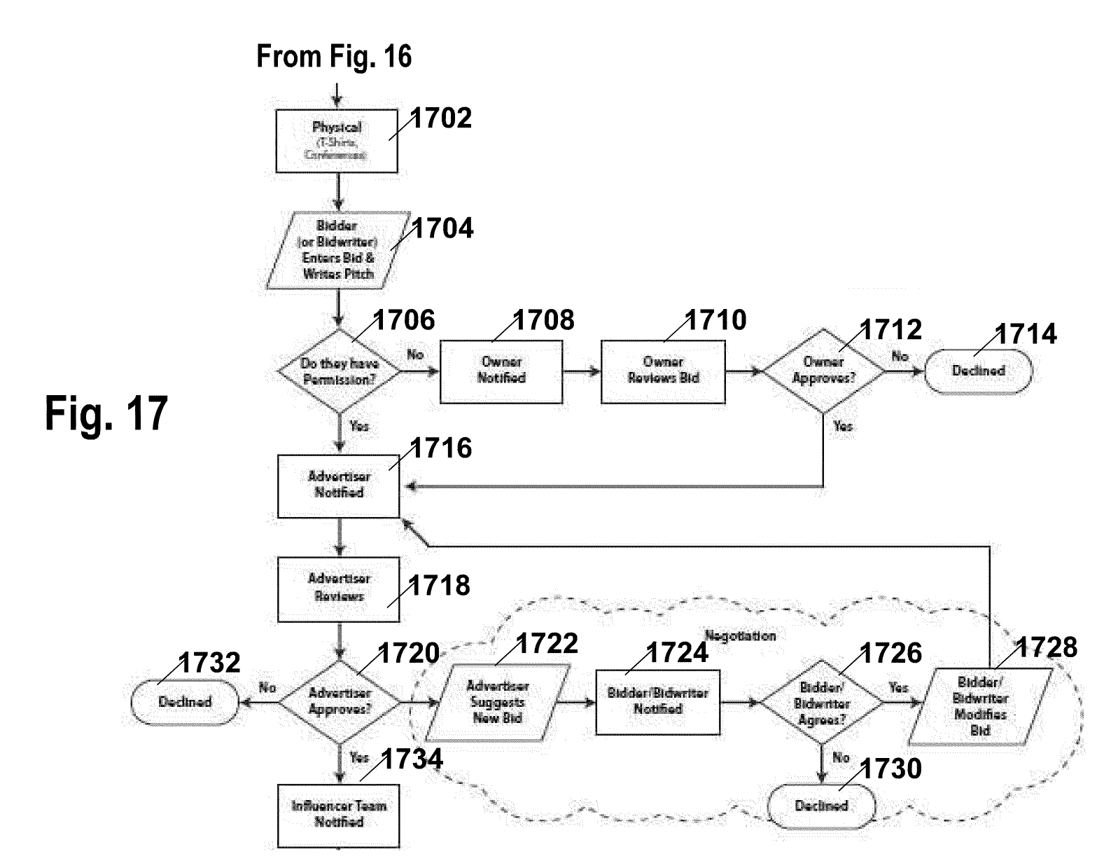

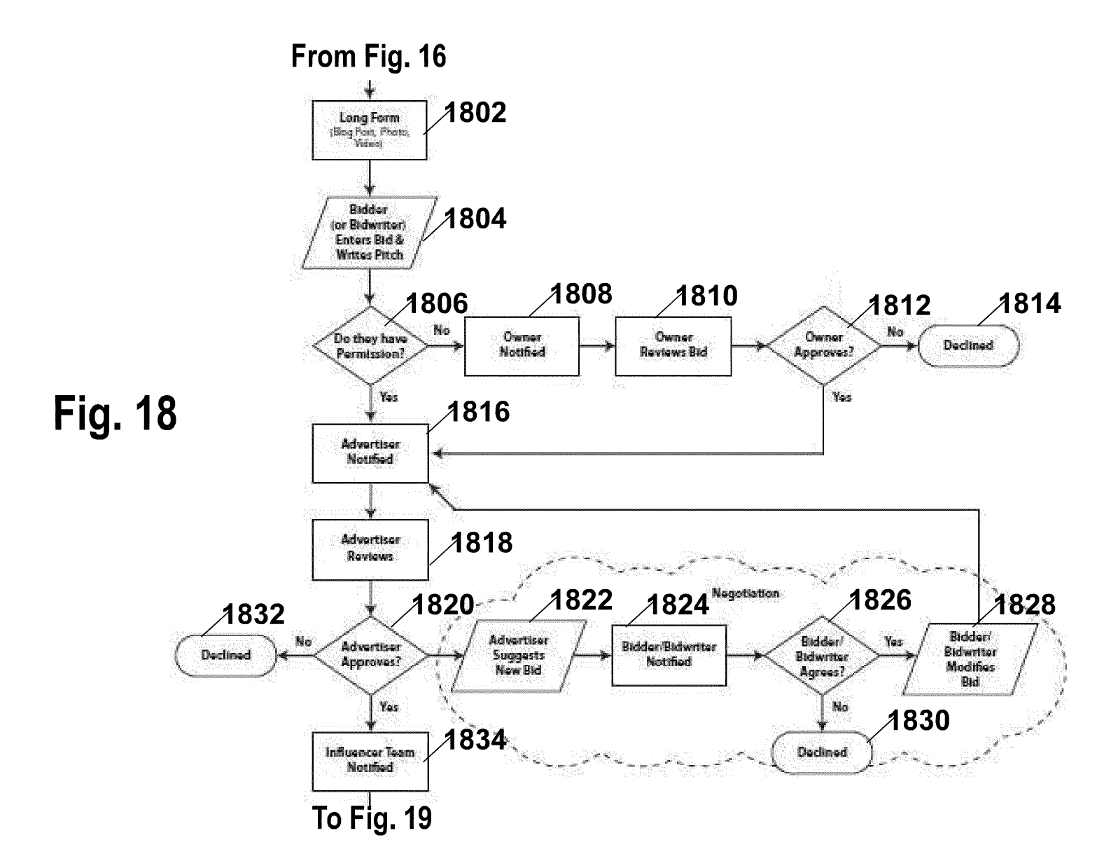

In one embodiment, an advertiser (e.g., in communication with an enterprise computing entity 100) can input or provide one or more advertising opportunities, as indicated by block 1602 of FIG. 16. As noted, advertising opportunities may be opportunities to receive payment or some other incentive for advertising (e.g., promoting, influencing, etc.) a product, service, article, photograph, blog, offering, opportunity, position, event, show, program, and/or the like.

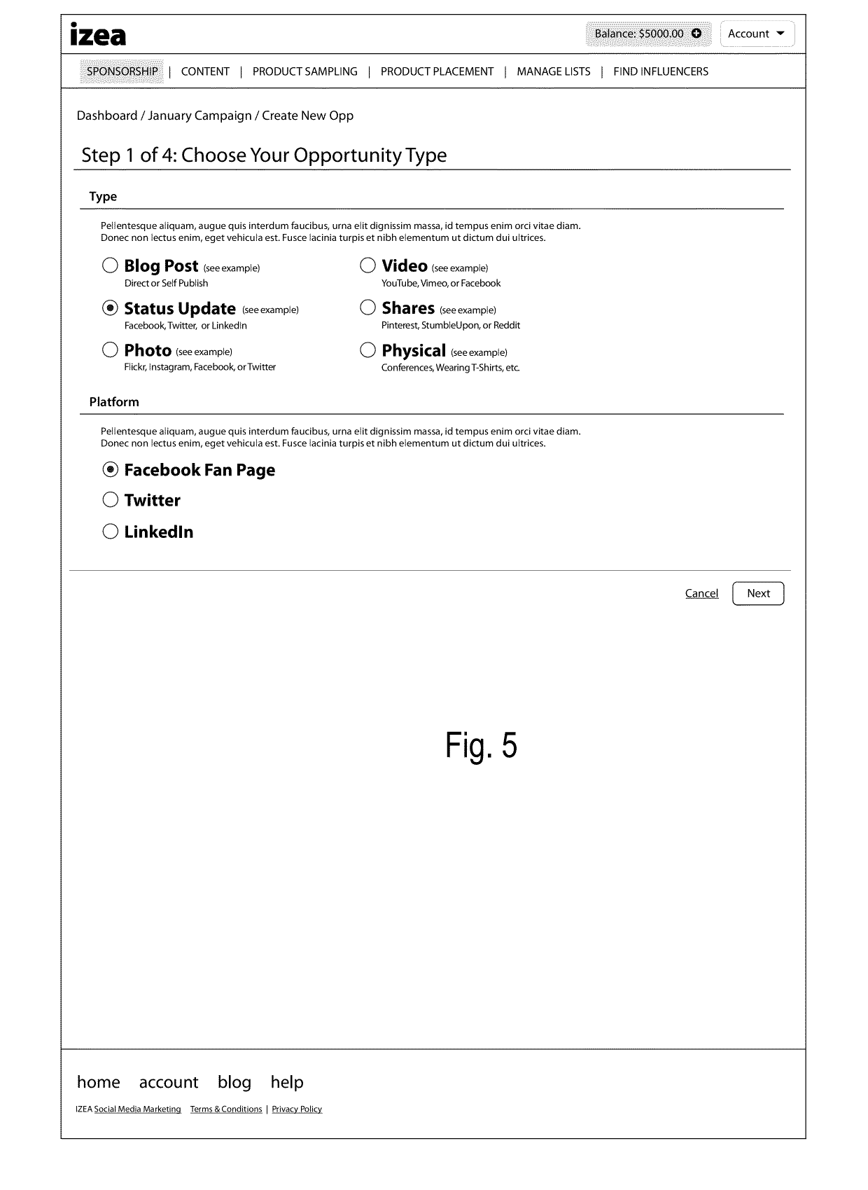

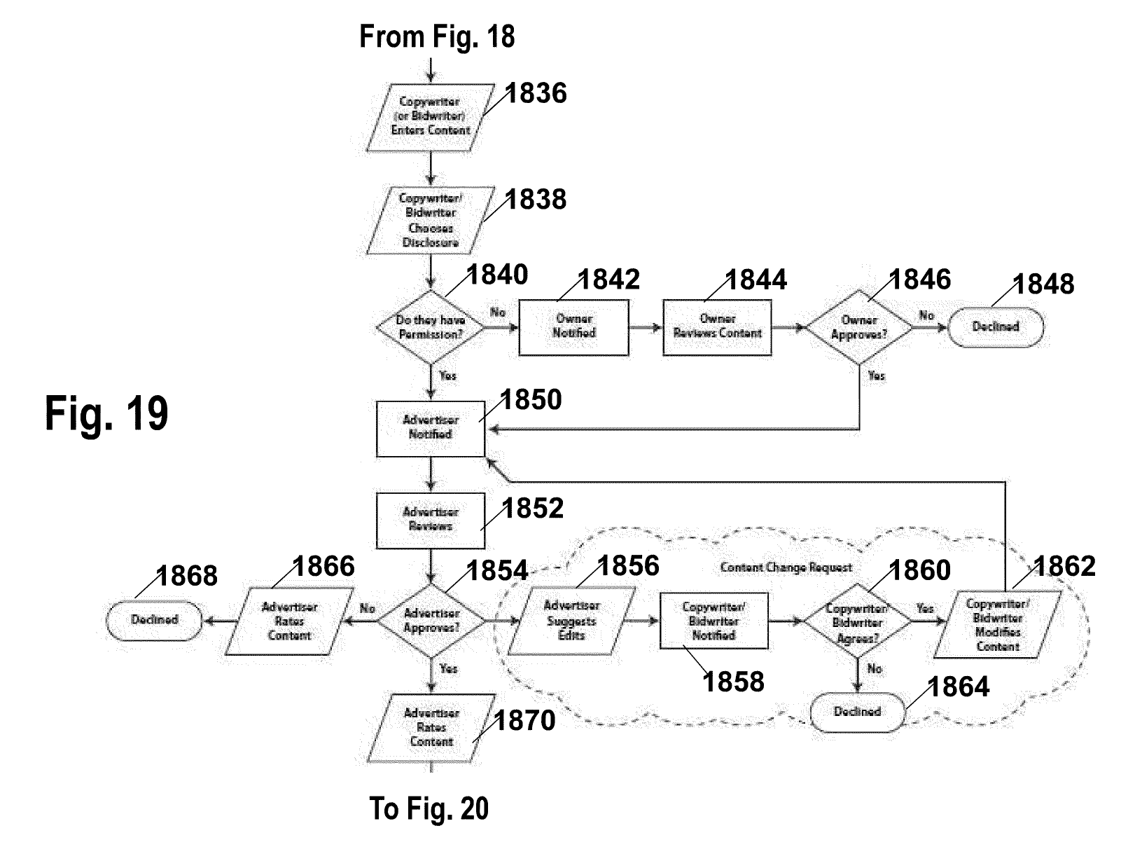

In one embodiment, an advertiser (e.g., operating an advertiser computing entity 110 executing an advertiser application, browser, dashboard, user interface, and/or the like) may first input the “type” of advertising opportunity (see FIGS. 5, 30, and 31) for storage by the enterprise computing entity 100, as shown by blocks 1702 of FIG. 17, block 1802 of FIG. 18, and block 2102 of FIG. 21. For instance, the advertising opportunity types may be Sponsored Content, such as blog posts, updates (e.g., Facebook, Twitter, LinkedIn, etc.), photos (e.g., Flickr, Instagram, Facebook, Twitter, etc.), videos (e.g., Facebook, Vimeo, YouTube, etc.), shares (Pinterest, StumbleUpon, Reddit, etc.), and/or the like. Further, the advertising opportunity may be physical, such as attending conferences, wearing apparel, guest appearances, verbal mentions, guerilla marketing, and/or the like. As will be recognized, a variety of other advertising opportunity types can be used to adapt to various needs and circumstances. If appropriate, the advertiser (e.g., operating an advertiser computing entity 110 in communication with an enterprise computing entity 100) can also specify the platform for the advertising opportunity.

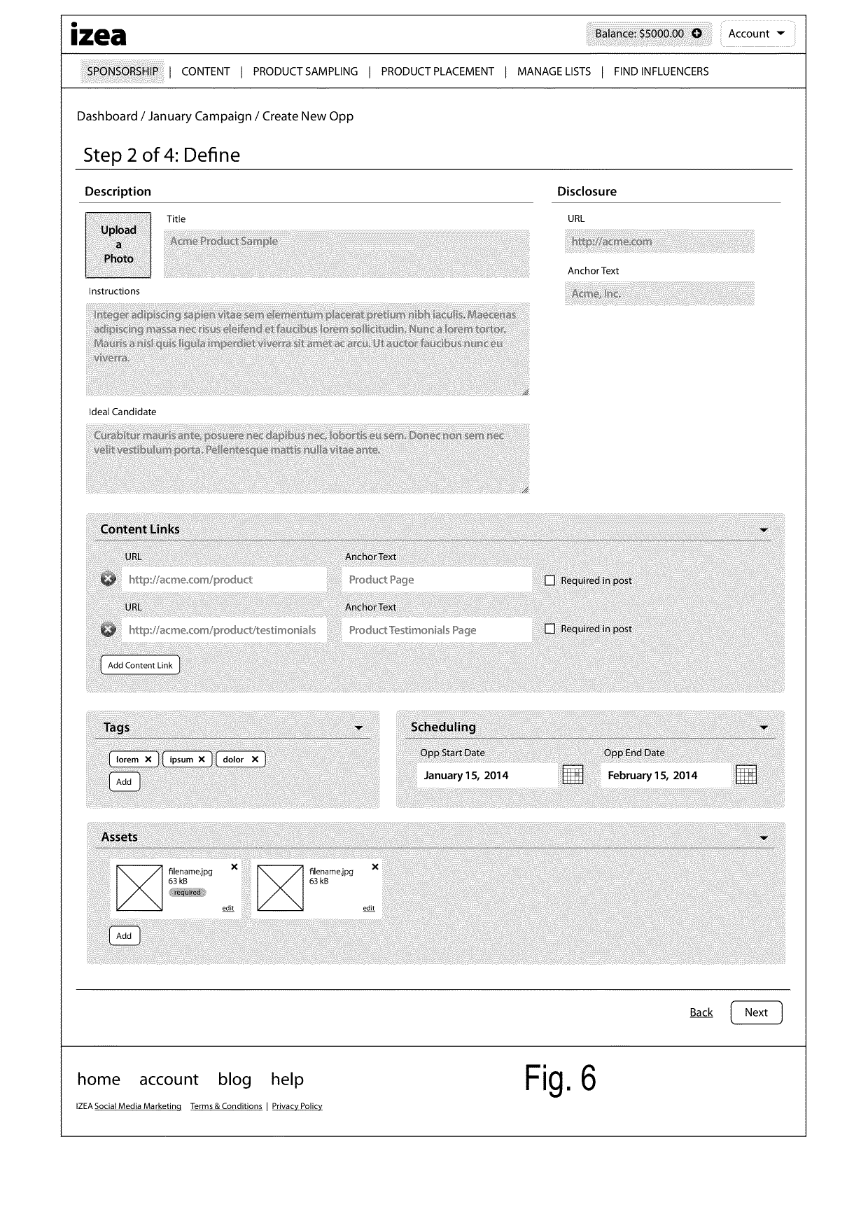

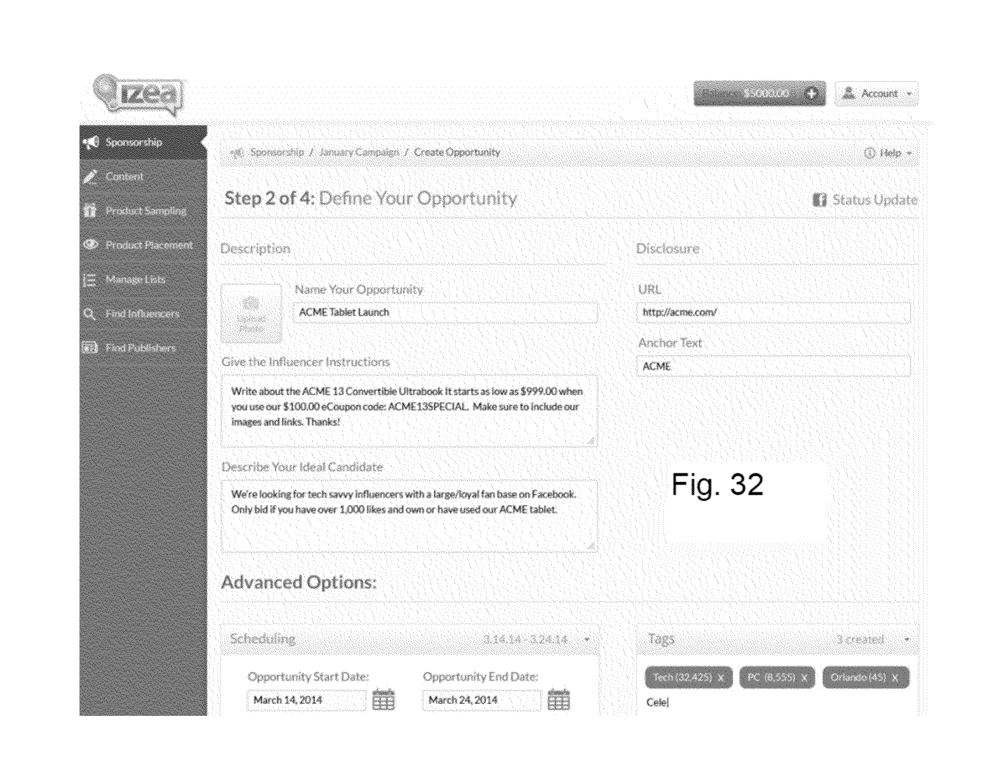

As seen in FIGS. 6 and 32, an advertiser (e.g., operating an advertiser computing entity 110 in communication with an enterprise computing entity 100) can also describe or further define the advertising opportunity. For example, the advertiser (e.g., operating an advertiser computing entity 110 in communication with an enterprise computing entity 100) may input a description that includes a photograph or image, a title, instructions for carrying out the advertising opportunity, a description of the ideal influencer/publisher, and/or the like. The advertiser (e.g., operating an advertiser computing entity 110 in communication with an enterprise computing entity 100) may also input one more content links (and corresponding anchor text) that must be used in carrying out the advertising opportunity. The advertiser (e.g., operating an advertiser computing entity 110 in communication with an enterprise computing entity 100) may also input one or more tags or keywords to help appropriate influencers/publishers in identifying the advertising opportunity. The advertiser (e.g., operating an advertiser computing entity 110 in communication with an enterprise computing entity 100) may also input the start and end dates for the advertising opportunity. As will be recognized, a variety of information can be used to define or describe the advertising opportunity to adapt to various needs and circumstances.

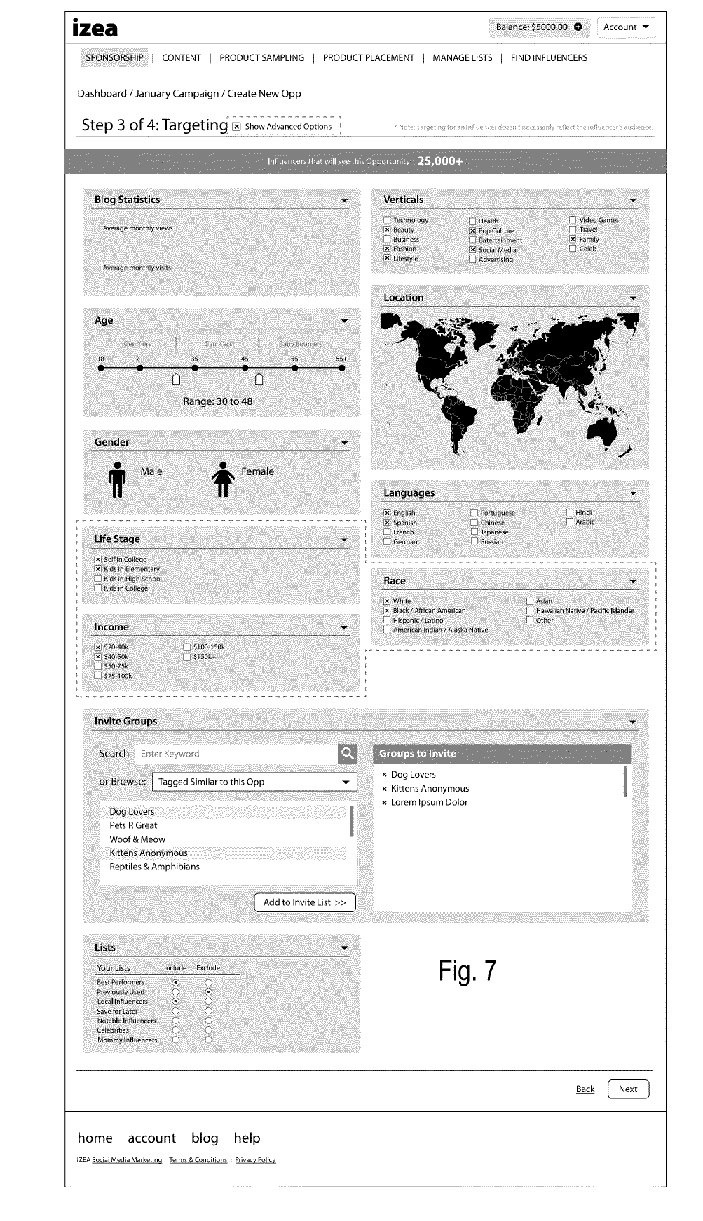

As previously noted, in addition to describing the advertising opportunity, the advertiser (e.g., operating an advertiser computing entity 110 in communication with an enterprise computing entity 100) may also input information describing one or more ideal influencers/publishers and/or the target audience for the advertising opportunity (see FIG. 7). For example, the advertiser (e.g., operating an advertiser computing entity 110 in communication with an enterprise computing entity 100) may input one more interest areas that may correspond to an ideal influencer/publisher and/or the target audience, such as Technology, Beauty, Business, Fashion, Lifestyle, Health, Pop Culture, Entertainment, Social Media, Advertising, Video Games, Travel, Family, Celebrity, and/or the like. The advertiser (e.g., operating an advertiser computing entity 110) may also input one or more geographic areas that may correspond to an ideal influencer/publisher and/or the target audience, such as United States (e.g., regions or areas within the same), Canada (e.g., regions or areas within the same), North America (e.g., regions or areas within the same), South America (e.g., regions or areas within the same), Europe (e.g., regions or areas within the same), Asia (e.g., regions or areas within the same), and Australia (e.g., regions or areas within the same), and/or the like. The advertiser (e.g., operating an advertiser computing entity 110) may also input an age range that may correspond to an ideal influencer/publisher and/or the target audience. Other information that may be used to describe an ideal influencer/publisher and/or the target audience may include gender, languages spoken, life stage, income level, and/or the like. In one embodiment, the advertiser (e.g., operating an advertiser computing entity 110 in communication with an enterprise computing entity 100) may also input certain tags or keywords or invite/notify certain groups that may correspond to one or more ideal influencers/publishers and/or the target audience. And the advertiser (e.g., operating an advertiser computing entity 110) may also define lists or categories of influencers/publishers to include or exclude in the campaign for the advertising opportunity.

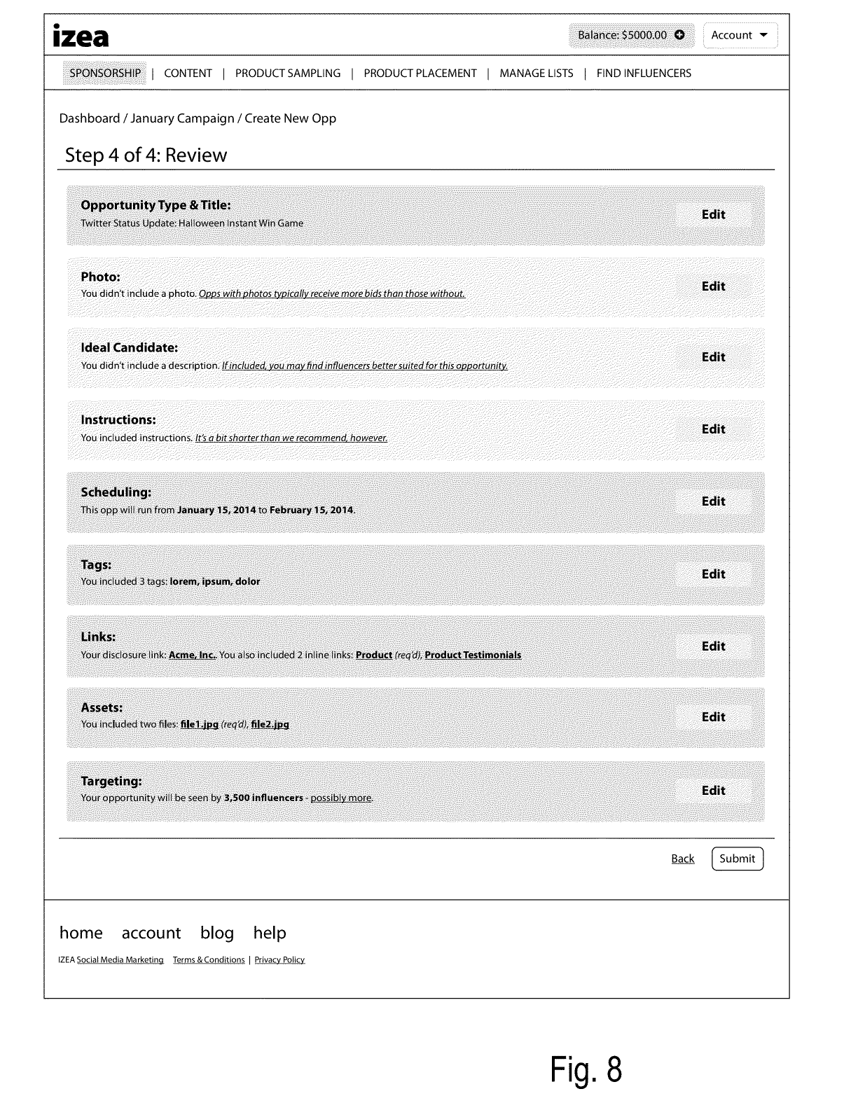

In one embodiment, as an advertiser (e.g., operating an advertiser computing entity 110) inputs information describing one or more ideal influencers/publishers and/or the target audience, the advertiser computing entity 110 in communication with an enterprise computing entity 100 can cause display of the number of influencers/publishers, for example, that satisfy the description of requirements of the advertising opportunity. This may be helpful for advertisers to know whether they should further define or loosen the criteria defining ideal influencers/publishers and/or the target audience. As shown in FIG. 8, an advertiser (e.g., operating an advertiser computing entity 110) can review the information input for the advertising opportunity and submit the same when ready to initiate a campaign for the advertising opportunity.

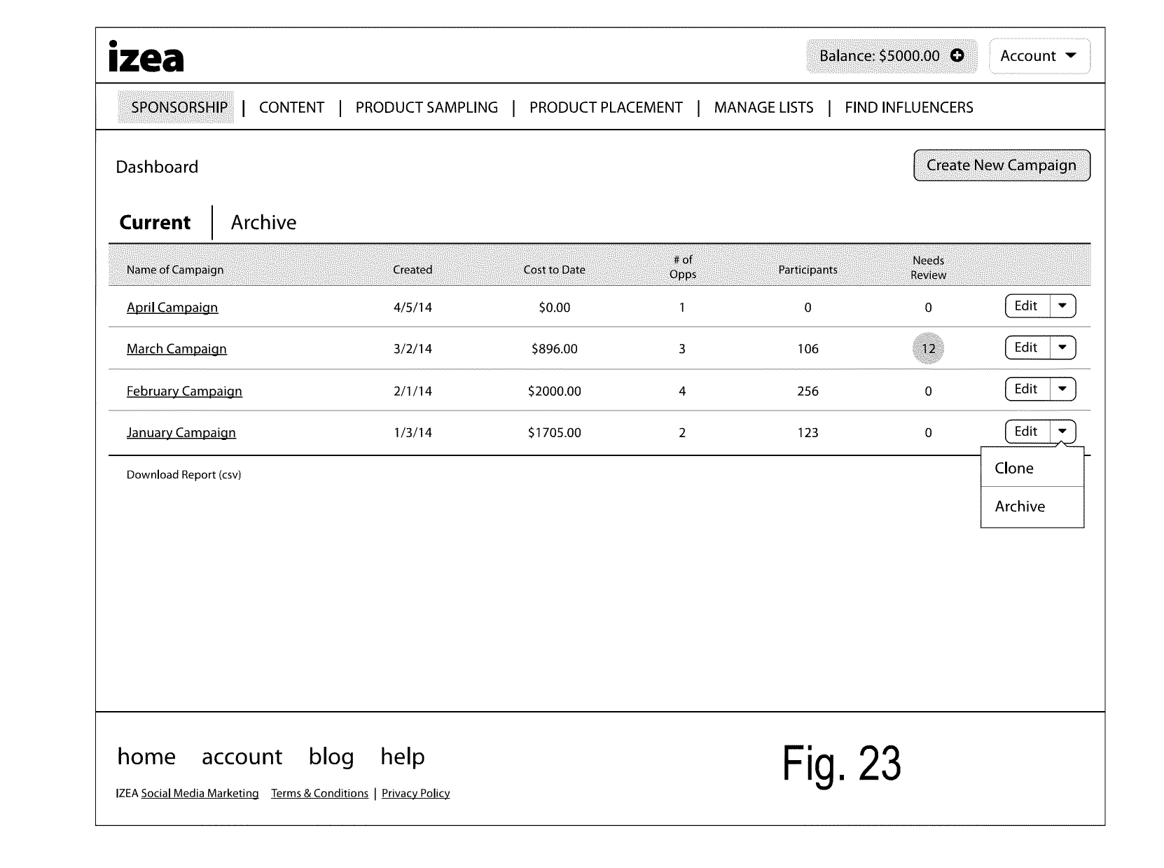

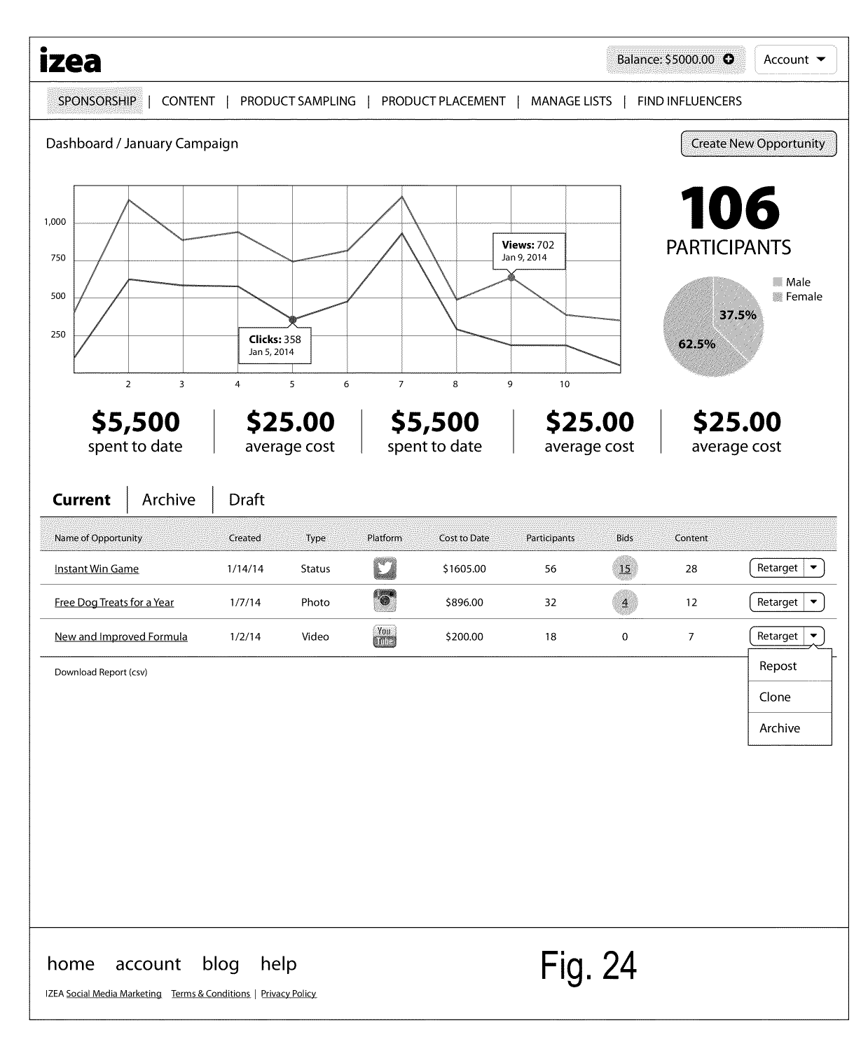

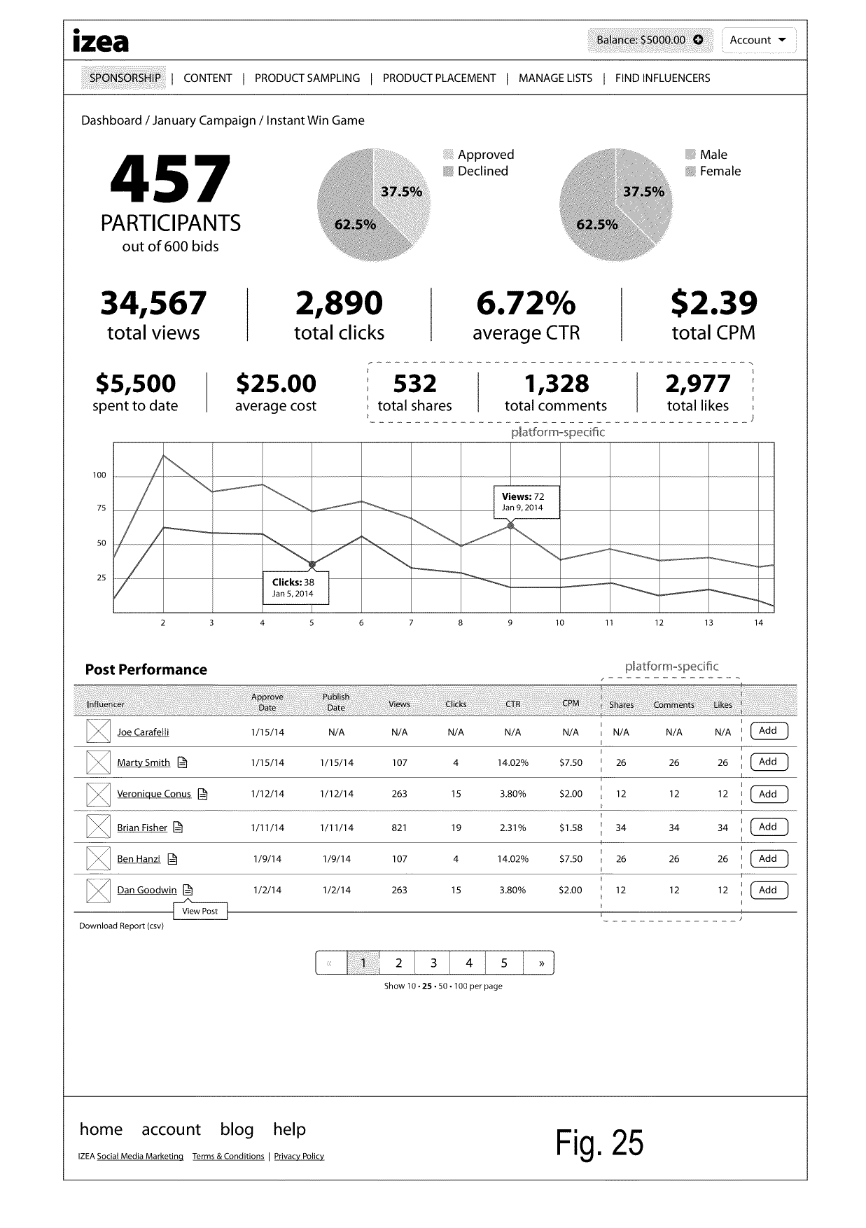

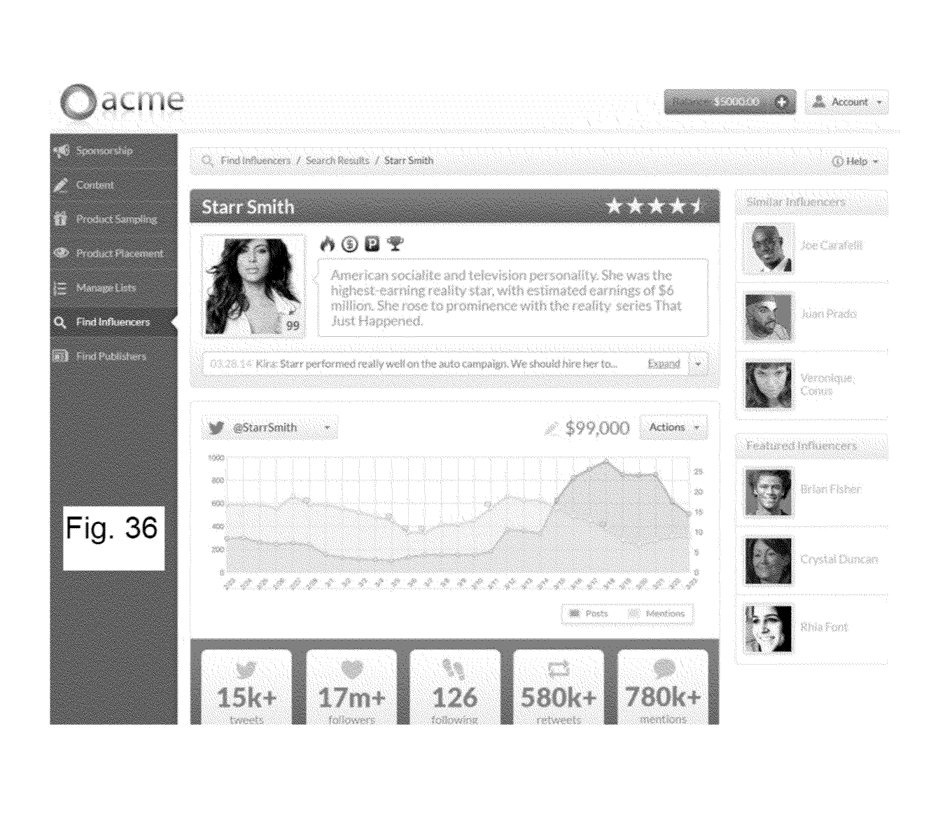

In one embodiment, once campaign has been created for an advertising opportunity, the enterprise computing entity 100 can allow various influencers/publishers (e.g., individuals, talent agencies, blog networks, crossover publishers, and/or the like) to view, accept, and/or bid on the advertising opportunity. Also, the enterprise computing entity 100 can provide an interface, for example, for the advertiser (e.g., operating an advertiser computing entity 110) to return to the campaign to review information about the influencers/publishers (e.g., individuals, talent agencies, blog networks, crossover publishers, and/or the like) who have viewed, accepted, and/or bid on the advertising opportunity. As will be recognized, a campaign may have multiple advertising opportunities (see FIGS. 23, 24, and 25). For example, an advertiser may input multiple advertising opportunities associated with a given campaign. Returning to the example with The Coca-Cola Company, one advertising opportunity may be for influencers/publishers to Tweet or write a blog about the great taste of a new Coca-Cola product. Another advertising opportunity may be for influencers/publishers to post a picture on Instagram of them drinking the new Coca-Cola product. And another advertising opportunity may be for influencers/publishers to wear Coca-Cola gear for the new product in public. Each of these advertising opportunities can be associated with a single campaign for the new product (see FIGS. 23, 24, and 25). As shown in FIGS. 23, 24, 25, and 39, an advertiser (e.g., operating an advertiser computing entity) can manage campaigns and advertising opportunities (e.g., view analysis regarding financials, views, clicks, shares, total reach, and/or the like), review performances by influencers/publishers, and/or the like. As will be recognized, a variety of techniques and approaches can be used to adapt to various needs and circumstances.

### Finding Influencers/Publishers

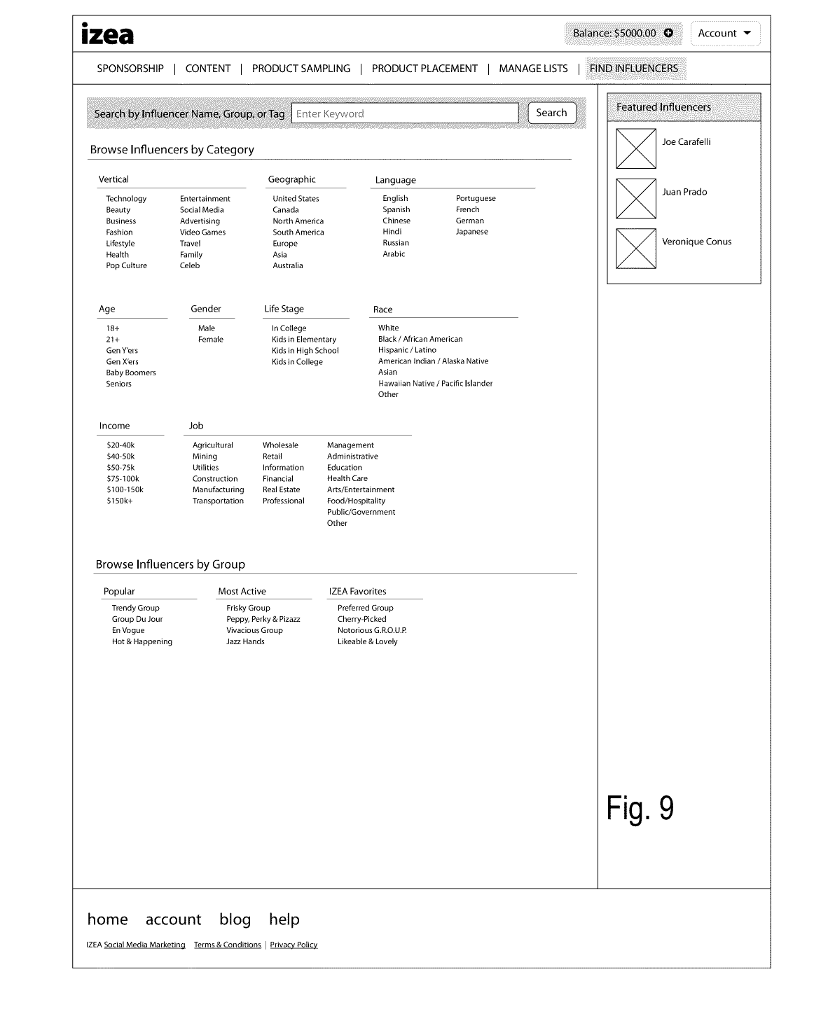

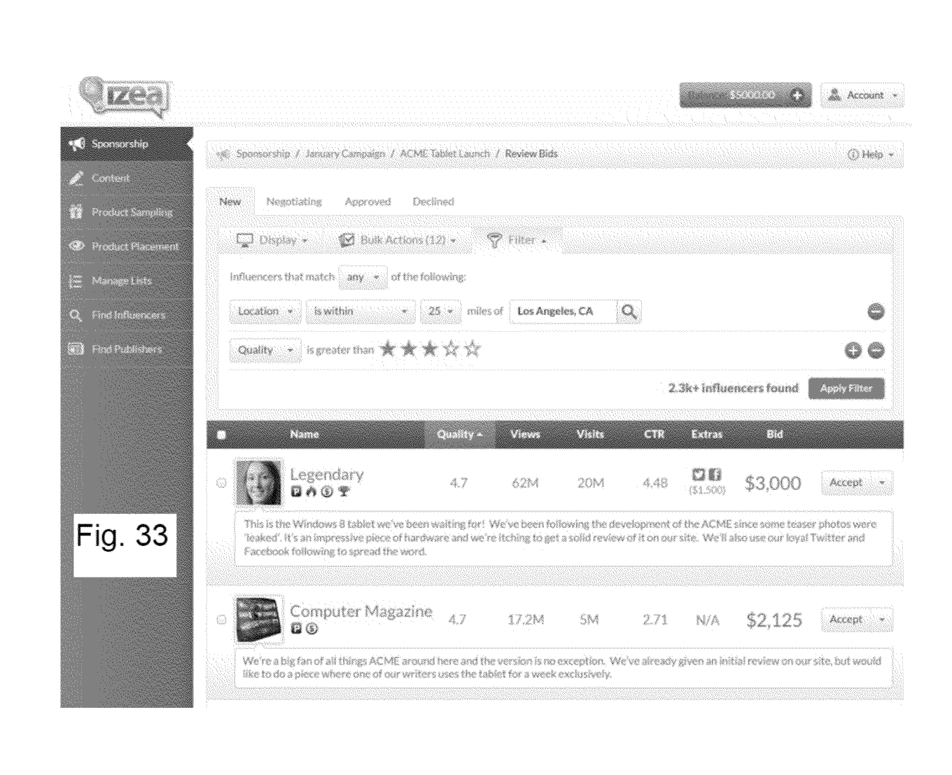

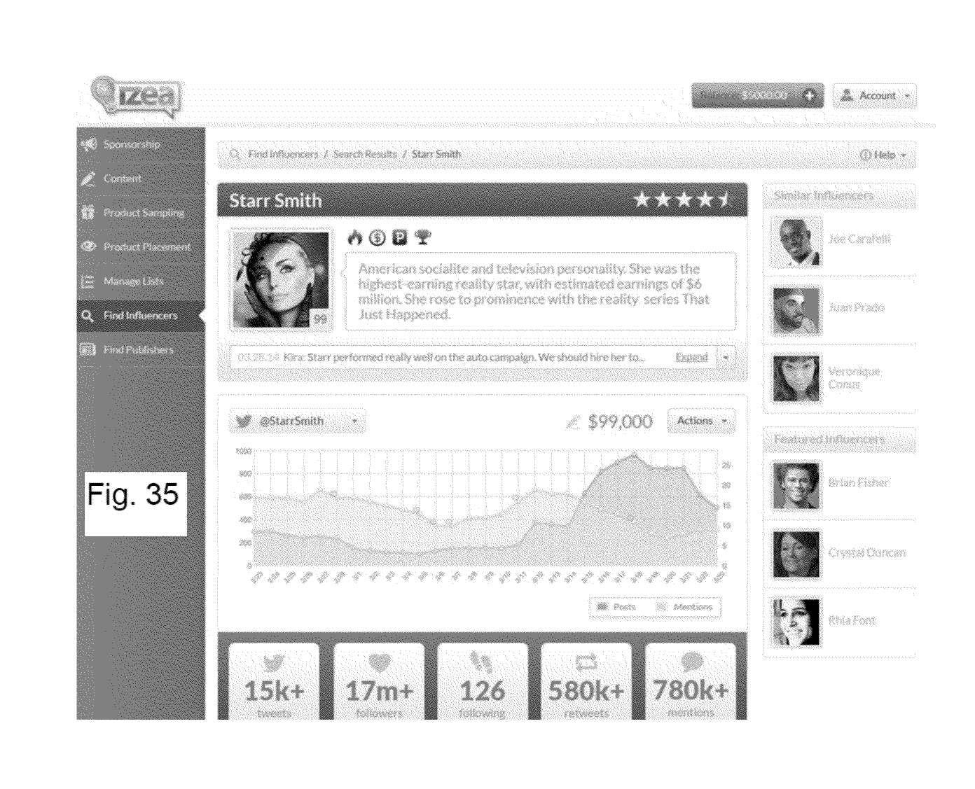

In one embodiment, the enterprise computing entity 100 can provide advertisers (e.g., individuals, advertising agencies, companies, public relations firms, and/or the like) with the ability to search for and identify influencers/publishers (e.g., individuals, talent agencies, blog networks, crossover publishers, and/or the like) who may be candidates for their advertising opportunities. For example, as shown in FIGS. 9, 34, 35, 36, and 38, an advertiser (e.g., operating an advertiser computing entity 110) may be able to search for influencers/publishers (e.g., individuals, talent agencies, blog networks, crossover publishers, and/or the like) based on information stored by the enterprise computing entity 100 as part of the influencers′/publishers' profiles. This may include searching for influencers/publishers based on areas of interest, geographic location, languages spoken, age range, gender, life stage, race, income level, profession or area of profession, popular groups, favorites, and/or the like.

In one embodiment, as an advertiser (e.g., operating an advertiser computing entity 110) searches for, filters, or sorts influencers/publishers, the enterprise computing entity 100 can provide information from the profiles of the influencers/publishers (e.g., individuals, talent agencies, blog networks, crossover publishers, and/or the like) who satisfy the search, filter, or sort for viewing by the advertiser. In one embodiment, the advertiser (e.g., operating an advertiser computing entity 110) may also have the ability to configure how information about the identified influencers/publishers is displayed.

In one embodiment, the advertiser (e.g., operating an advertiser computing entity 110) may further refine the results of the matching influencers/publishers. For instance, the advertiser (e.g., operating an advertiser computing entity 110) may further refine the results by narrowing the geographic area to a country, province, state, territory, county, city, area code, postal code, and/or the like. The advertiser (e.g., operating an advertiser computing entity 110) may further refine the results by including additional criteria, such as limiting the results to influencers/publishers who have a minimum Approval Rating, a minimum Quality Score, a minimum Influence Rank or InRank, a minimum badge level, and/or the like. The advertiser (e.g., operating an advertiser computing entity 110) may also further refine the results based on platforms, Followers, Tweets, Mentions, Retweets, Comments, Updates, Contacts, and/or the like. And the advertiser (e.g., operating an advertiser computing entity 110) may also refine the results based on the cost for the influencers/publishers (e.g., individuals, talent agencies, blog networks, crossover publishers, and/or the like) to accept the advertising opportunity, such as the “Ask Price” or “Buy Now Price.”

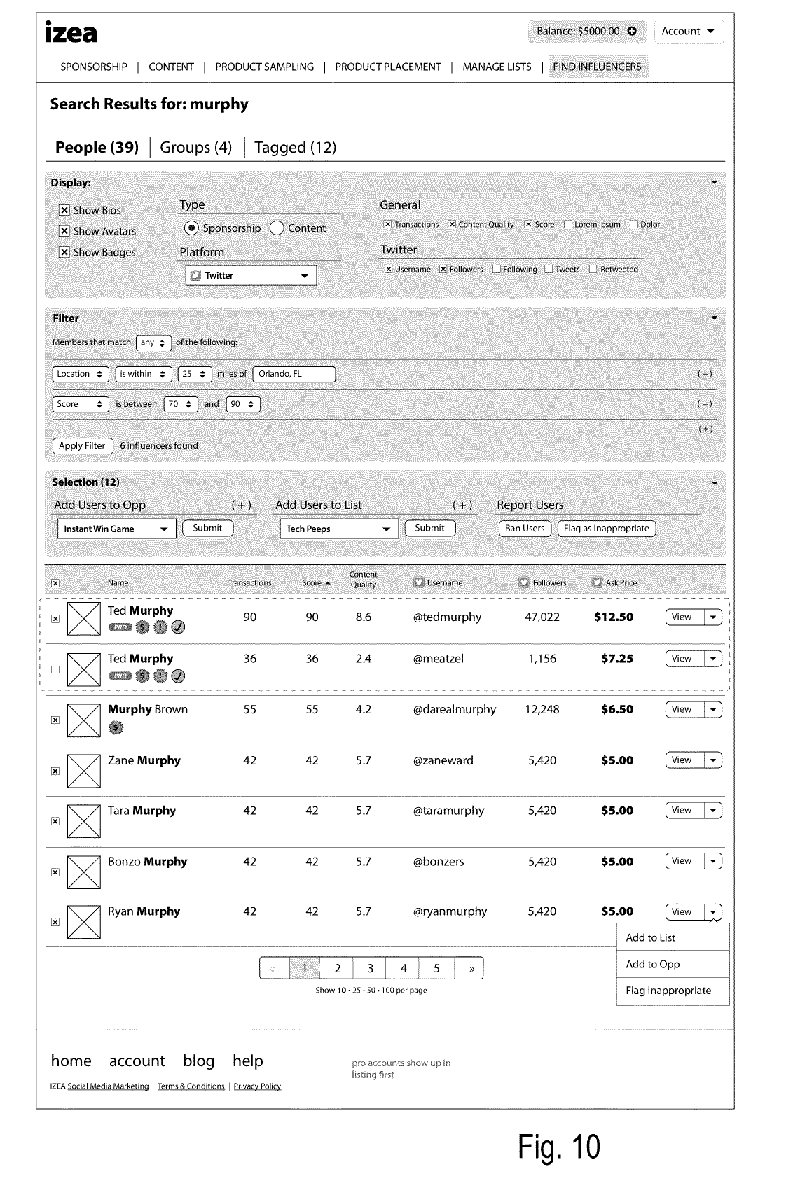

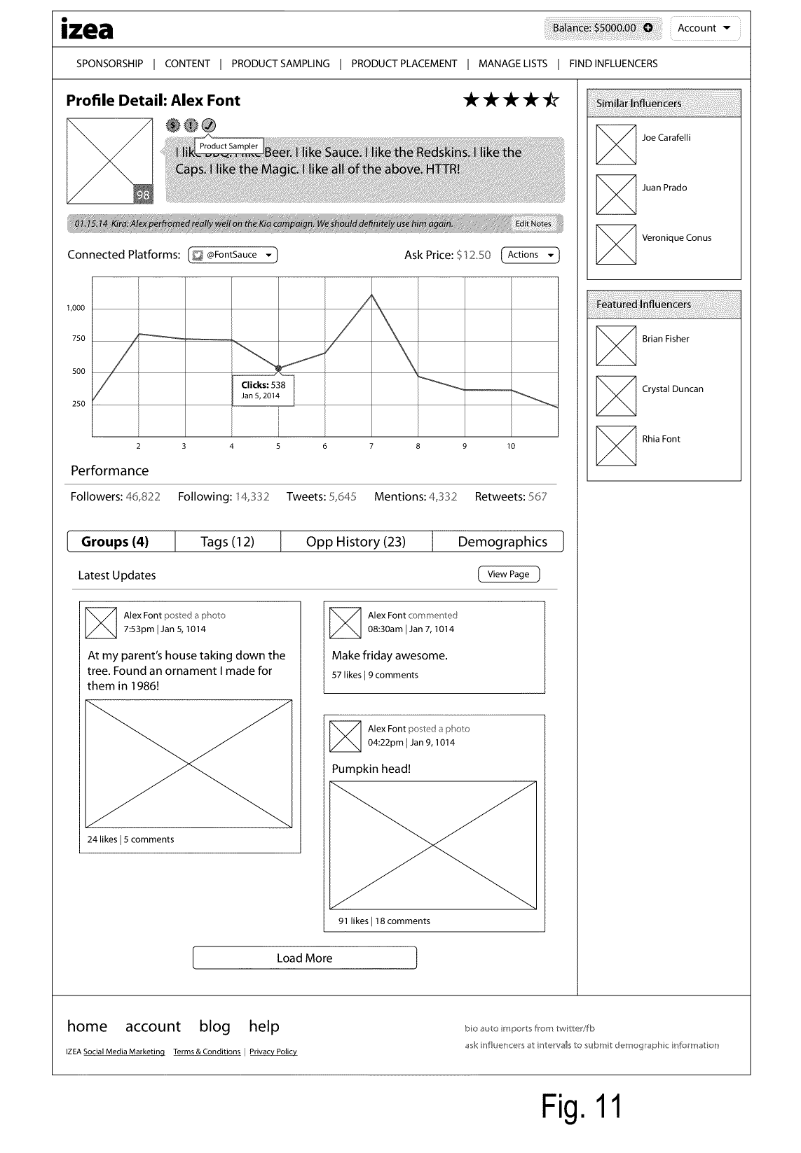

As also shown in FIGS. 10 and 11, the advertiser (e.g., operating an advertiser computing entity 110) may view and/or compare further information about each influencer's/publisher's profile by selecting the same. The advertiser (e.g., operating an advertiser computing entity 110) may also add particular influencers/publishers to a list (e.g., list of influencers/publishers of interest), campaign, or an advertising opportunity. In response to such input, the enterprise computing entity 100 can store the same in accordance with the advertiser's list, campaign, and/or advertising opportunity. For example, such lists may include influencer's/publisher's who are fans of an advertiser's Facebook page, follow the advertiser on Twitter, have successfully completed an advertising opportunity with the advertiser previously, and/or the like.

In one embodiment, the advertiser (e.g., operating an advertiser computing entity 110) can select to invite/notify one or more lists or one or more influencers/publishers to participate in a campaign or advertising opportunity. For instance, if the advertiser (e.g., operating an advertiser computing entity 110) invites/notifies a list (e.g., group of influencers/publishers) or an influencer/publisher for a given opportunity, the enterprise computing entity 100 can provide each of the influencers/publishers in the list or the directly invited/notified influencers/publishers with a message or notification of the campaign or advertising opportunity for which they have been invited/notified. In one embodiment, the invitation may indicate that the advertiser has agreed to the influencer's/publisher's “Ask Price” or “Buy Now” price if the influencer/publisher wishes to accept the advertising opportunity. In one embodiment, the advertiser (e.g., operating an advertiser computing entity 110) can view such direct invitations via the dashboard, browser, application, or user interface. The enterprise computing entity 100 may also provide a variety of other notifications, such as emails, voice messages, text messages, and/or the like. Influencers/publishers (e.g., individuals, talent agencies, blog networks, crossover publishers, and/or the like) can also “share” or “refer” these invitations with other influencers/publishers. As will be recognized, a variety of techniques and approaches can be used to adapt to various needs and circumstances.

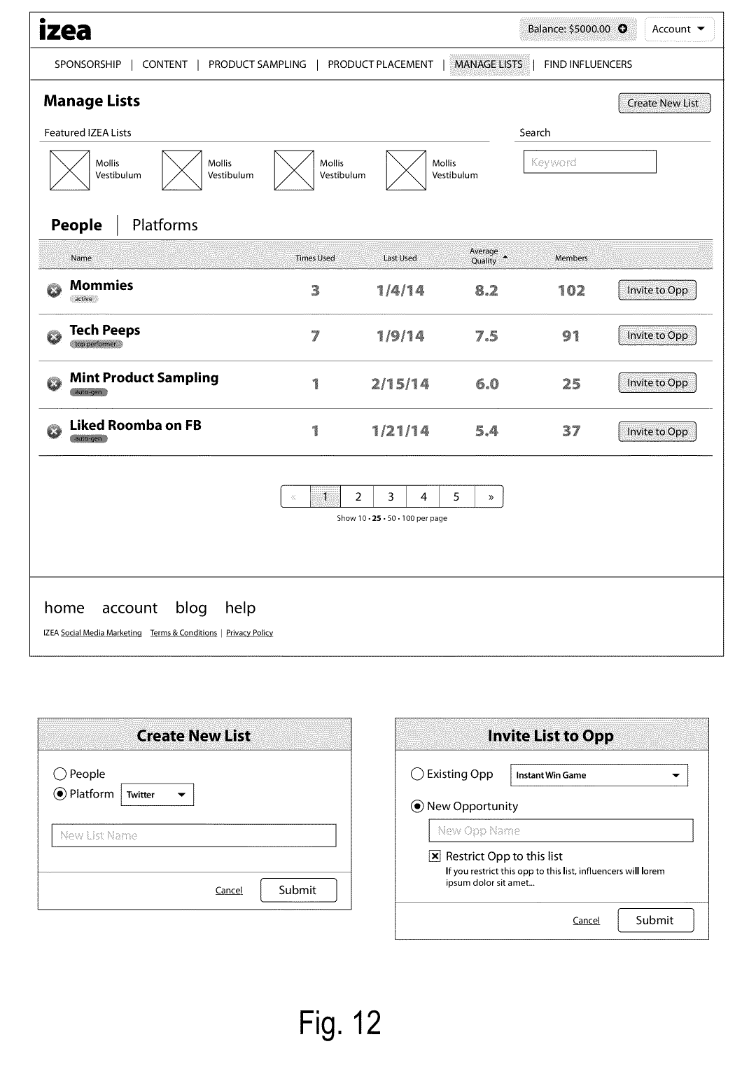

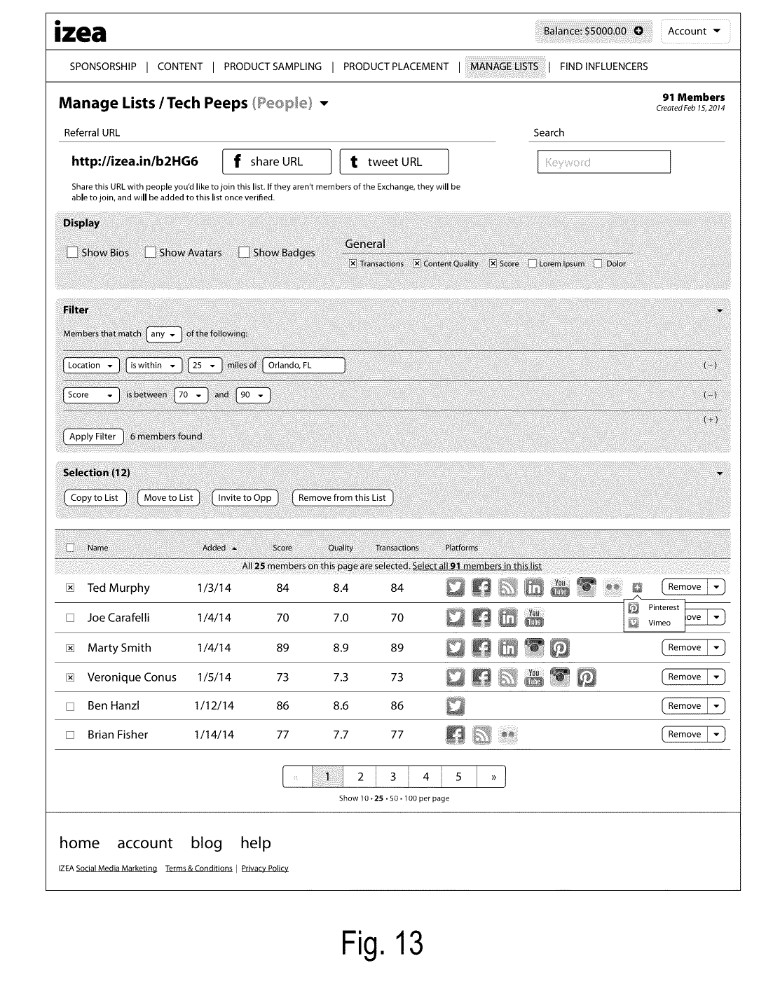

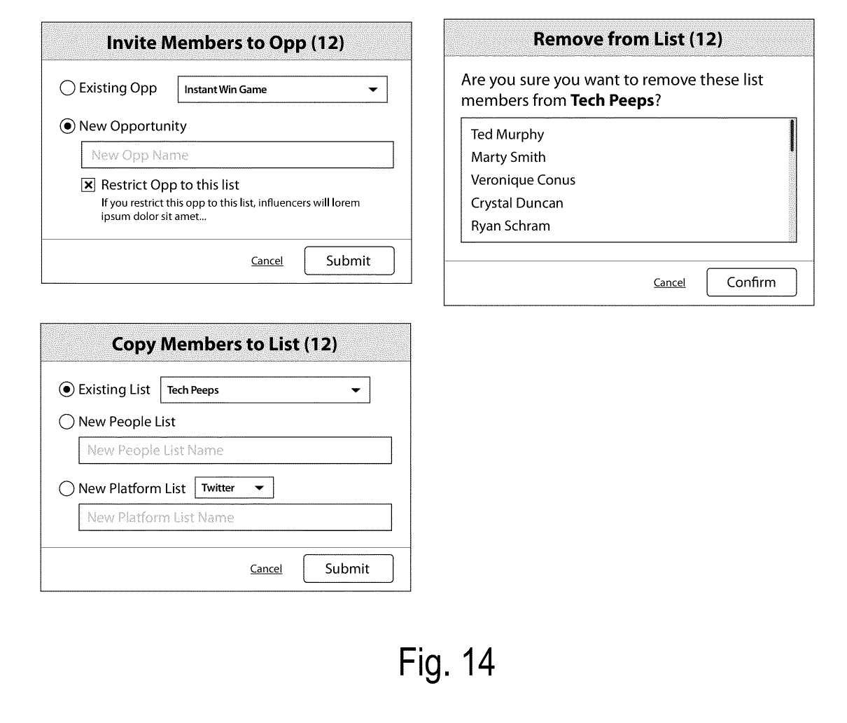

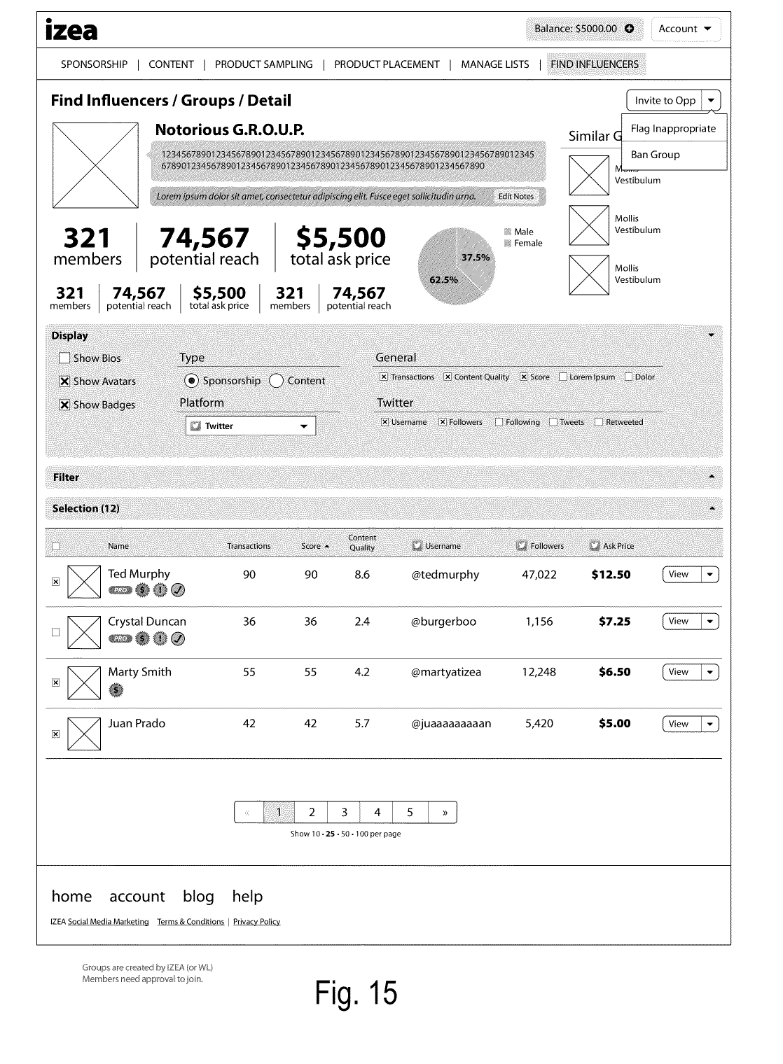

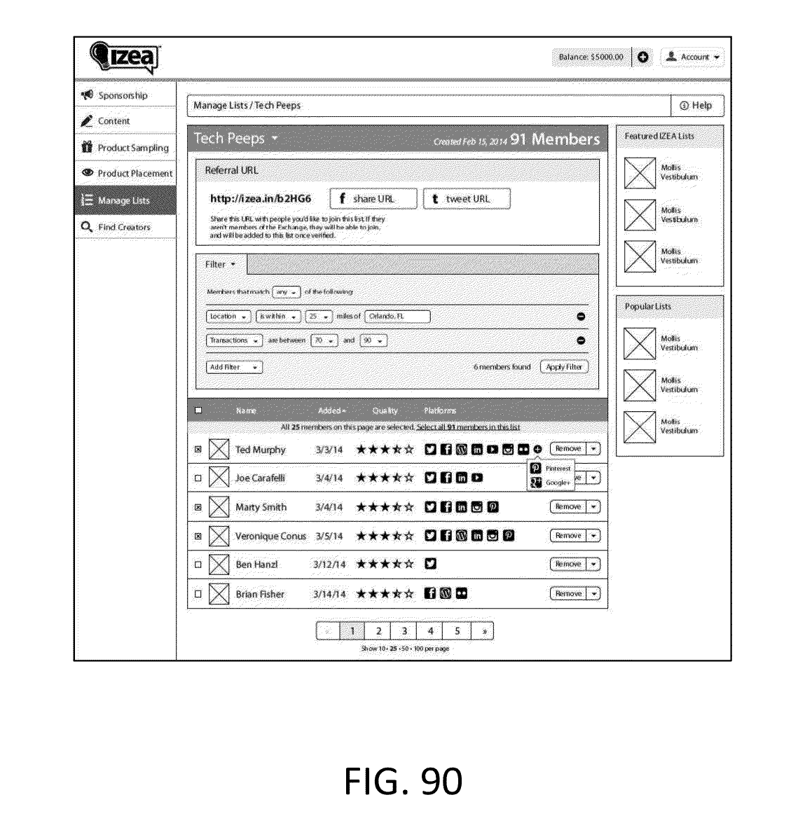

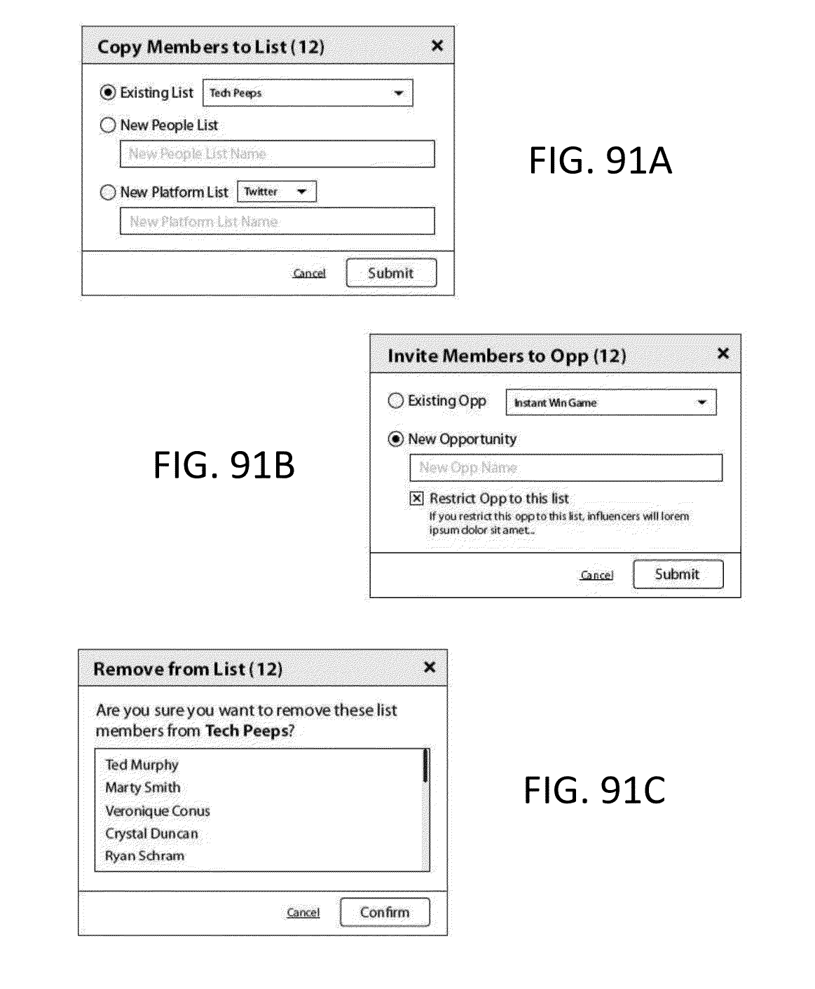

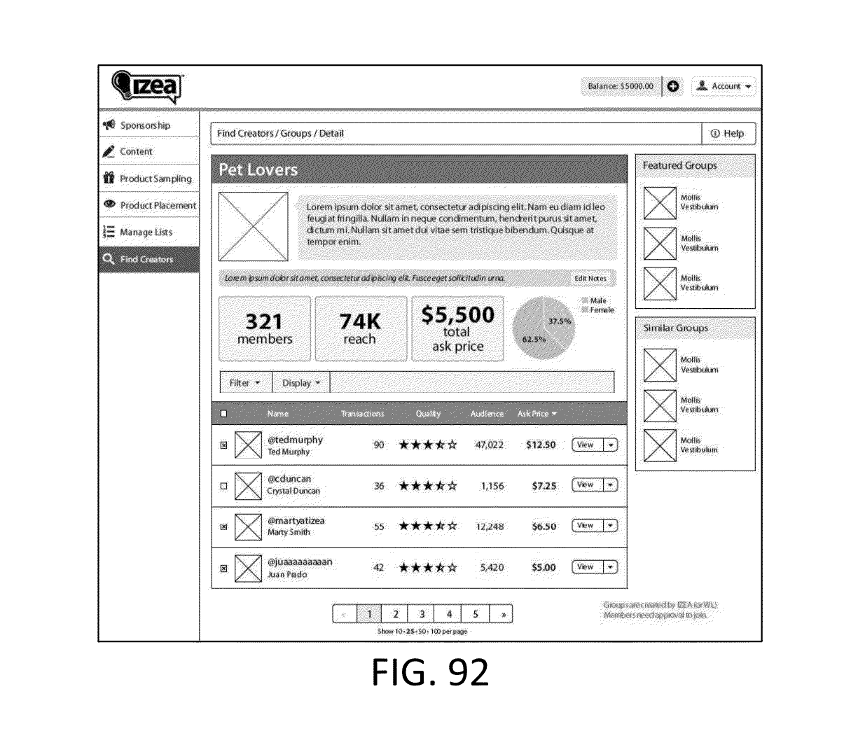

In one embodiment, as previously described, in the lists context, an advertiser (e.g., operating an advertiser computing entity 110) can view lists and information about the same via an appropriate computing entity in communication with the enterprise computing entity 100, for example. For instance, FIG. 12 includes lists (Mommies, Tech Peeps, Mint Product Sampling, Liked and Roomba on FB) that can be invited/notified for an advertising opportunity. FIGS. 13 and 15 show more-detailed views of a specific list and the influencer/publisher profiles (and corresponding profile information) for the list. An advertiser (e.g., operating an advertiser computing entity 110) may further refine influencer/publisher profiles in the list. For instance, the advertiser (e.g., operating an advertiser computing entity 110) may further refine influencer/publisher profiles in the list by narrowing the geographic area to a country, province, state, territory, county, city, area code, postal code, and/or the like. The advertiser (e.g., operating an advertiser computing entity 110) may further refine influencer/publisher profiles in the list by including additional criteria, such as limiting the results to influencers/publishers who have a minimum Approval Rating, a minimum Quality Score, a minimum Influence Rank or InRank, a minimum badge level, and/or the like. The advertiser (e.g., operating an advertiser computing entity 110) may also further refine influencer/publisher profiles in the list based on platforms, Followers, Tweets, Mentions, Retweets, Comments, Updates, Contacts, and/or the like. Additionally, an advertiser (e.g., operating an advertiser computing entity 110) may invite/notify an entire list, portions of a lists, selected influencers/publishers of a lists, and/or the like to an advertising opportunity. The advertiser (e.g., operating an advertiser computing entity 110) may also remove influencers/publishers from a list, add influencers/publishers to a list, copy influencers/publishers from a list and/or the like (see FIGS. 14, 85D-85G, and 89-92).

### Finding Advertising Opportunities

In one embodiment, the enterprise computing entity 100 can provide influencers/publishers (e.g., individuals, talent agencies, blog networks, crossover publishers, and/or the like) with the ability to search for and identify advertising opportunities. For example, in one embodiment, the enterprise computing entity 100 may provide influencers/publishers (e.g., operating influencer/publisher computing entities 105) with the ability to identify advertising opportunities in a similar manner as advertisers finding influencers/publishers. For example, an influencer/publisher (e.g., operating an influencer/publisher computing entity 105) may be able to search for advertising opportunities based on information submitted to the enterprise computing entity 100 when advertisers (e.g., operating advertiser computing entities 110) submitted the advertising opportunities. This may include searching for advertising opportunities based on areas of interest, geographic location, languages spoken, age range, gender, life stage, race, income level, profession or area of profession, popular groups, favorites, and/or the like.

In one embodiment, when an advertiser (e.g., operating an advertiser computing entity 110) creates an “open” advertising opportunity, only influencers/publishers (e.g., based on their corresponding profiles) who satisfy the description (e.g., parameters) of the advertising opportunity can view the advertising opportunity. Such an implementation may limit influencers/publishers (e.g., individuals, talent agencies, blog networks, crossover publishers, and/or the like) from viewing advertising opportunities when they do not match the defined criteria. In one embodiment, as an influencer/publisher (e.g., operating an influencer/publisher computing entity 105) searches for, filters, or sorts advertising opportunities, the enterprise computing entity 100 can provide information from the advertising opportunities that satisfy the search, filter, or sort for viewing by the influencer/publisher.

In one embodiment, similar to an advertiser, an influencer/publisher (e.g., operating an influencer/publisher computing entity 105) may further refine the results of the matching advertising opportunities. For instance, the influencer/publisher (e.g., operating an influencer/publisher computing entity 105) may further refine the results by narrowing the geographic area to a country, province, state, territory, county, city, area code, postal code, and/or the like. The influencer/publisher (e.g., operating an influencer/publisher computing entity 105) may further refine the results by platform (e.g., Twitter, Facebook, Instragram, etc. In one embodiment, an influencer/publisher (e.g., operating an influencer/publisher computing entity 105) may view advertising opportunities as a result of direct invitations from advertisers (e.g., individuals, advertising agencies, companies, public relations firms, and/or the like) or “shares” or “referrals” from other influencers/publishers (e.g., individuals, talent agencies, blog networks, crossover publishers, and/or the like).

As also noted, in one embodiment, influencers/publishers (e.g., operating influencer/publisher computing entities 105) may be accessing advertising opportunities offered by an individual advertiser, such as Digitas, by accessing a unique domain for the advertiser (e.g., opportunities.digitas.com). Thus, this approach can allow advertisers (e.g., individuals, advertising agencies, companies, public relations firms, and/or the like) to present the advertising opportunities through the enterprise computing entity 100 in a manner transparent to influencers/publishers (e.g., individuals, talent agencies, blog networks, crossover publishers, and/or the like). As will be recognized, a variety of techniques and approaches can be used to adapt to various needs and circumstances.

In one embodiment, influencers/publishers (e.g., operating influencer/publisher computing entities 105) can view, accept, and/or bid on the advertising opportunities and interact with advertisers (e.g., individuals, advertising agencies, companies, public relations firms, and/or the like) regarding the same.

### Approval/Acceptance and Bidding Process

In one embodiment, an influencer/publisher (e.g., operating an influencer/publisher computing entity 105) can review, accept, approve, negotiate, or decline direct invitations, shares, or referrals for advertising opportunities. To do so, an influencer/publisher (e.g., operating an influencer/publisher computing entity 105) can access the appropriate application, browser, dashboard, user interface, and/or the like to view and review direct invitations and/or shares to accept the same. In one embodiment, if such an invitation is accepted, the terms for the advertising opportunity are as provided in the invitation. Further, if an influencer/publisher accepts an invitation or share, for instance, the influencer/publisher may perform or carry out a content review and approval/acceptance process as described in greater detail below. In other embodiments, the influencer/publisher may simply carry out the advertising opportunity as described, which can be tracked/determined and monitored by the enterprise computing entity 100.

In one embodiment, influencers/publishers (e.g., operating influencer/publisher computing entities 105) can also bid on (e.g., offer to perform or carry out) advertising opportunities of interest (see FIGS. 16-22) based on searches, filters, sorts, shares, and/or the like. For example, an influencer/publisher (e.g., operating an influencer/publisher computing entity 105) may view, bid on, negotiate about, and/or the like such opportunities via the appropriate application, browser, dashboard, user interface, and/or the like, as indicated by block 1704 of FIG. 17, block 1804 by FIG. 18, and block 2104 by FIG. 21. That is, the enterprise computing entity 100 may provide the influencer/publisher (e.g., operating an influencer/publisher computing entity 105) with ability to perform or carry out such actions via the appropriate application, browser, dashboard, user interface, and/or the like.

In one embodiment, to bid on an advertising opportunity, an influencer/publisher (e.g., operating an influencer/publisher computing entity 105) may simply select “bid” for the corresponding advertising opportunity. In one embodiment, the bid may include the influencer's/publisher's bid price (e.g., the amount or incentive for which the influencer/publisher is willing to perform or carry out the advertising opportunity). The bid price may be entered manually by the influencer/publisher (e.g., operating an influencer/publisher computing entity 105) or automatically based on the influencer's/publisher's “Ask Price” or a “Buy Now Price.” In another embodiment, the bid may include the influencer's/publisher's bid price (e.g., the amount or incentive for which the influencer/publisher is willing to perform or carry out the advertising opportunity) and/or the proposed content (e.g., blog, tweet, photograph, comment, and/or the like) as described by the advertising opportunity.

In one embodiment, as previously discussed, such bids may be entered by multiple parties and/or require a multi-step approval/acceptance process depending on the party submitting or entering the bid, as shown by blocks 1706-1714 of FIG. 17, blocks 1806-1814 of FIG. 18, and blocks 2106-2114 of FIG. 21. For instance, bids may by entered by an owner (e.g., Kim Kardashian), a bidder or bidwriter (e.g., Kim Kardiashian's agents or managers), a copywriter (e.g., Kim Kardashian's talent agency), and/or the like. In one embodiment, if a person other than the owner enters the bid, the owner may be notified of the bid via the dashboard, user interface, and/or the like of the bid, which may require the owner's approval/acceptance to proceed. For instance, the owner/actual influencer/publisher operating an influencer/publisher computing entity 105 may be required to approve/accept all bids. Continuing with the above example, Kim Kardashian (e.g., owner) may view the advertising opportunity offered by The Coca-Cola Company to write a blog about a new product and enter/submit a bid (e.g., by operating the appropriate computing entity). In another example, Kim Kardashian's manager (e.g., bidwriter) may view the advertising opportunity offered by The Coca-Cola Company to write a blog about a new product and enter a bid on Kim's behalf. In yet another example, a representative at Kim Kardashian's talent agency (e.g., copywriter) may view the advertising opportunity offered by The Coca-Cola Company to write a blog about a new product and enter a bid with a draft of a blog on Kim's behalf. In the latter two examples, Kim can receive a notification via the dashboard, user interface, and/or the like that the bidwriter or copywriter submitted a bid on behalf of Kim. In response to (e.g., after) receiving the notification and/or reviewing the bid, Kim (e.g., owner) may be required to approve/accept the bid before it is actually provided to the corresponding advertiser. In other embodiments, the enterprise computing entity 100 may require approval/acceptance by multiple parties before a bid is actually submitted to the corresponding advertiser. As will be recognized, a variety of techniques and approaches can be used for submitting and approving bids to adapt to various needs and circumstances.

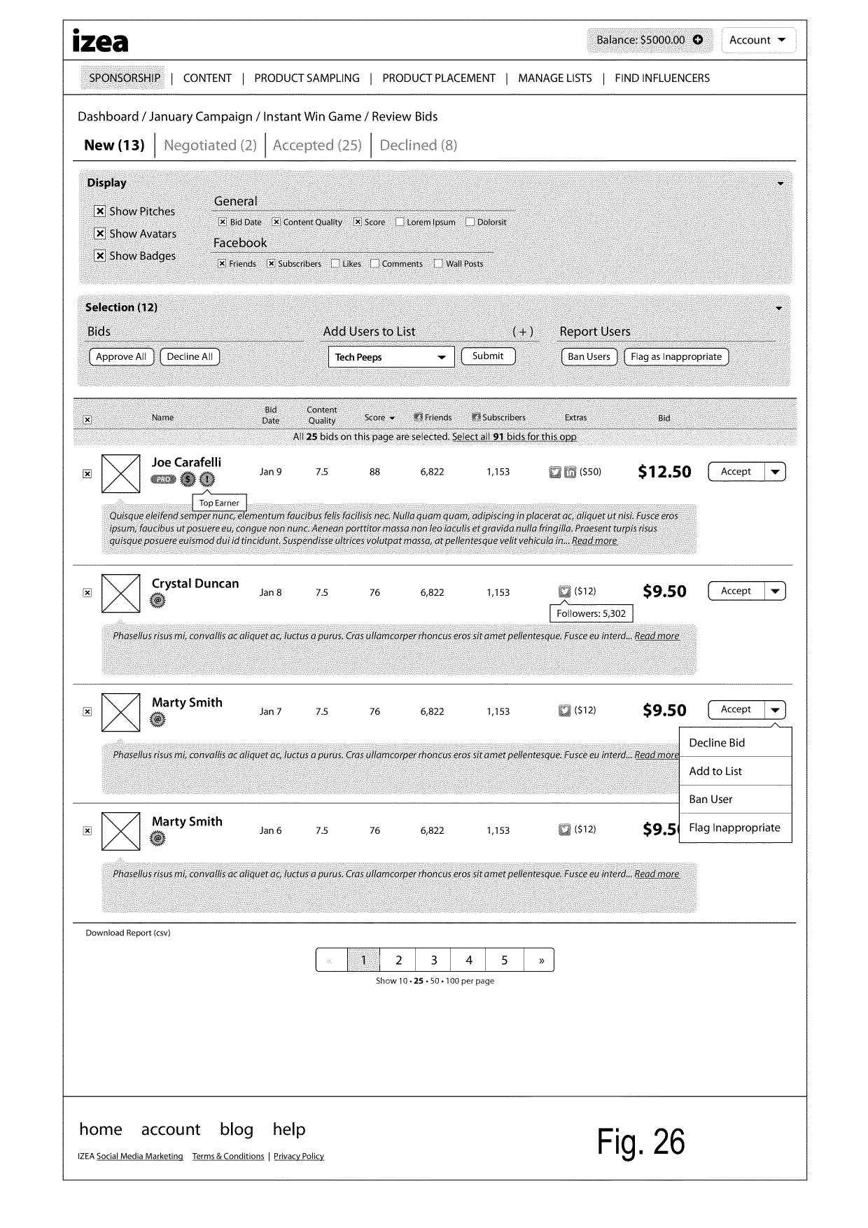

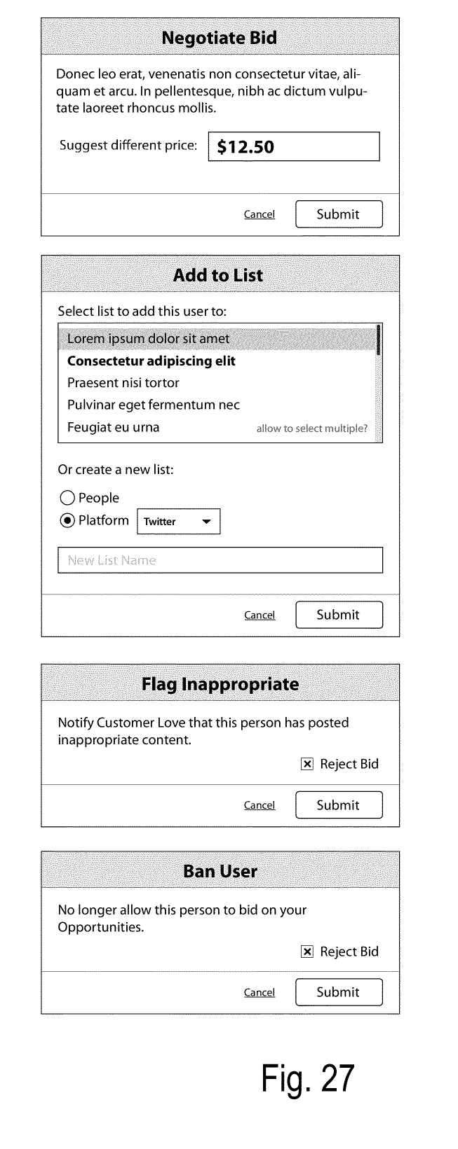

In one embodiment, after a bid has been appropriately submitted and/or approved/accepted, the enterprise computing entity 100 can provide a message or notification (e.g., via the appropriate interface) to the advertiser regarding the bid (see FIGS. 26 & 27 and blocks 1716 of FIG. 17, 1816 of FIGS. 18, and 2116 of FIG. 21). Then, via the dashboard, browser, application, or user interface (see FIGS. 26, 27, and 33), the advertiser (e.g., operating an advertiser computing entity 110) can accept the bid, decline the bid, ban the influencer/publisher from bidding on the advertiser's advertising opportunities, flag the bid as inappropriate, add the bid to a list or campaign, negotiate the bid, and/or the like, as indicated by blocks 1718-1734 of FIG. 17, blocks 1818-1834 of FIG. 18, and blocks 2118-2134 of FIG. 21.

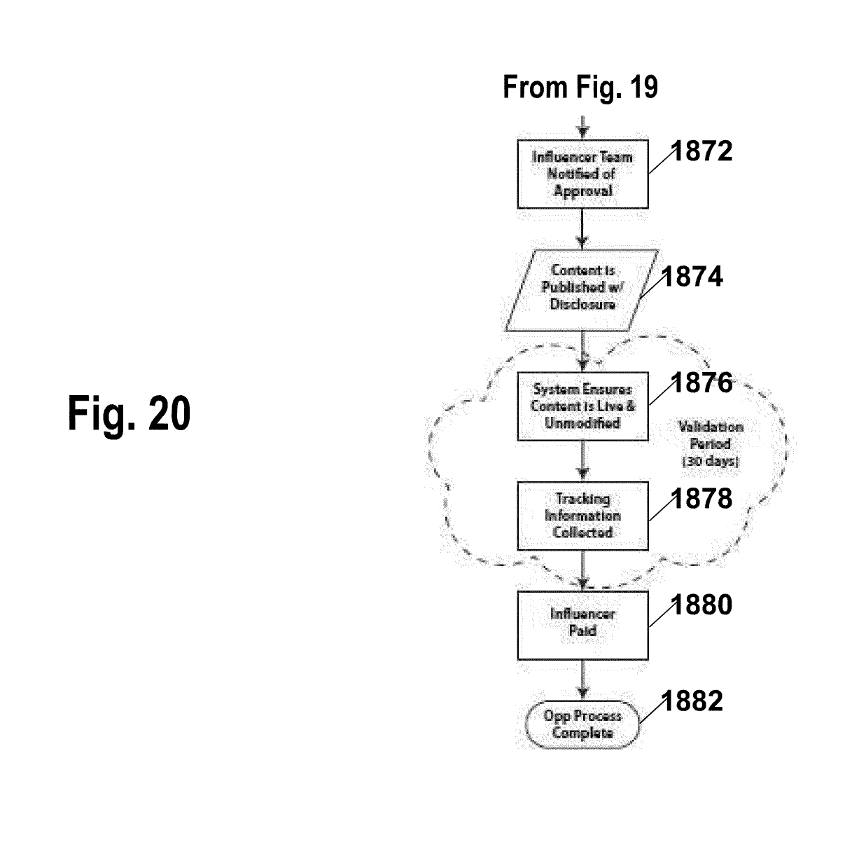

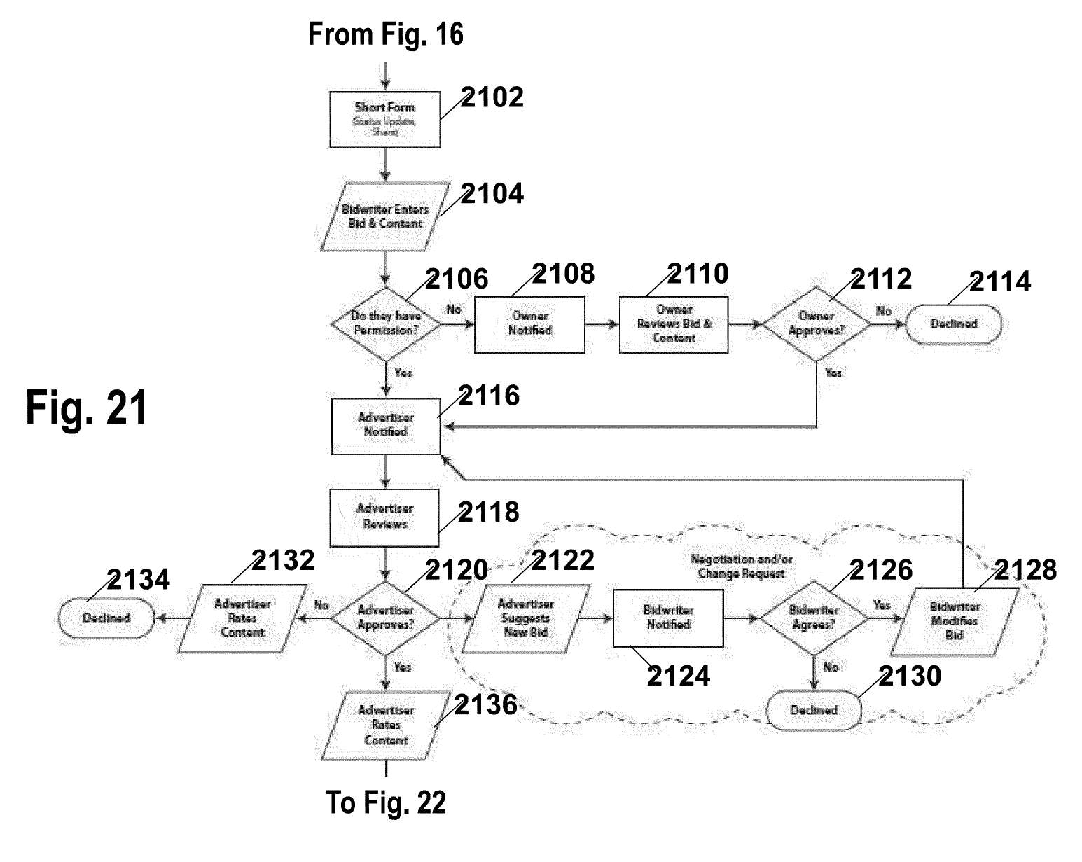

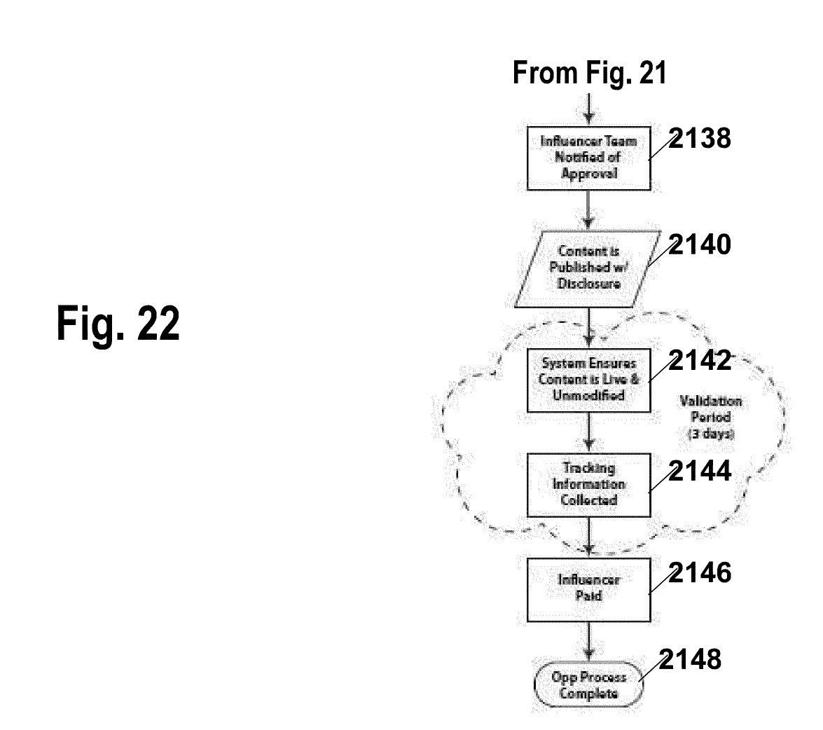

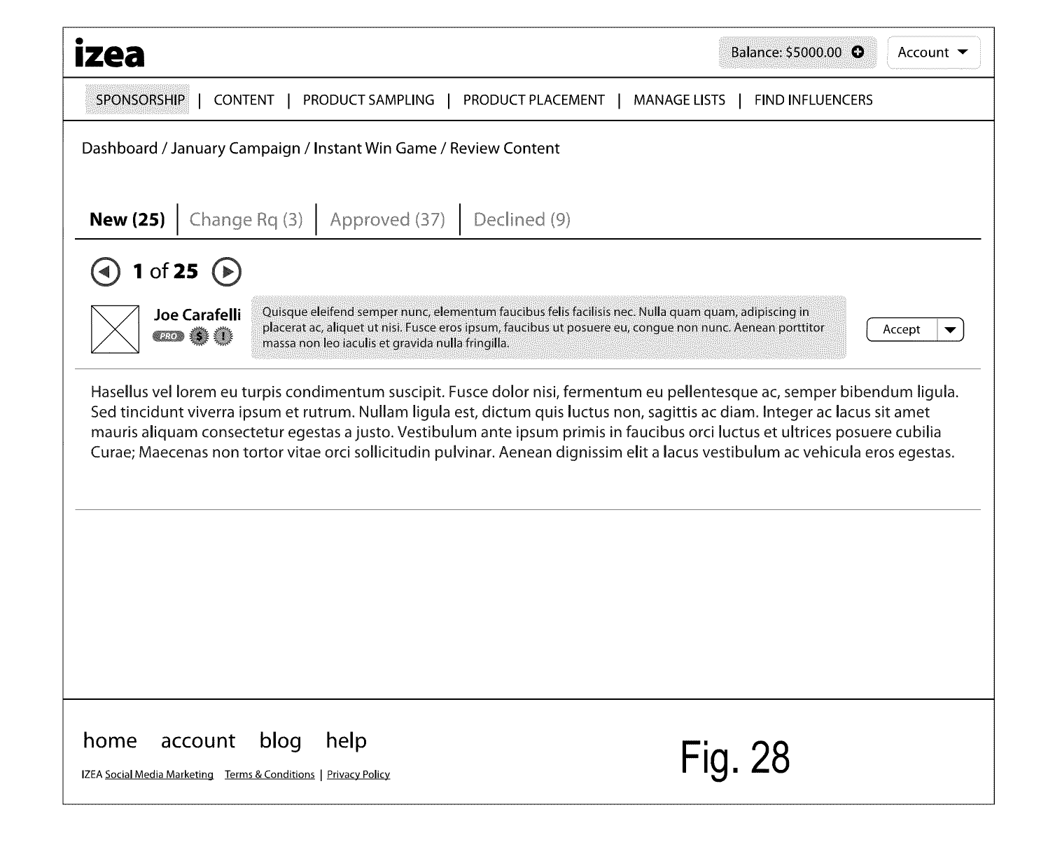

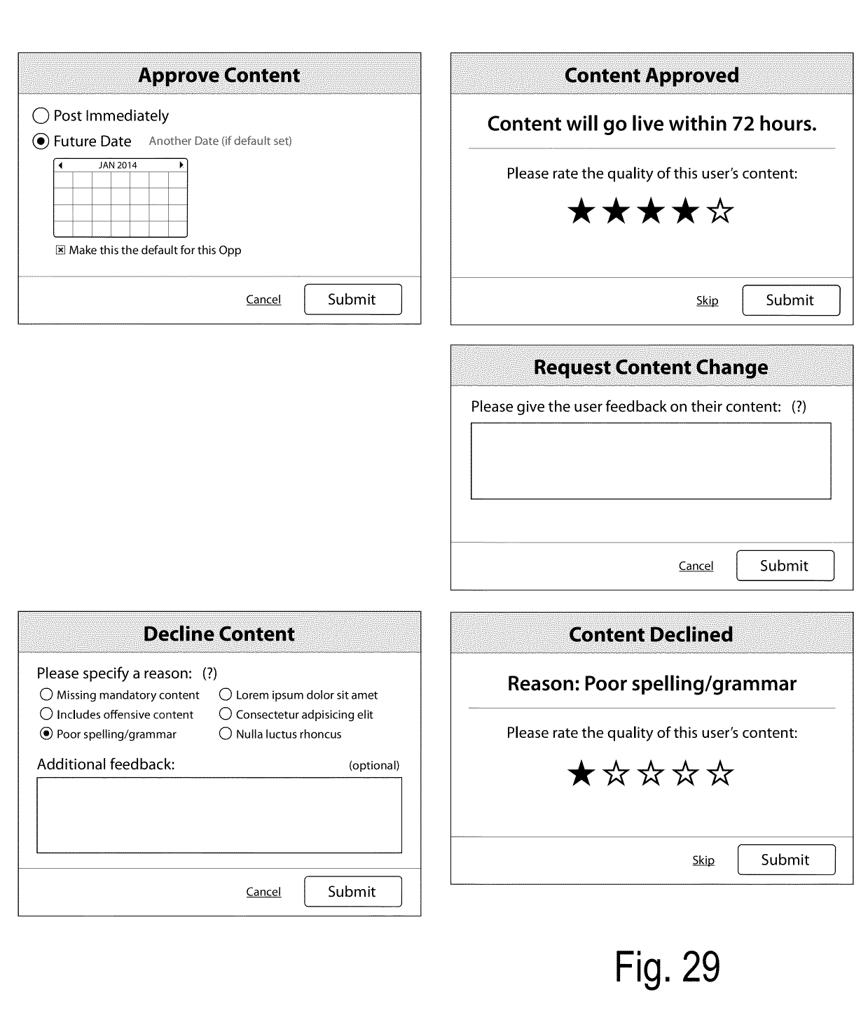

In one embodiment, after a bid, direct invitation, or share has been accepted by an advertiser or influencer/publisher, the influencer/publisher (e.g., operating an influencer/publisher computing entity 105) and advertiser (e.g., operating an advertiser computing entity 110) may go through a content approval/acceptance process (shown in FIGS. 16-22) until both parties either withdraw from the process or the content is approved/accepted as being in compliance/accordance with the description of the advertising opportunity. This may include the advertiser (e.g., operating an advertiser computing entity 110) reviewing a draft of the submitted content (e.g., Kim Kardashian's draft blog). The draft of the submitted content may be the content (both in substance and form) in which the influencer/publisher proposes to use to fulfill or carry out the advertising opportunity (see FIGS. 28-29). In one embodiment, one or more parties on behalf of the influencer/publisher (e.g., owner, bidwriter, copywriter, and/or the like) may be required to approve/accept the content being submitted to the advertiser (as described with regard to the multi-step bid approval). Similarly, the advertiser can suggest changes or edits to the content or accept the content before allowing it to “go live,” e.g., to be posted, printed, worn, said, tweeted, shared, commented on, published, and/or the like (see FIGS. 28-29). In certain embodiments, both parties can receive notifications for each step described shown in FIGS. 16-22; the process may be iterative as well. Continuing with the above example, once the appropriate parties associated with the influencer/publisher (e.g., Kim Kardashian's team) approve/accept and submit the content and the advertiser approves the content (e.g., The Coca-Cola Company or Digitas on behalf of The Coca-Cola Company), the influencer/publisher can complete or carry out the advertising opportunity by taking the content “live”—posting, tweeting, sharing, saying/speaking, wearing, commenting on, publishing, and/or the like the content (see blocks 1836-1870 of FIGS. 19 and 20 and blocks 2136-2140 of FIGS. 21 and 22).

Once the content “goes live,” the enterprise computing entity 100 can indicate the advertising opportunity as “complete” or “closed” (unless multiple advertising opportunities can be accepted for the same) and provide the payment or other incentive to the appropriate parties.

Payments may be in a variety of forms, such as via debit cards, credit cards, direct credits, direct debits, cash, check, money order, Internet banking, e-commerce payment networks/systems (e.g., PayPal™, Google Wallet, Amazon Payments), virtual currencies (e.g., Bitcoins), award or reward points, and/or the like. Such payments may be made using a variety of techniques and approaches, including through NFC technologies such as PayPass, Android Beam, BlueTooth low energy (BLE), and various other contactless payment systems. Further, such payment technologies may include PayPal Beacon, Booker, Erply, Leaf, Leapset, Micros, PayPal Here, Revel, ShopKeep, TouchBistro, Vend, and/or the like (see blocks 1876-1882 of FIG. 20 and blocks 2142-2148 of FIG. 22).

As will be recognized, a variety of payment scenarios may occur. In the context of a white label marketplace, not only can influencers/publishers receive payment or another incentive for carrying out the advertising opportunity, but the appropriate talent agencies, advertising agencies, public relations firms, and/or the like may also receive payment or other appropriate incentives—as well as the entity operating the enterprise computing entity 100. As will be recognized, a variety of other approaches and techniques can be used to adapt to various needs and circumstances, such as provide payment of incentives for shares, referrals, and/or the like.

The enterprise computing entity 100 can also track/determine various statistics associated with the advertising opportunity. For instance, as shown in FIGS. 23, 24, 25, and 39, the enterprise computing entity 100 can provide statistics and analysis regarding the financials associated with the advertising opportunity or campaign and/or statistics and analysis regarding the views, clicks, shares, total reach, and/or the like regarding the same. The enterprise computing entity 100 can also provide the advertiser (e.g., operating an advertiser computing entity 110) with ability to review the influencers/publishers performance and update the corresponding Approval Rating, Quality Score, Influence Rank or InRank, badges, and/or the like as a result of the reviews. As will be recognized, a variety of other approaches and techniques can be used to adapt to various needs and circumstances.

### Advertising/Sponsorship Campaigns/Opportunities

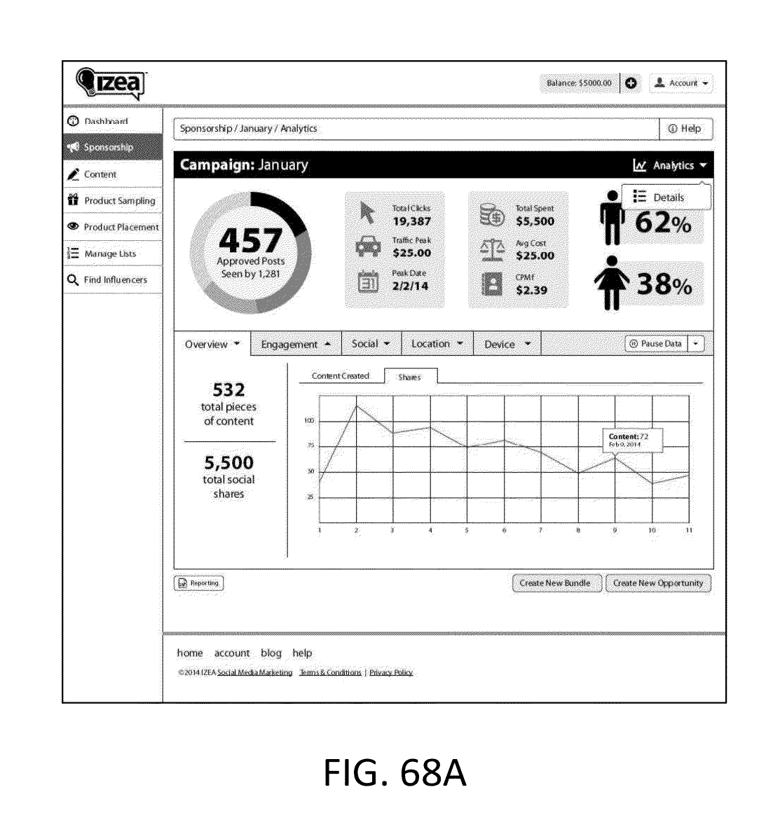

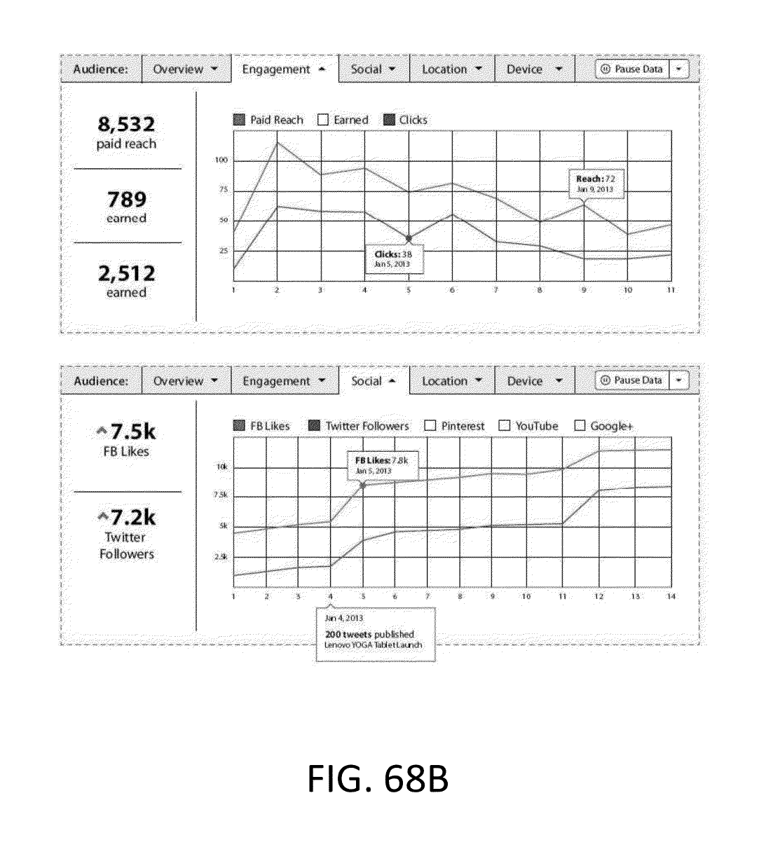

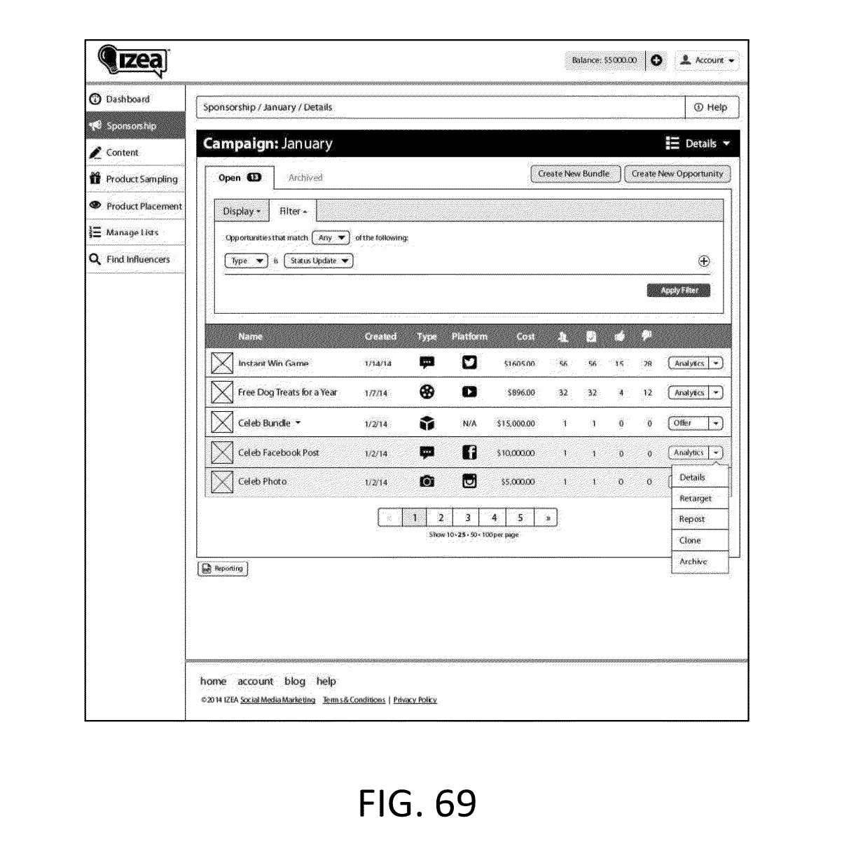

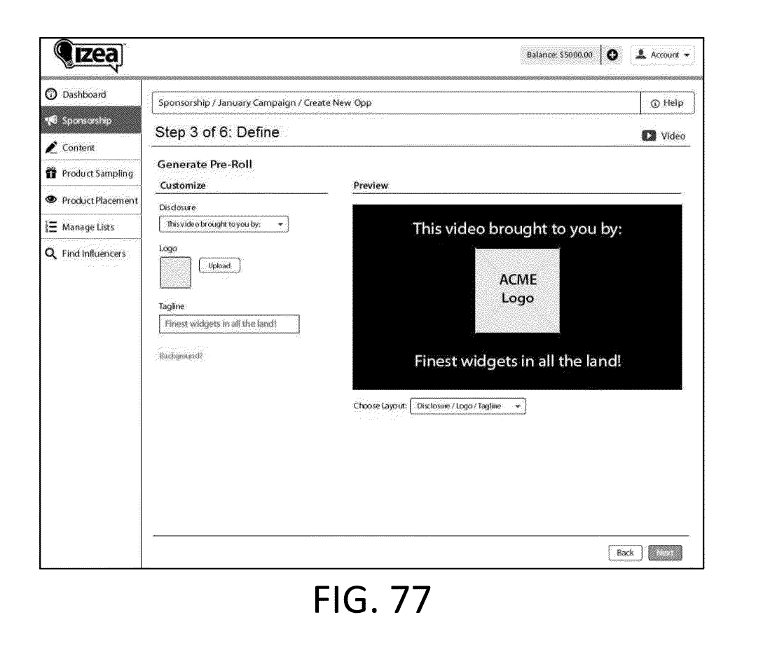

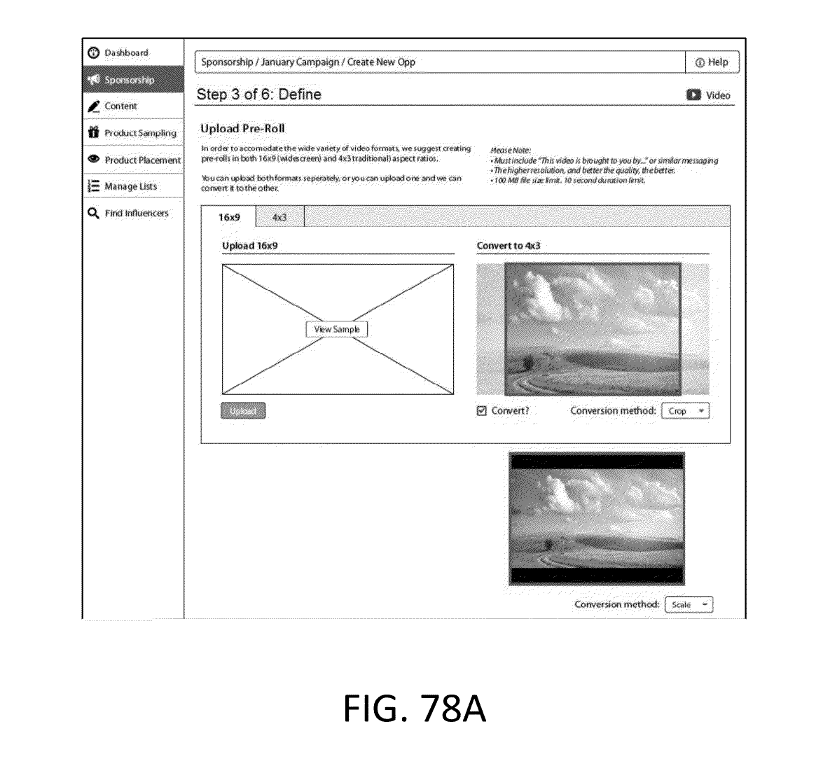

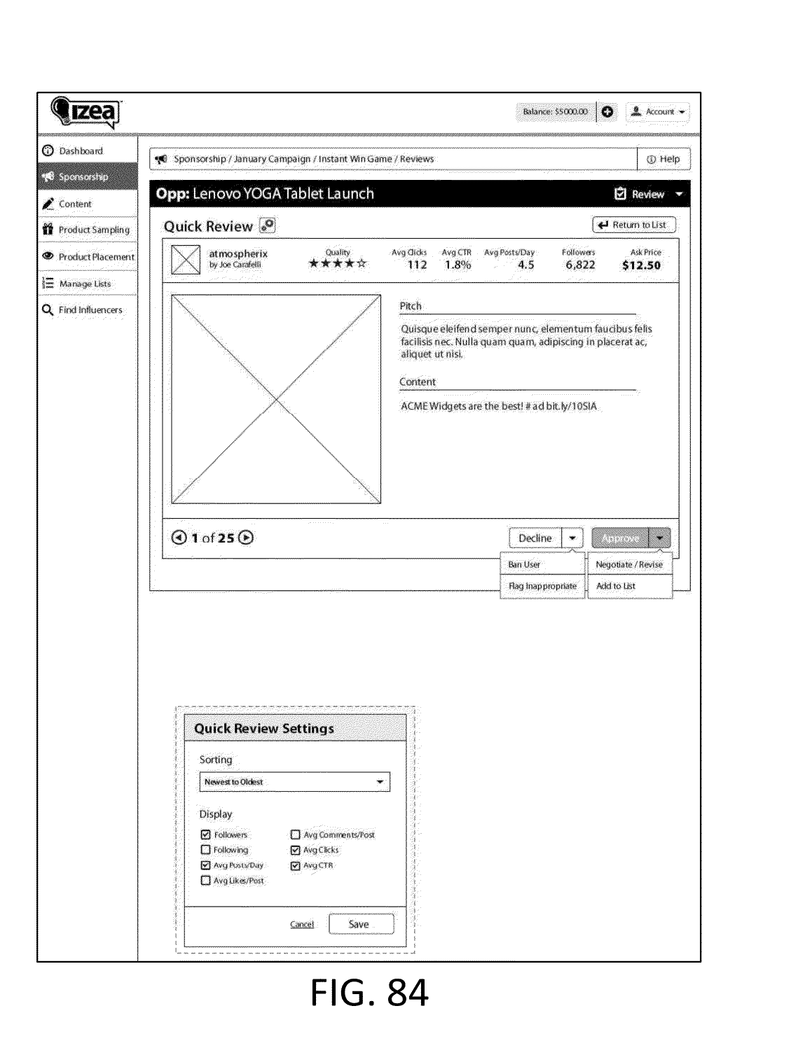

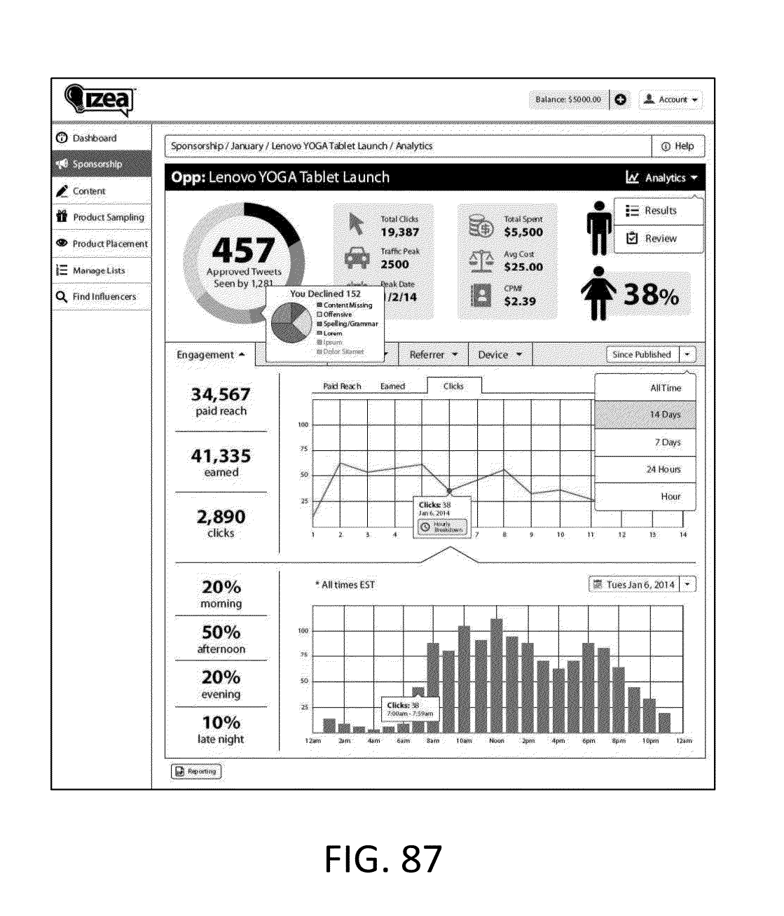

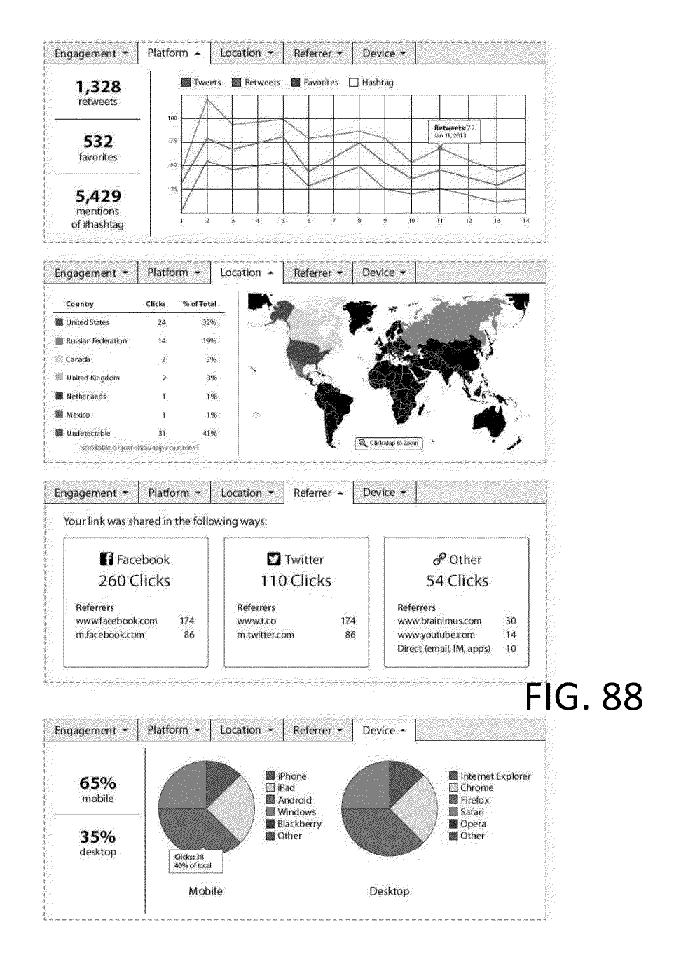

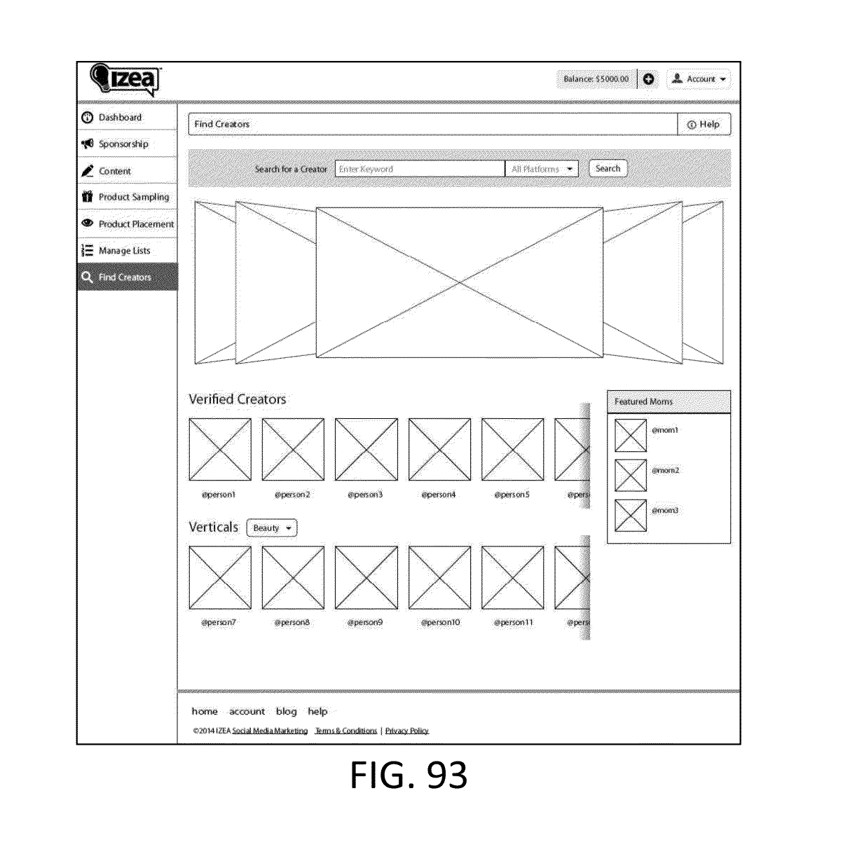

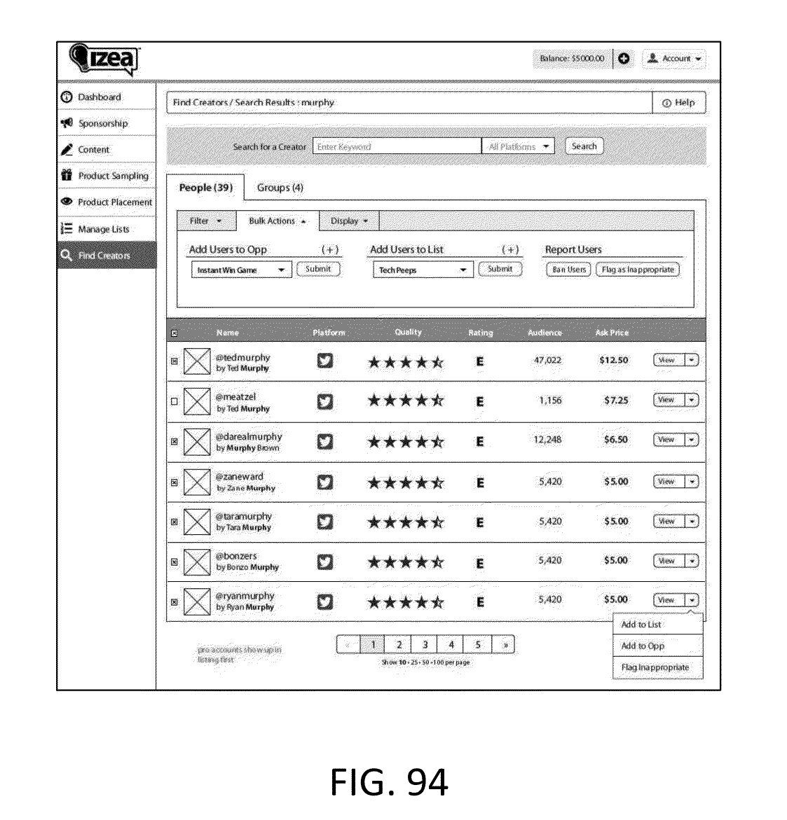

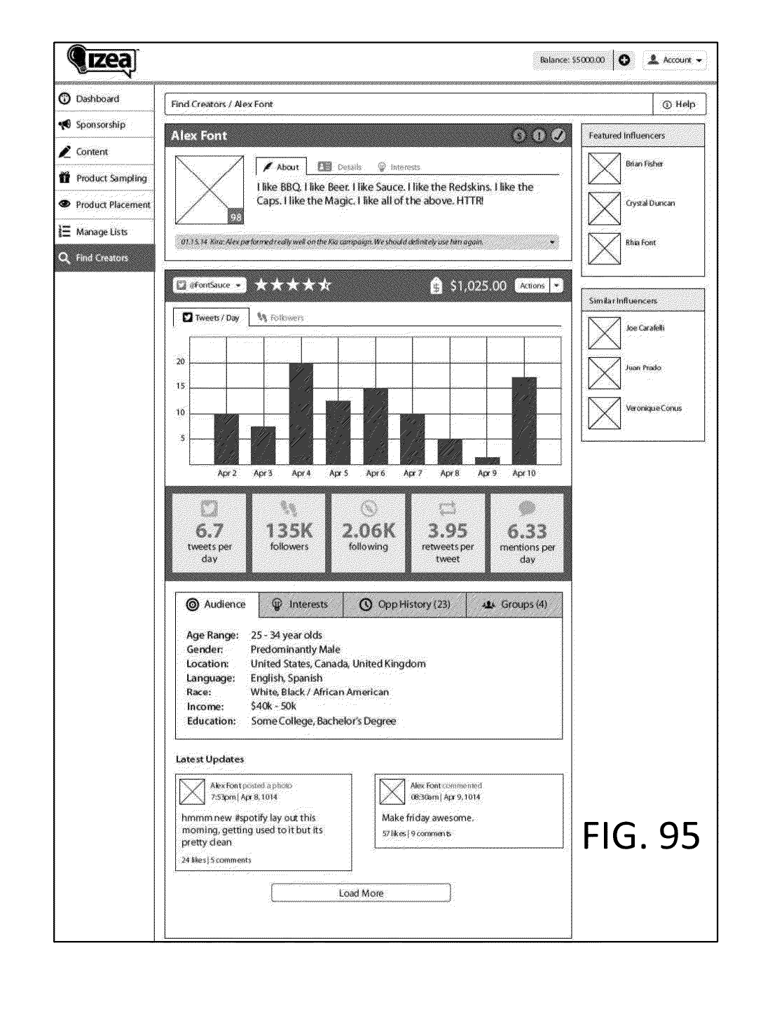

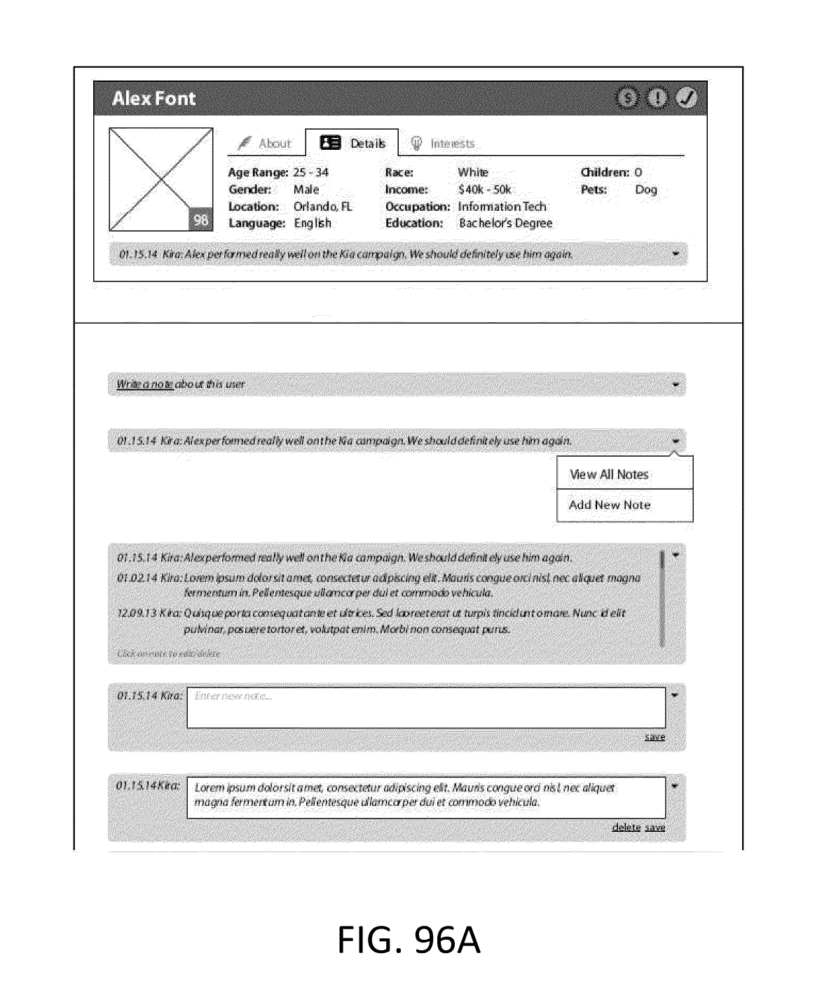

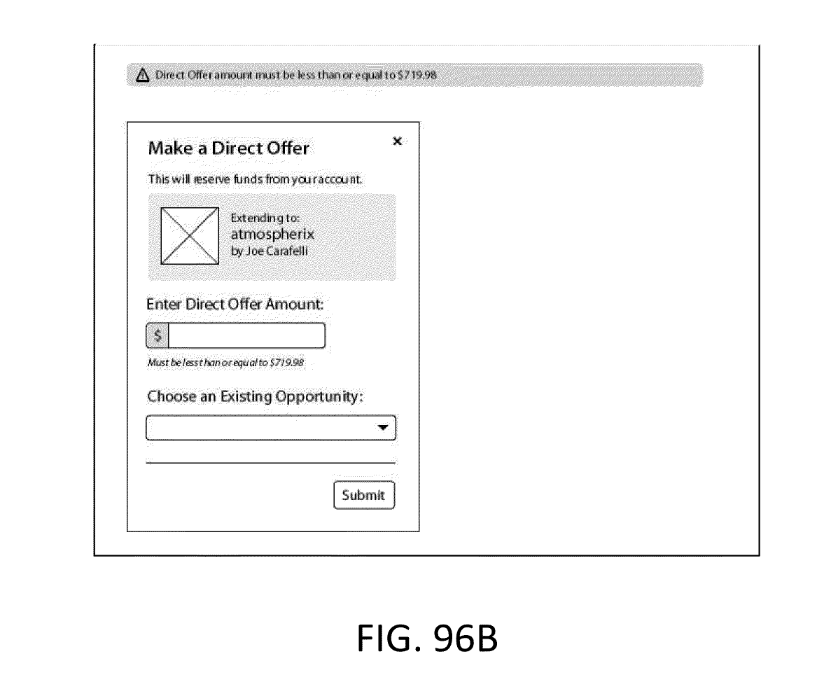

FIGS. 68A-96B illustrate various views of the creation and management of a sponsorship campaign by an advertiser. For example, FIGS. 68A and 68B illustrate some example statistics related to an advertising opportunity (e.g., a sponsorship campaign) that the enterprise computing entity 100 may track/determine and provide to (e.g., cause display of for) the advertiser (e.g., operating an advertiser computing entity 110). FIG. 69 illustrates an example view provided by the enterprise computing entity 100 (e.g., via the advertiser computing entity 110) to provide tools for an advertiser to manage one or more advertising opportunities.

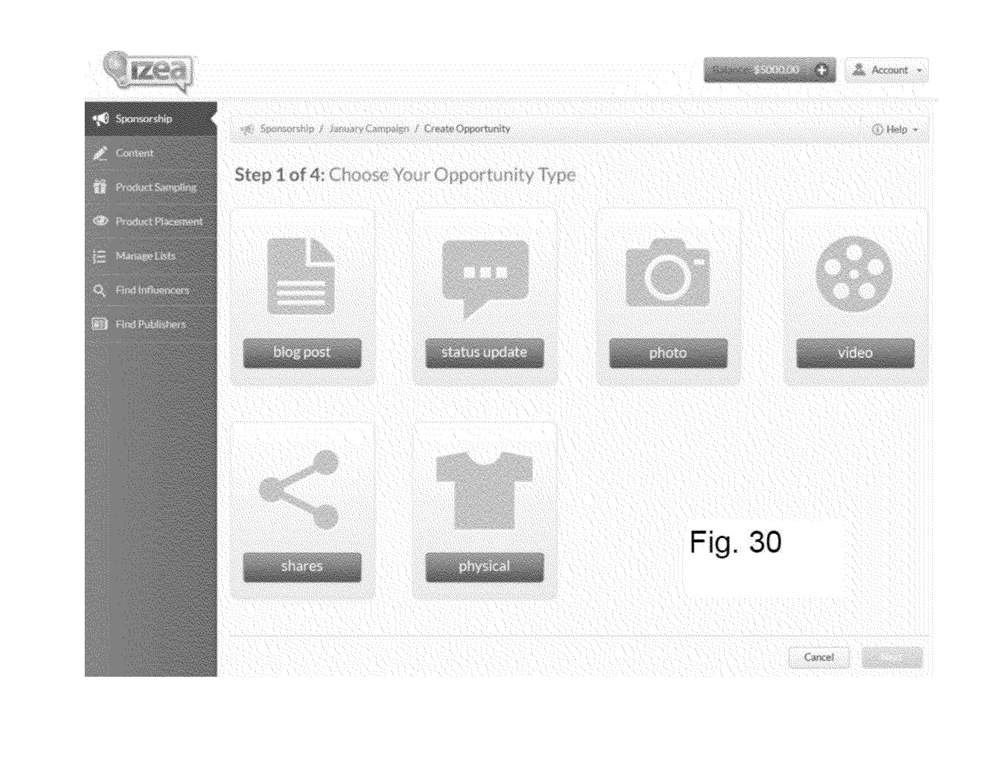

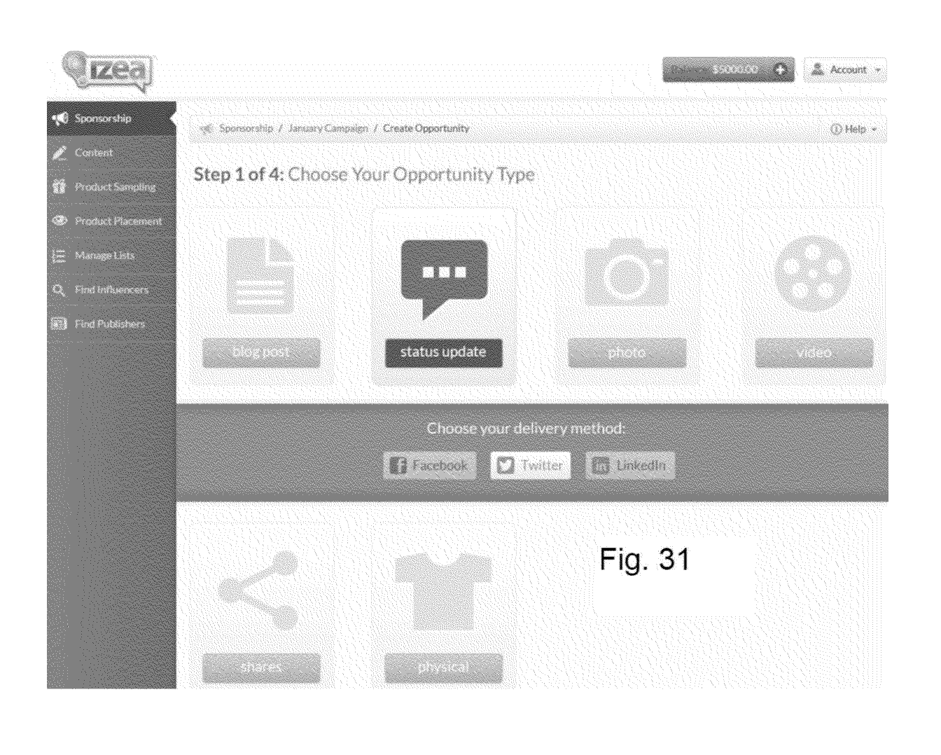

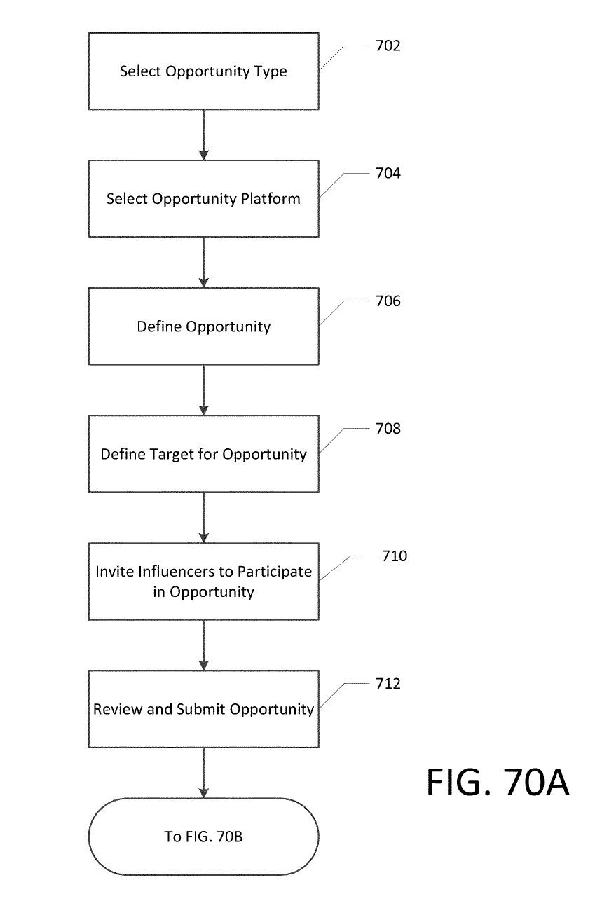

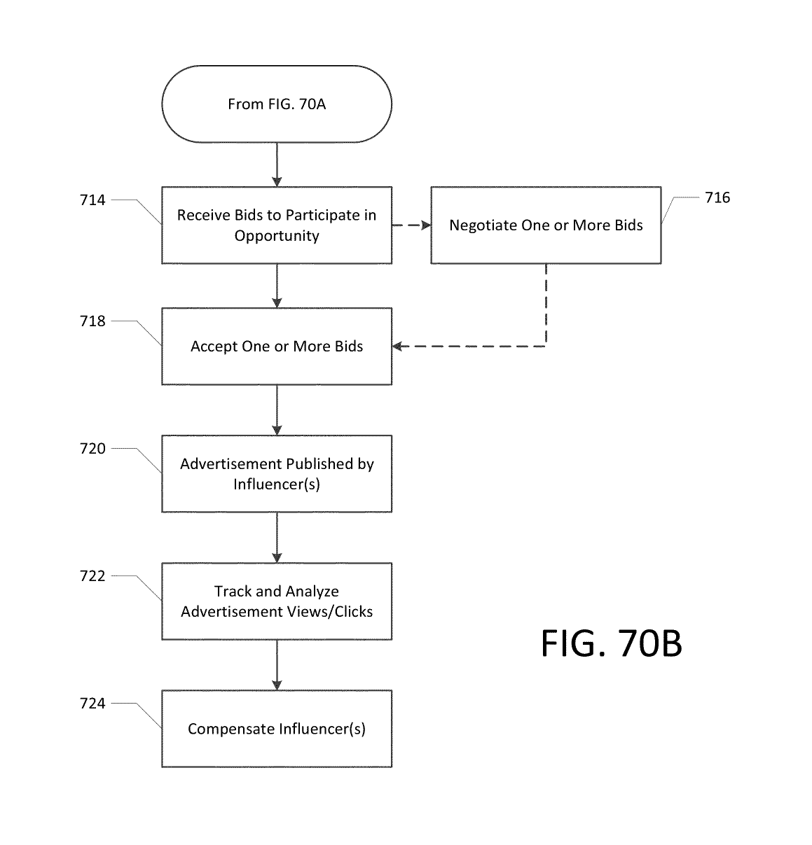

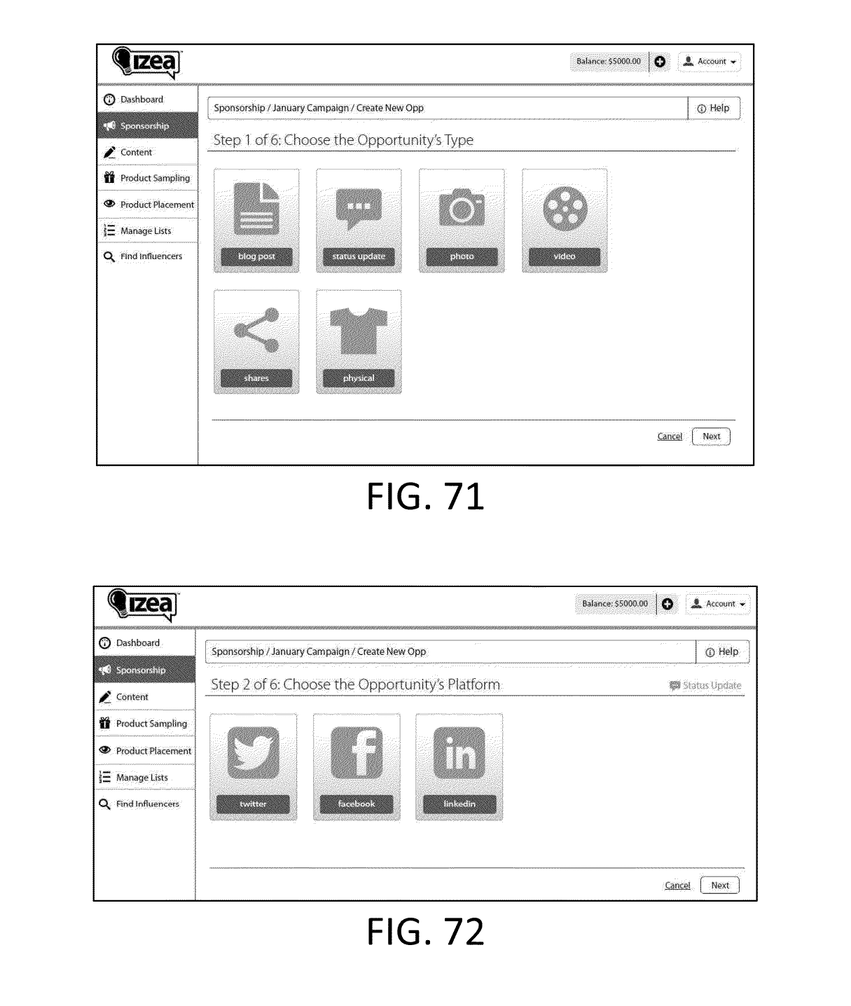

FIGS. 70A and 70B provide a flowchart illustrating various processes and operations that may be completed in the creation and management of an advertising opportunity by an advertiser, according to various embodiments. At step 702, the advertiser (e.g., operating an advertiser computing entity 110) selects a type of opportunity for the advertising opportunity, as shown in FIGS. 30 and 71. At step 704, the advertiser (e.g., operating an advertiser computing entity 110) may select a platform for the advertising opportunity, as shown in FIGS. 31 and 72.

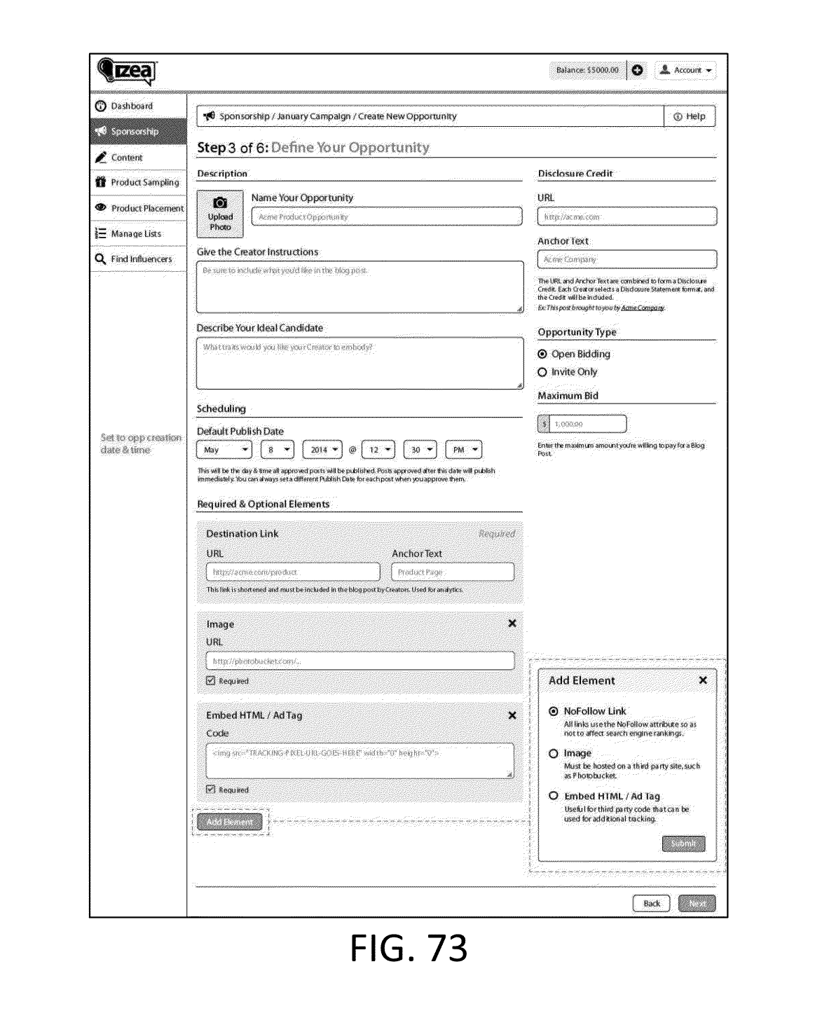

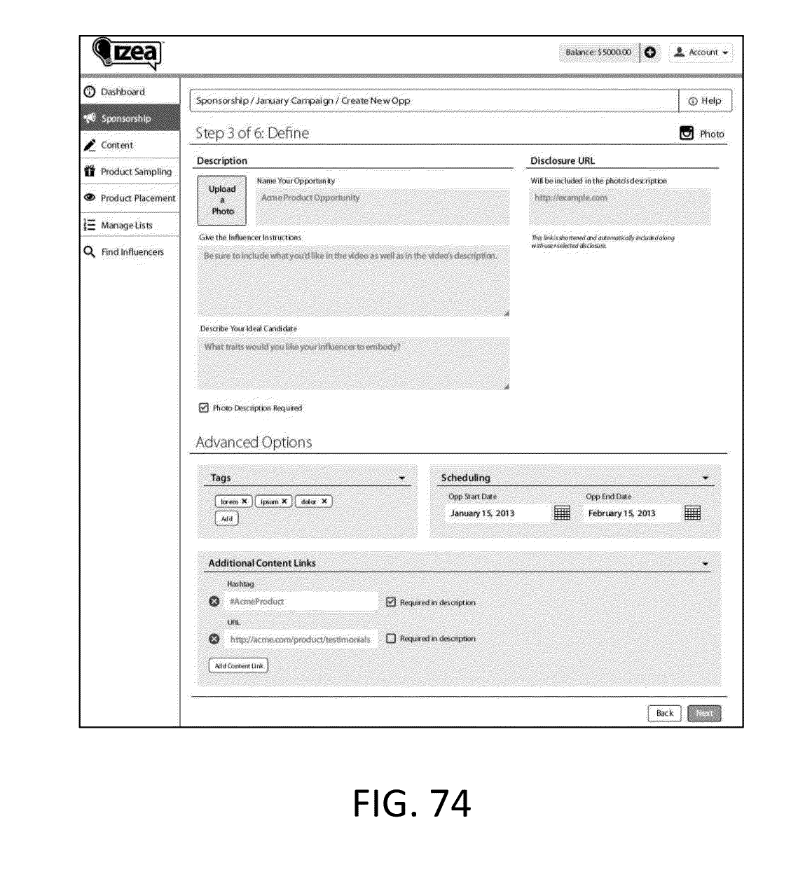

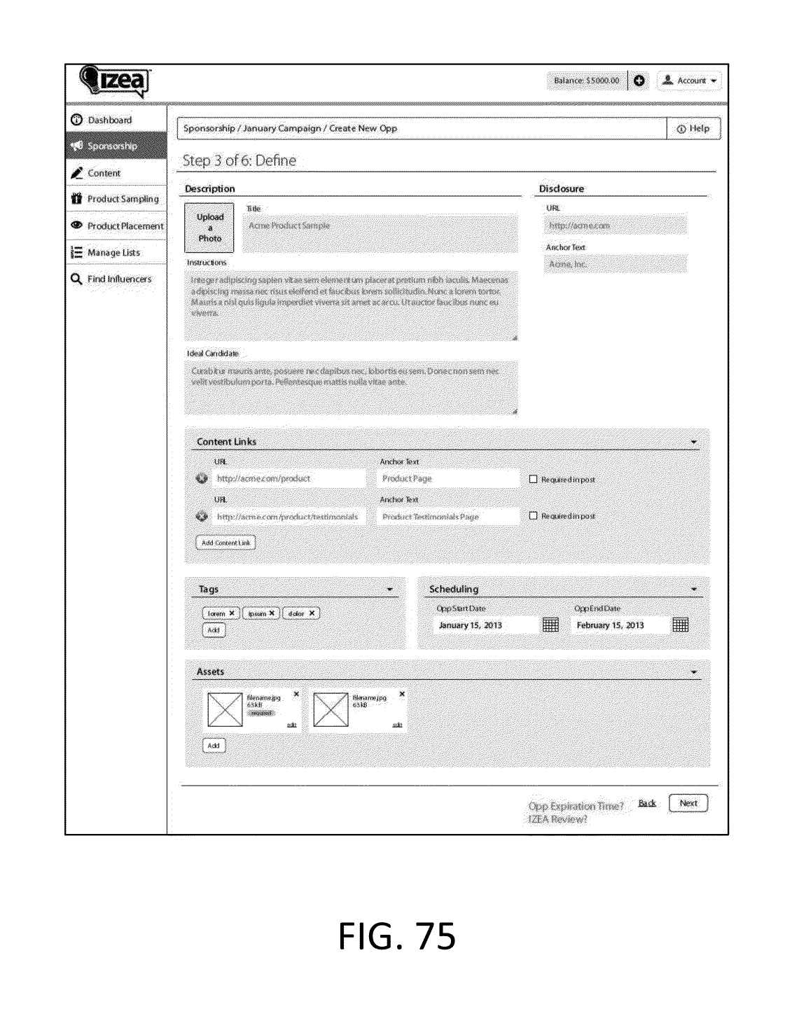

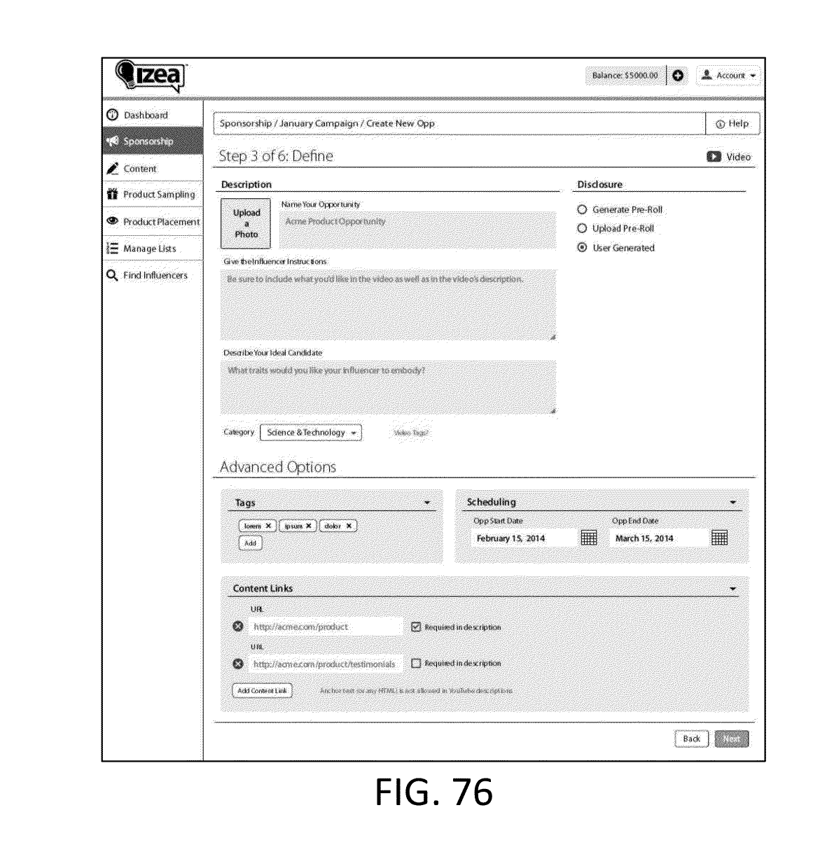

Step 706, the advertiser (e.g., operating an advertiser computing entity 110) may define the opportunity. FIG. 73 illustrates an example view of how an advertiser may define a “blog” type opportunity. FIG. 74 illustrates an example view of how an advertiser may define a “photo” type opportunity. FIG. 75 shows how an advertiser may define a “status update” type opportunity. FIGS. 76-78A and 78B show how an advertiser may define a “video” type opportunity.

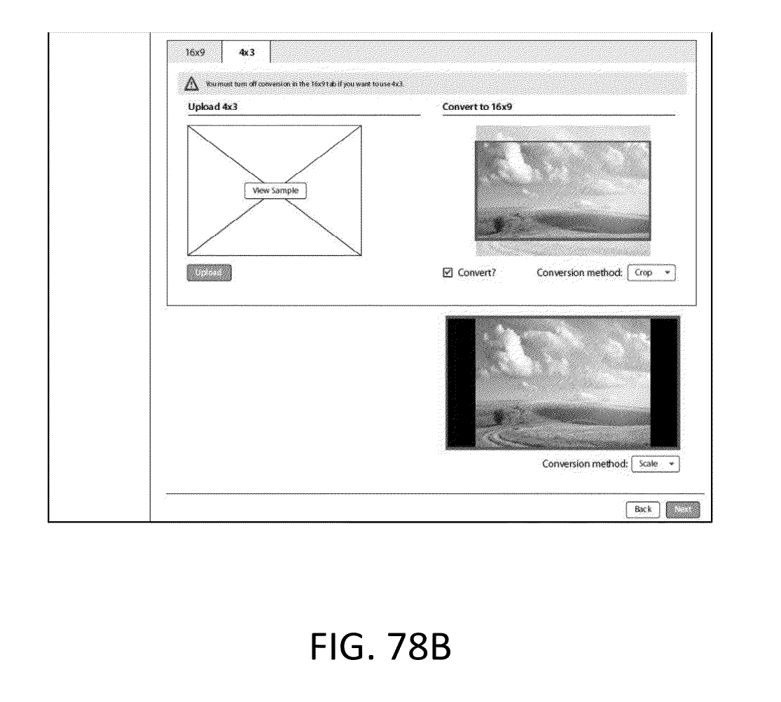

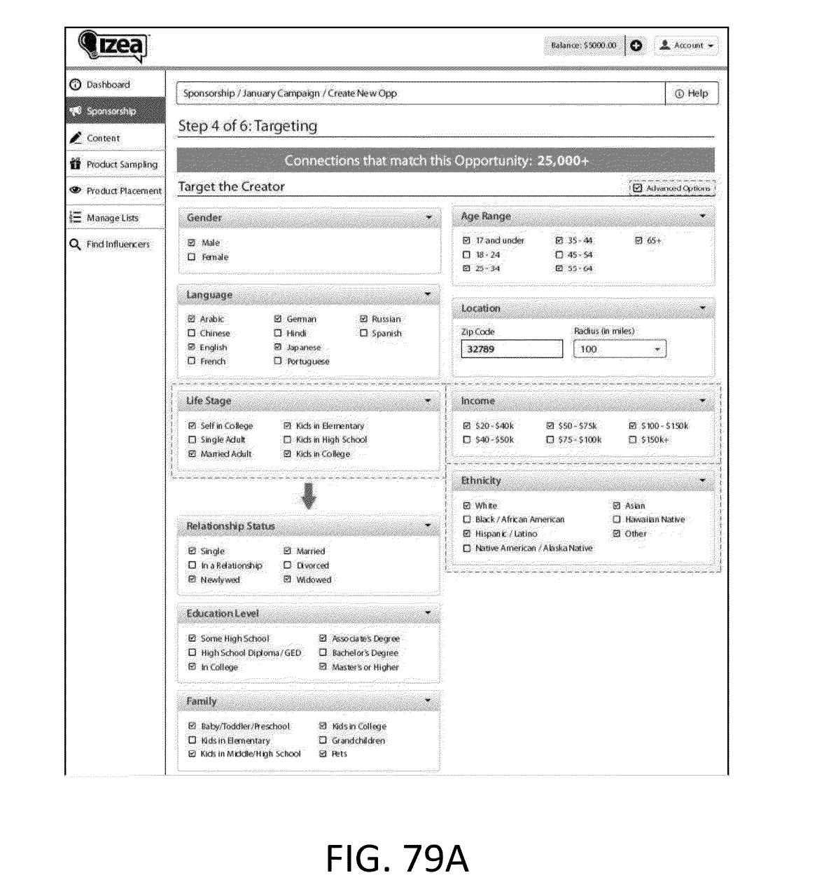

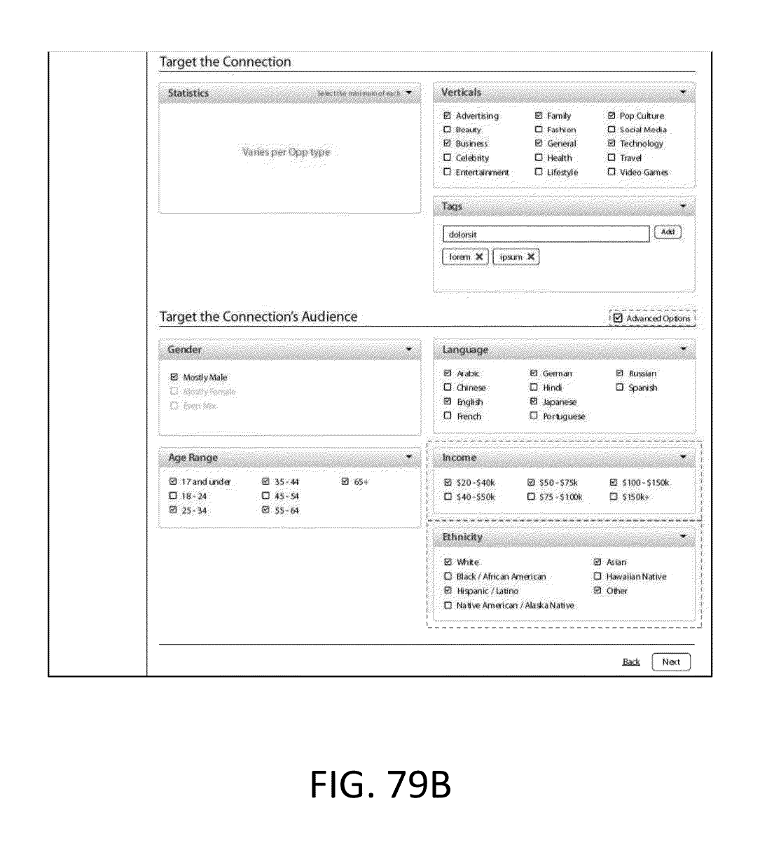

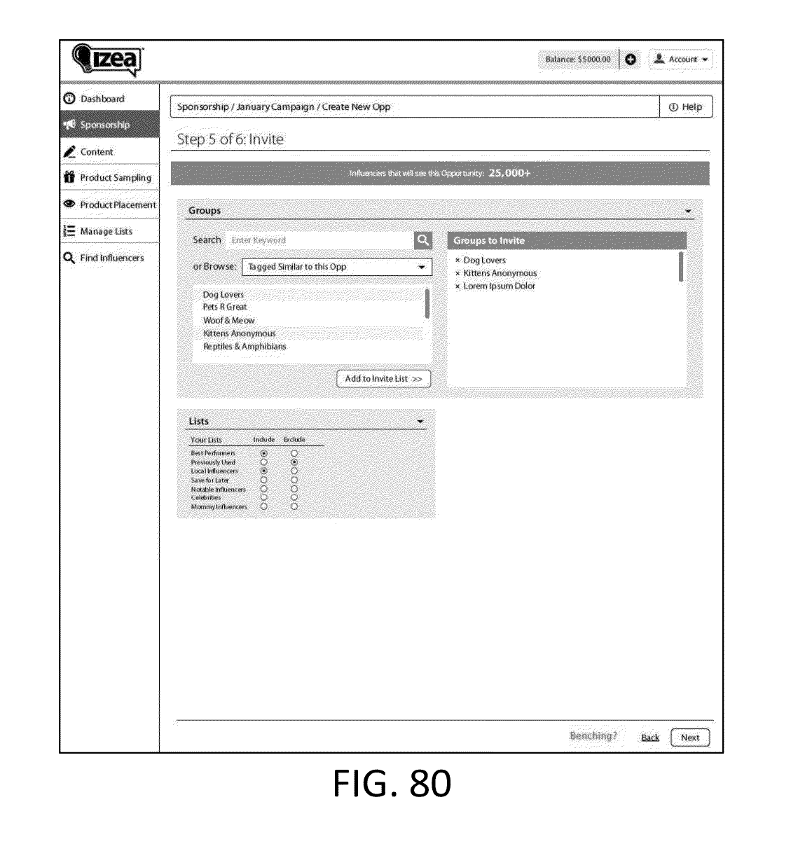

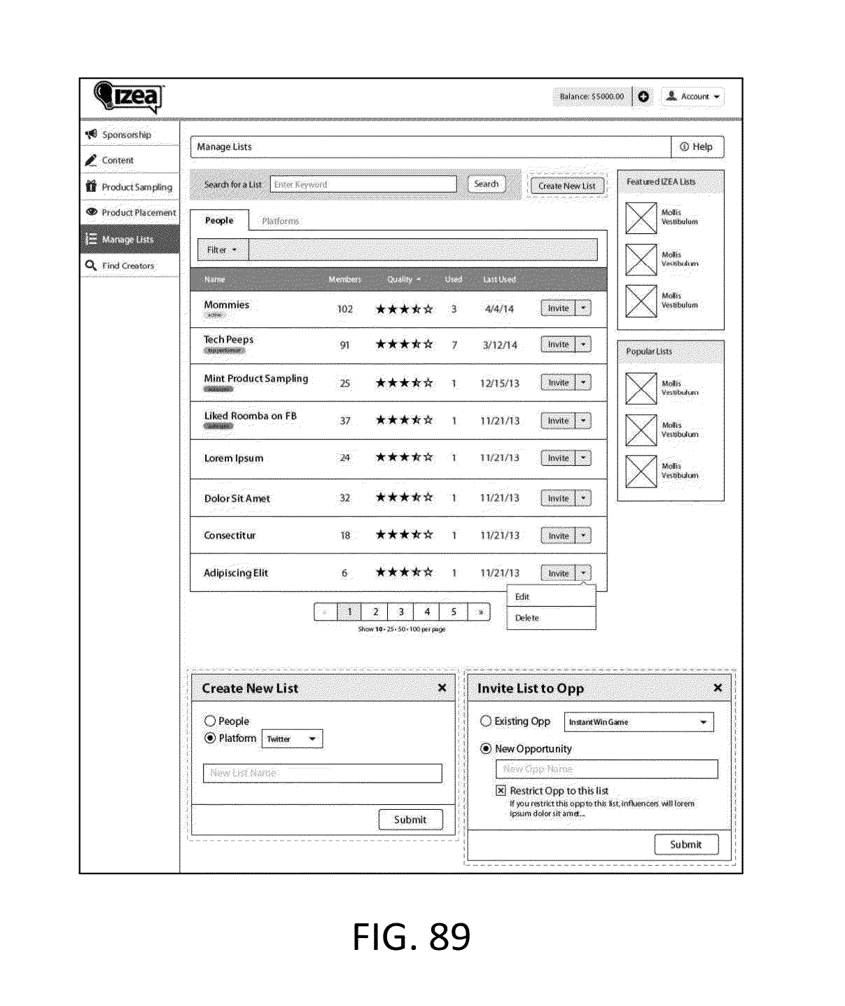

At step 708, the advertiser (e.g., operating an advertiser computing entity 110) may provide information regarding the type of influencer/publisher/creator the advertiser would like to participate in the advertising opportunity, as shown in FIGS. 79A and 79B. At step 710, the advertiser (e.g., operating an advertiser computing entity 110) may invite/notify influencers/publishers/creators to participate in the advertising opportunity. As shown in FIG. 80, the influencers/publishers/creators may be invited/notified one or more lists that may be managed by the advertiser. FIGS. 89-96B illustrate various ways in which an advertiser (e.g., operating an advertiser computing entity 110) may search for influencers/creators/publishers and/or create and/or manage lists of influencers/creators/publishers that may be invited/notified to participate in one or more advertising opportunities based on the demographics and/or audience associated with the influencer/creator/publisher and/or the list of influencers/creators/publishers.

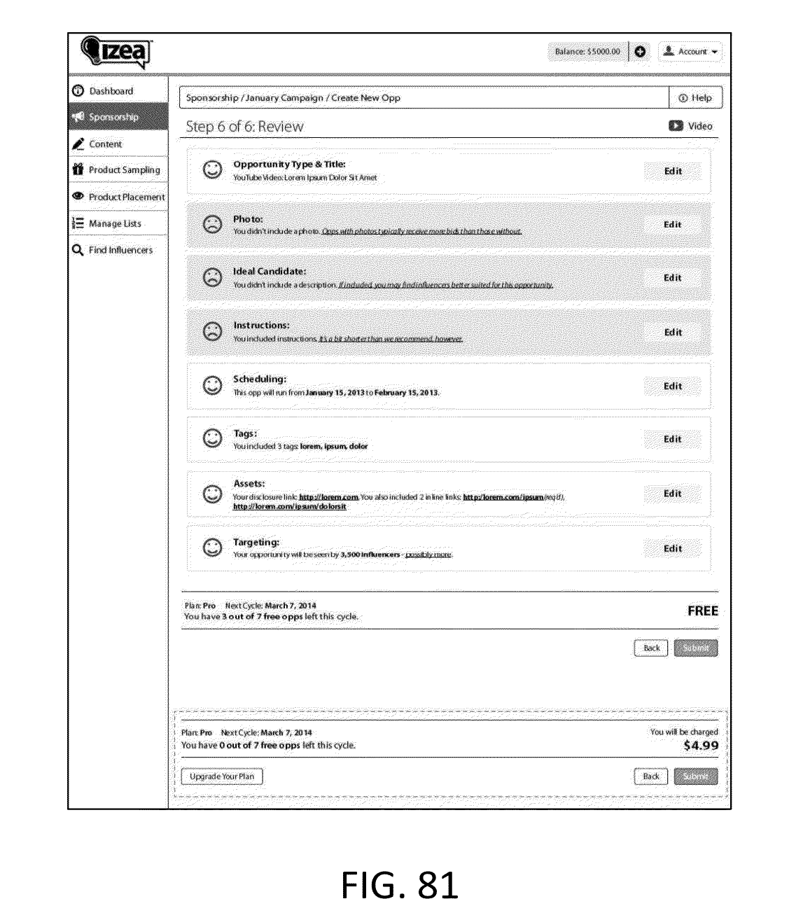

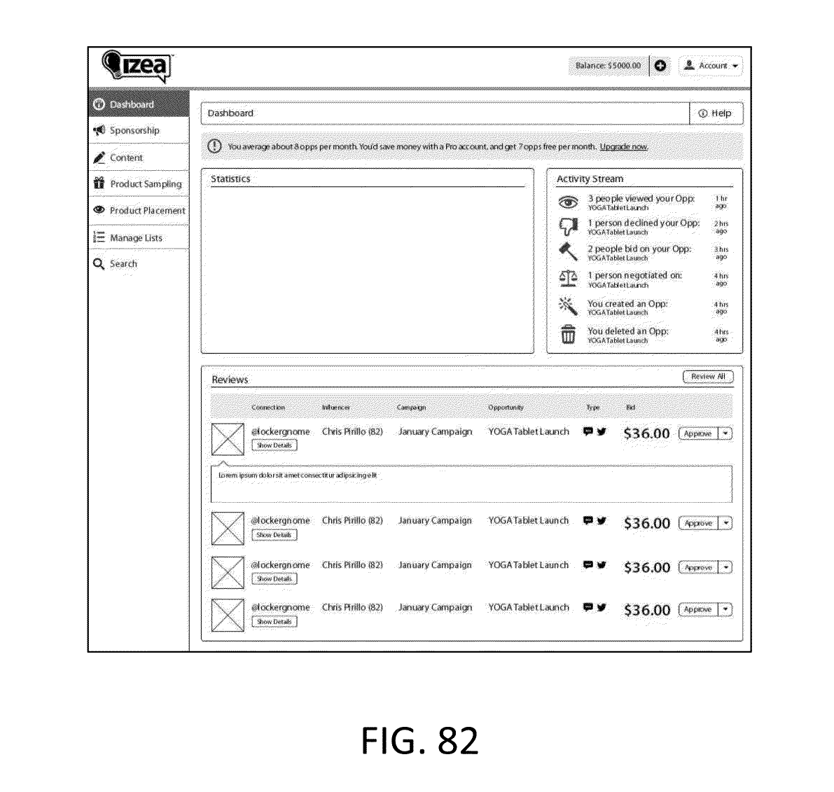

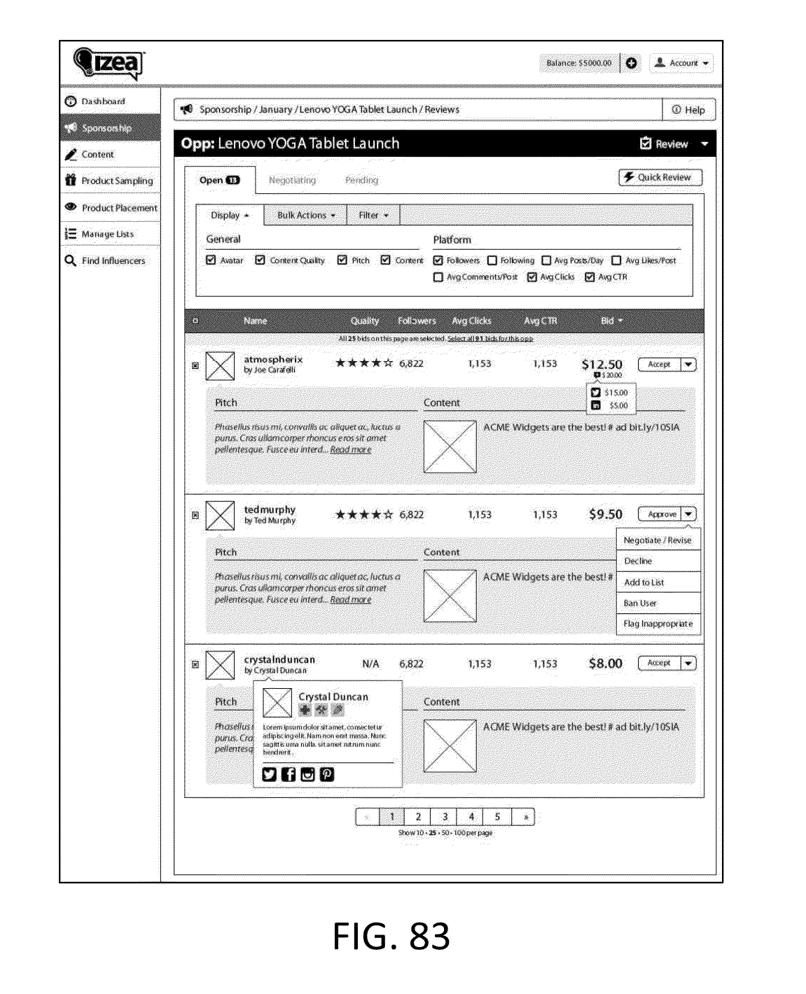

At step 712, the advertiser (e.g., operating an advertiser computing entity 110) may review the advertising opportunity, edit as necessary, and submit the advertising opportunity (e.g., to the enterprise computing entity 100), as shown in FIG. 81. At step 714, the enterprise computing entity 100 may receive one or more bids for participation in the advertising opportunity. In various embodiments, the one or more bids may be provided by influencers/creators/publishers operating influencer/publisher computing entities 105. In various embodiments, each bid may be accompanied by a pitch (e.g., why the influencer/creator/publisher) thinks that he/she/it is a good fit for the advertising opportunity) and/or content (e.g., a proposed blog post, status update, and/or the like). The one or more bids and corresponding pitches and/or content may be provided to the advertiser via the advertiser computing entity 110, as shown in FIG. 82. At step 716, according to some embodiments, the advertiser (e.g., operating an advertiser computing entity 110) and/or an influencer/creator/publisher (e.g., operating an influencer/publisher computing entity 105) may negotiate one or more bids related to one or more advertising opportunities, as shown in FIGS. 83, 84, and 85A-85C.

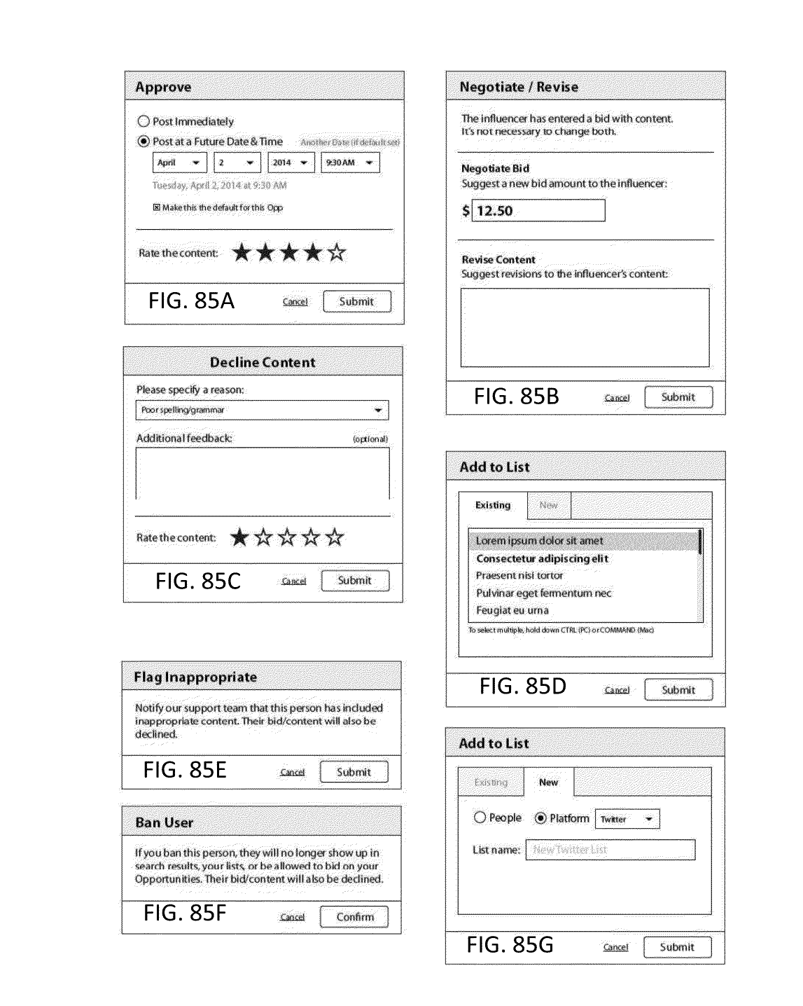

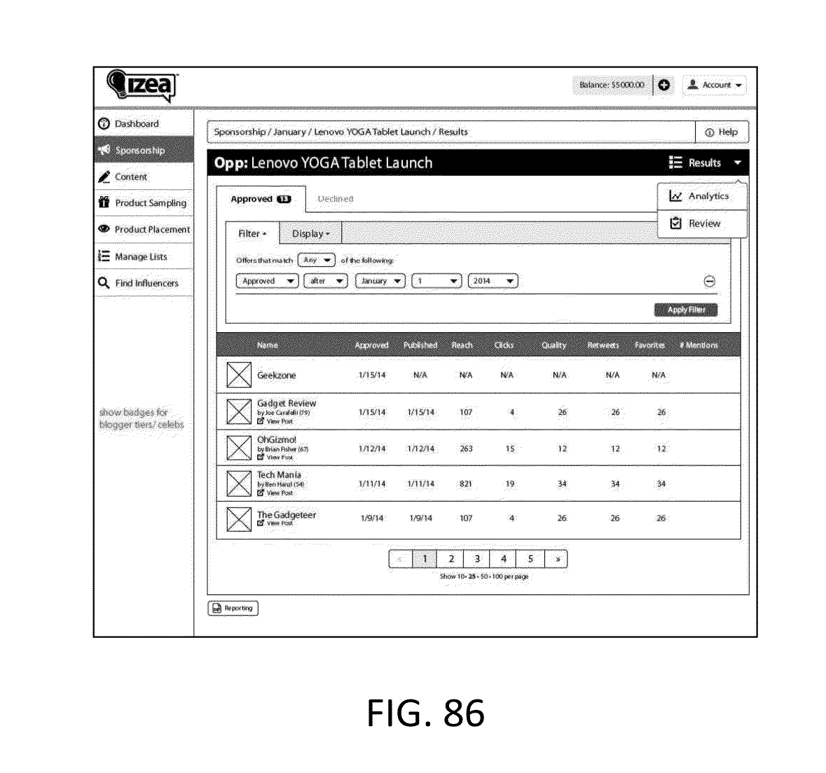

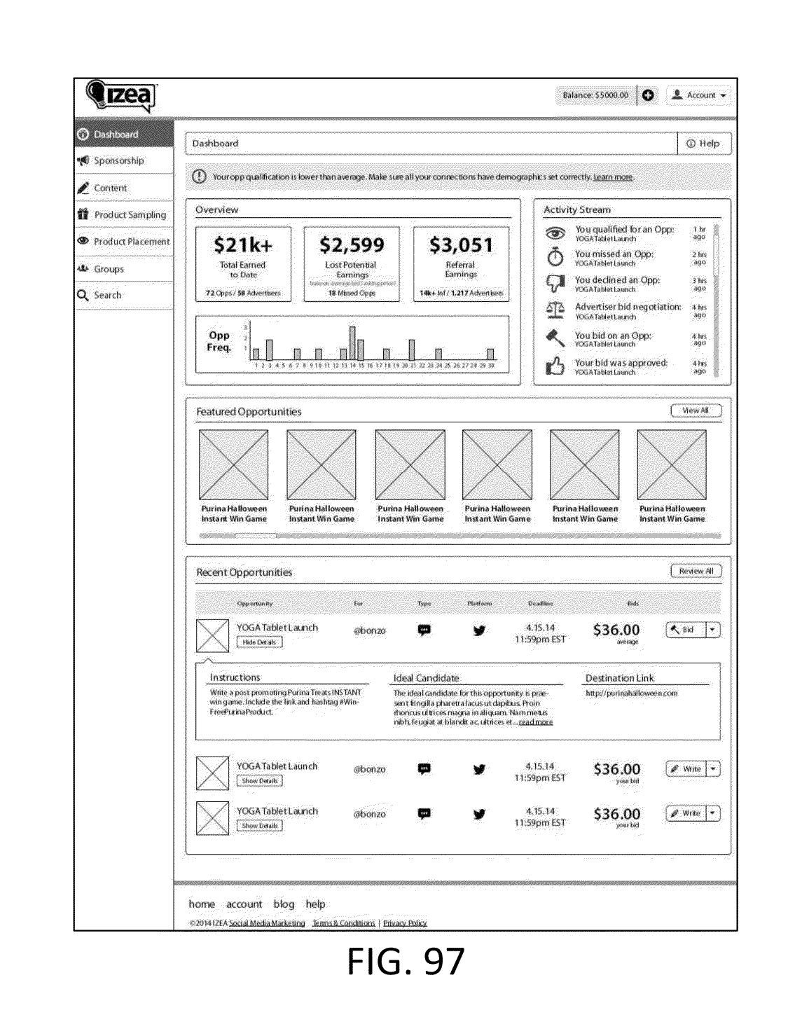

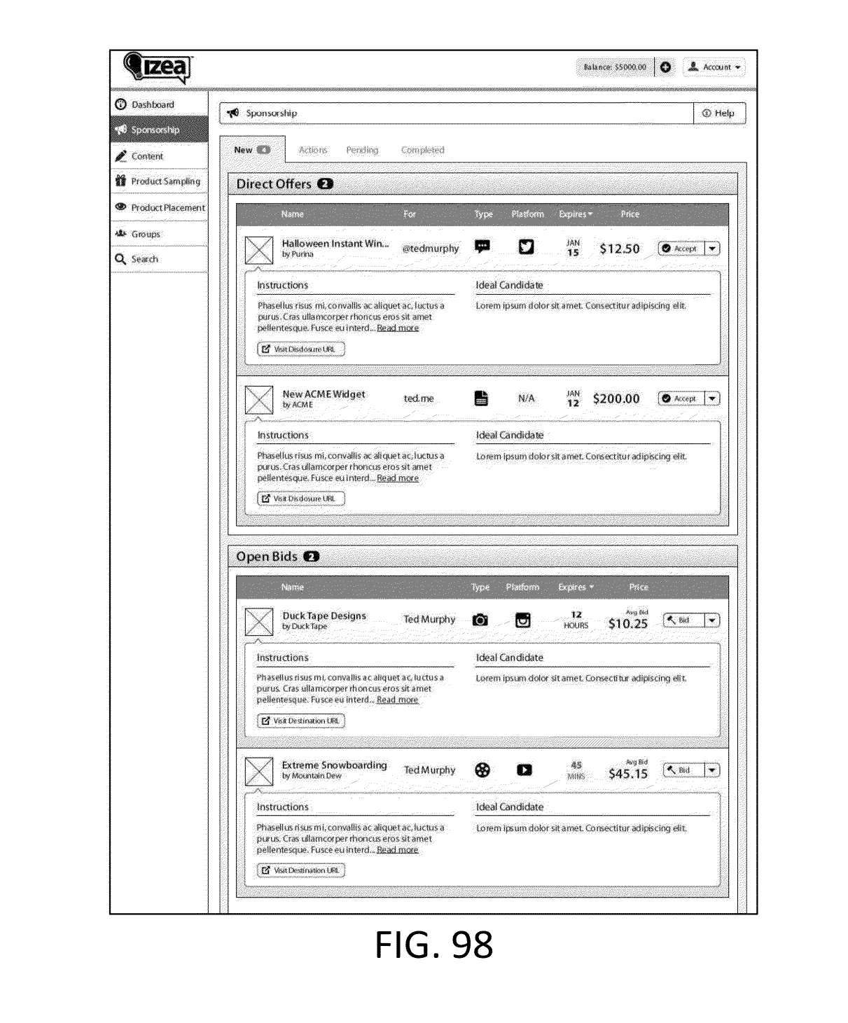

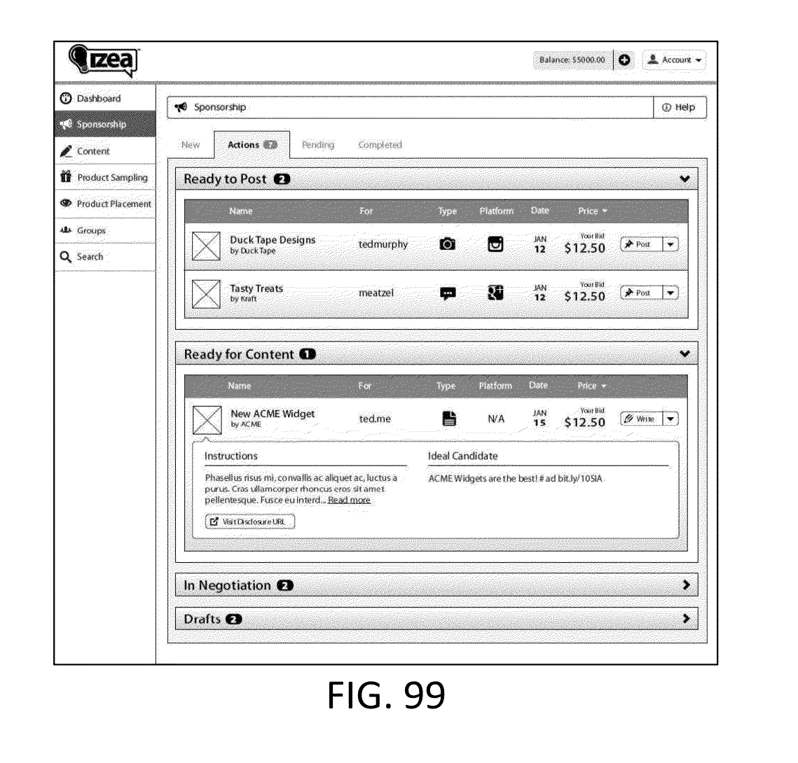

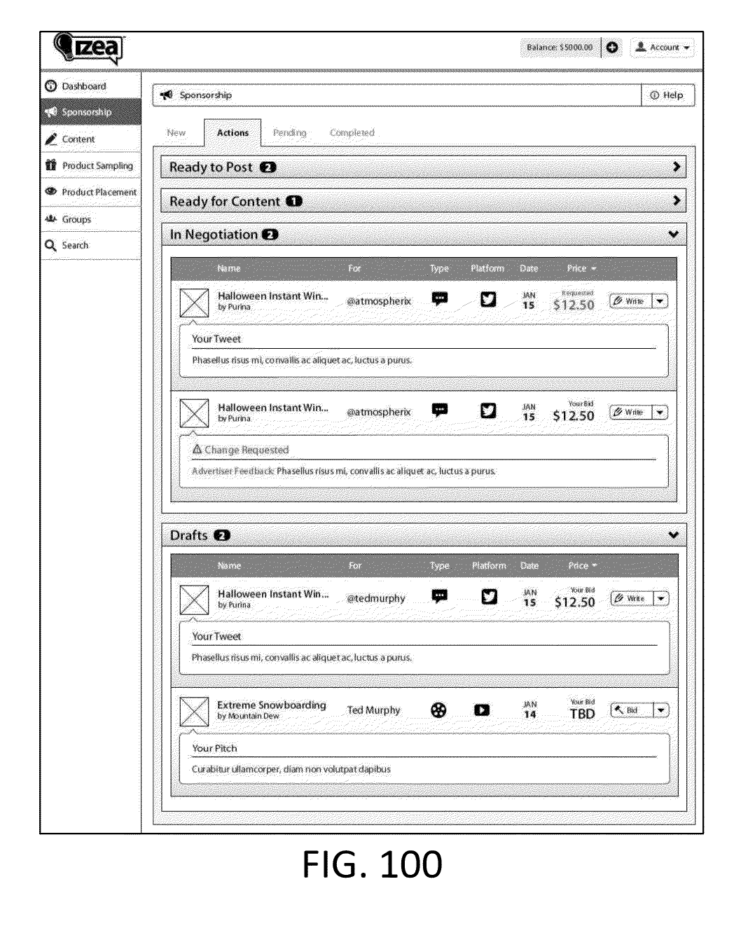

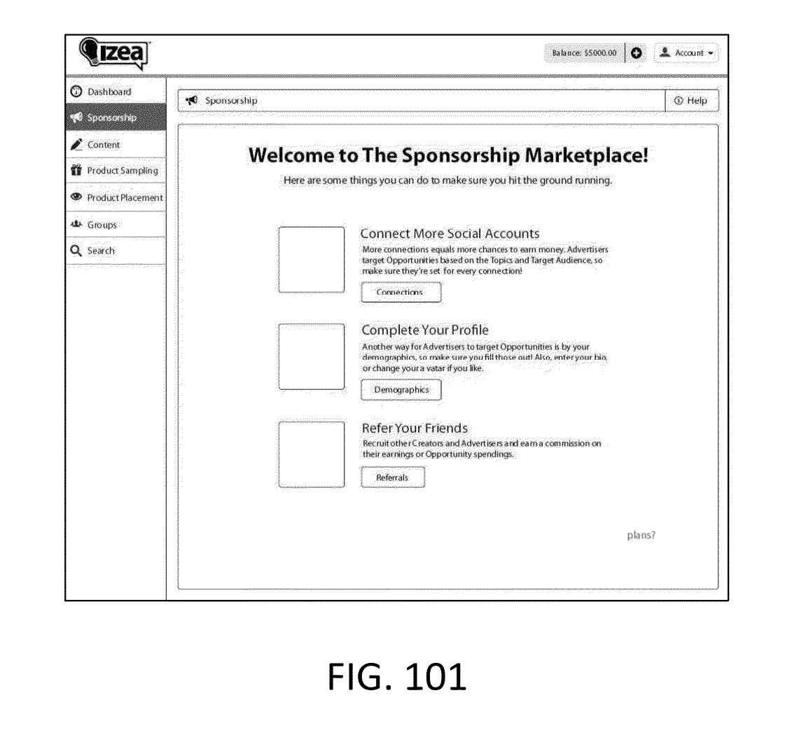

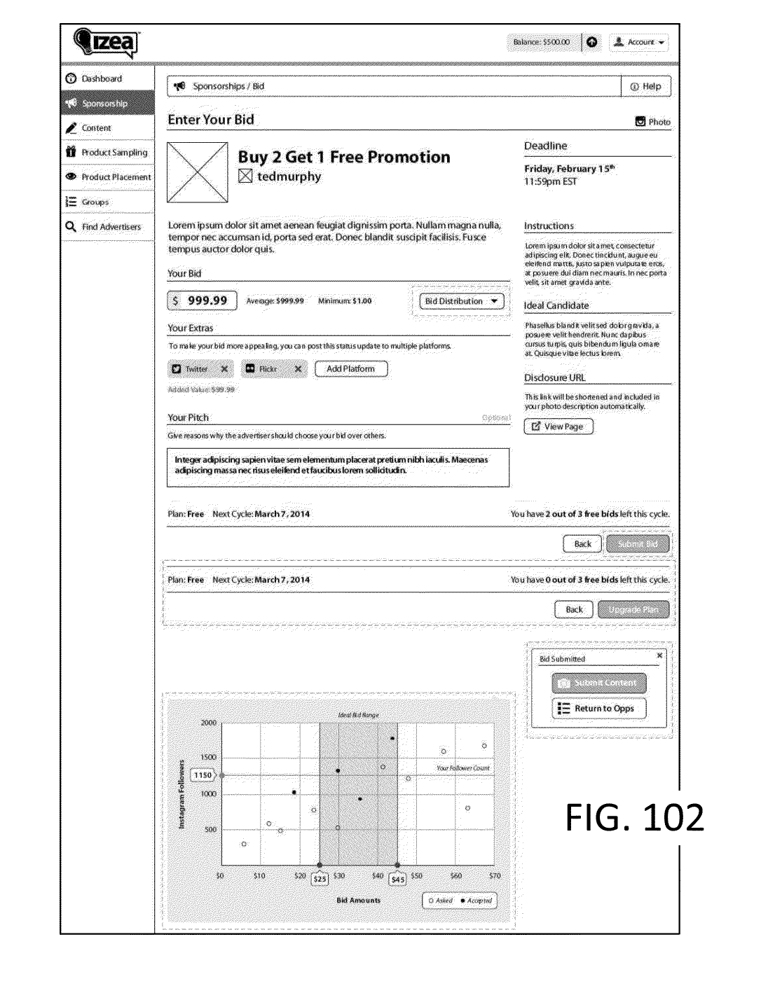

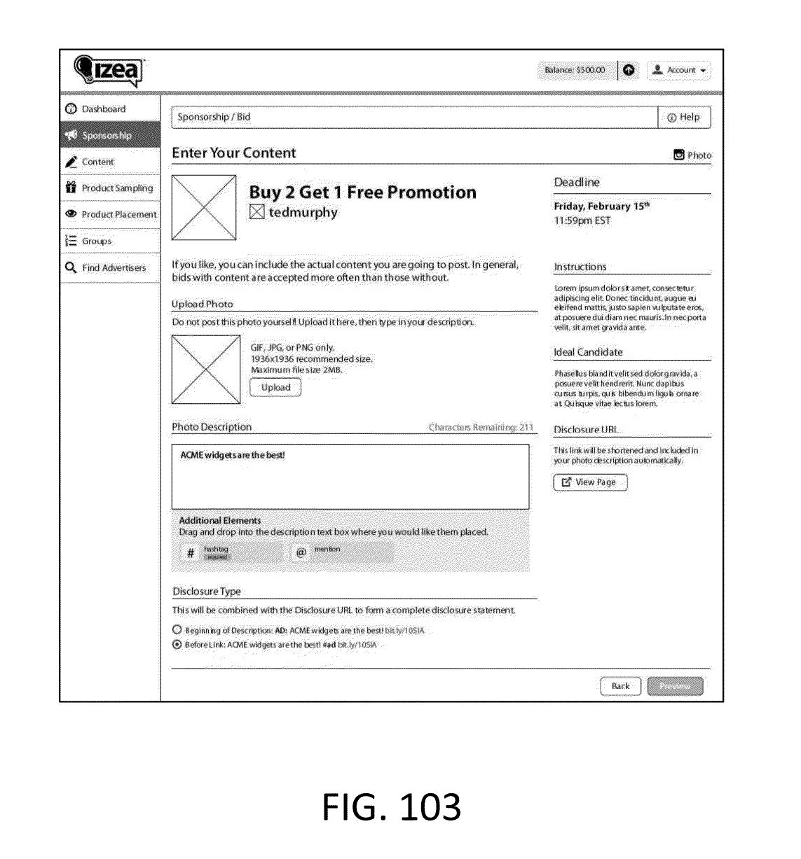

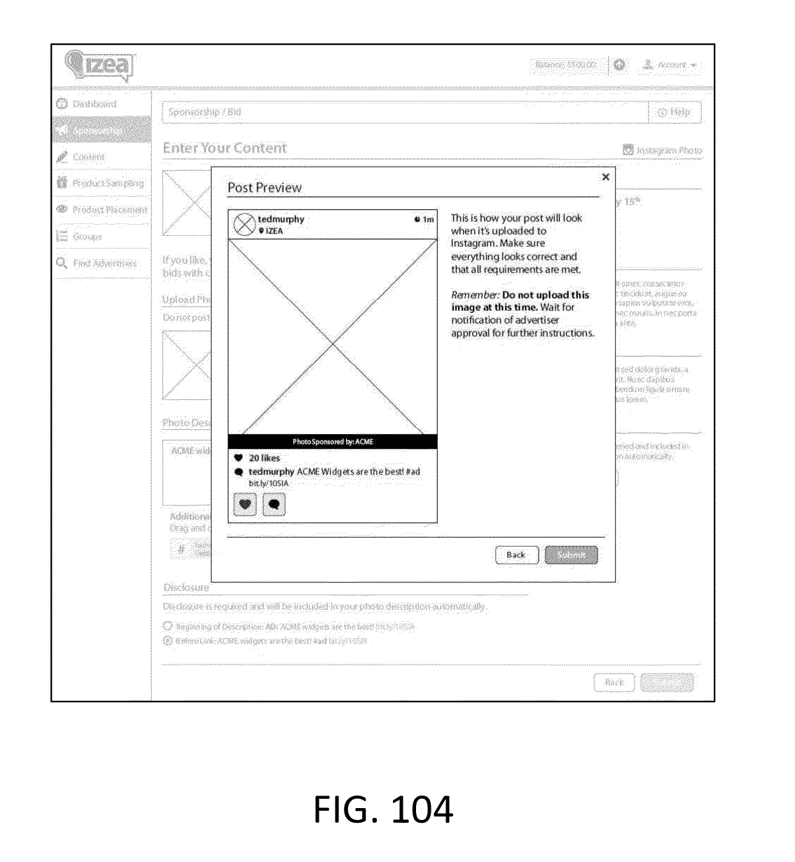

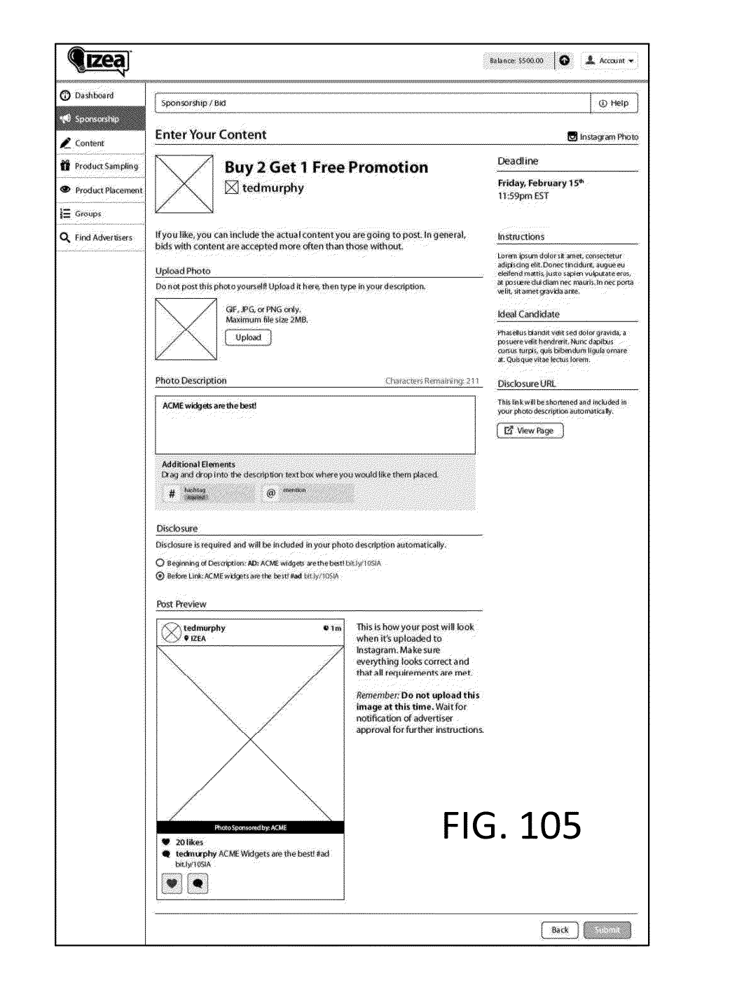

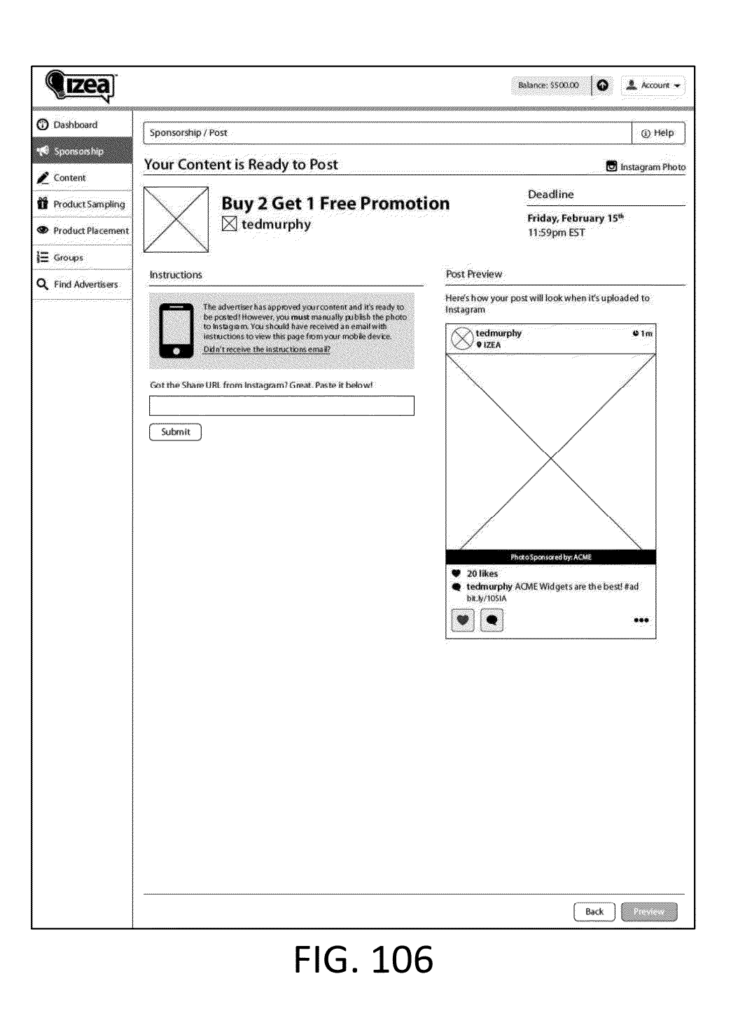

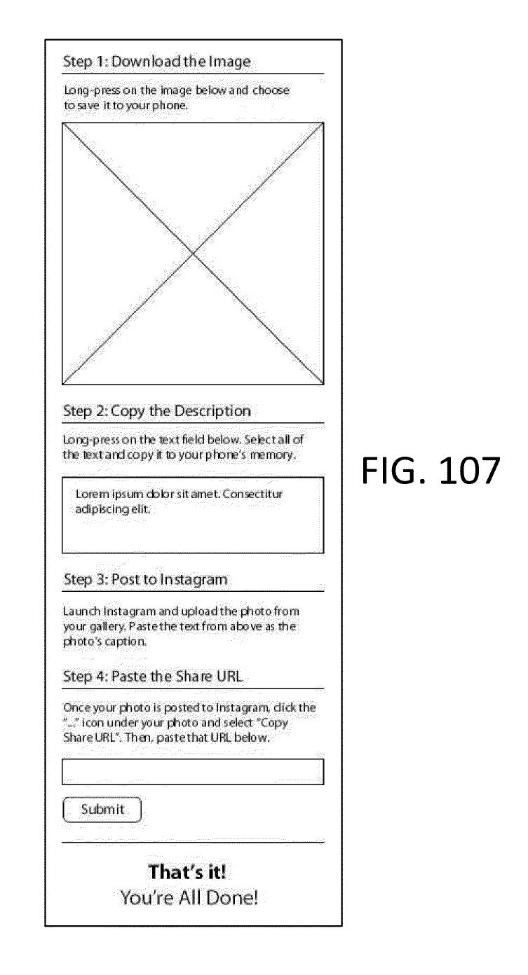

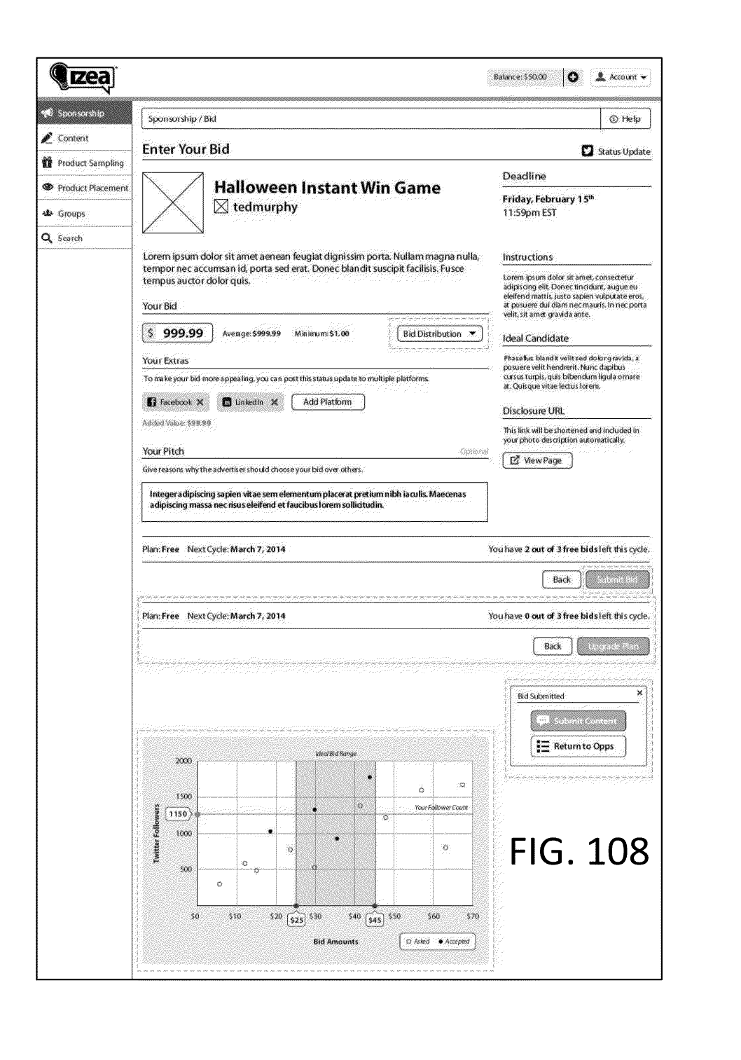

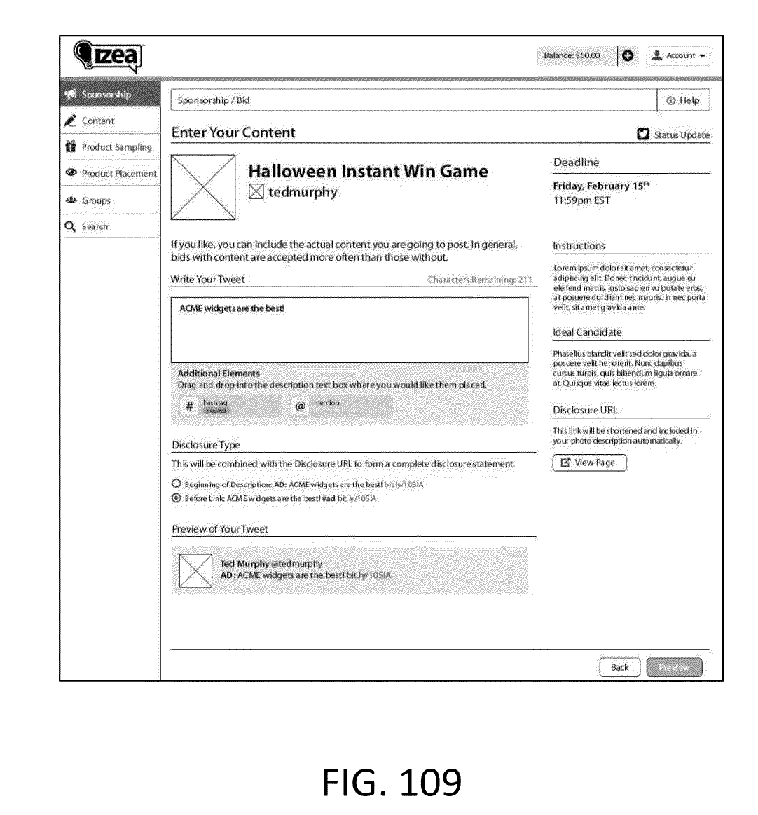

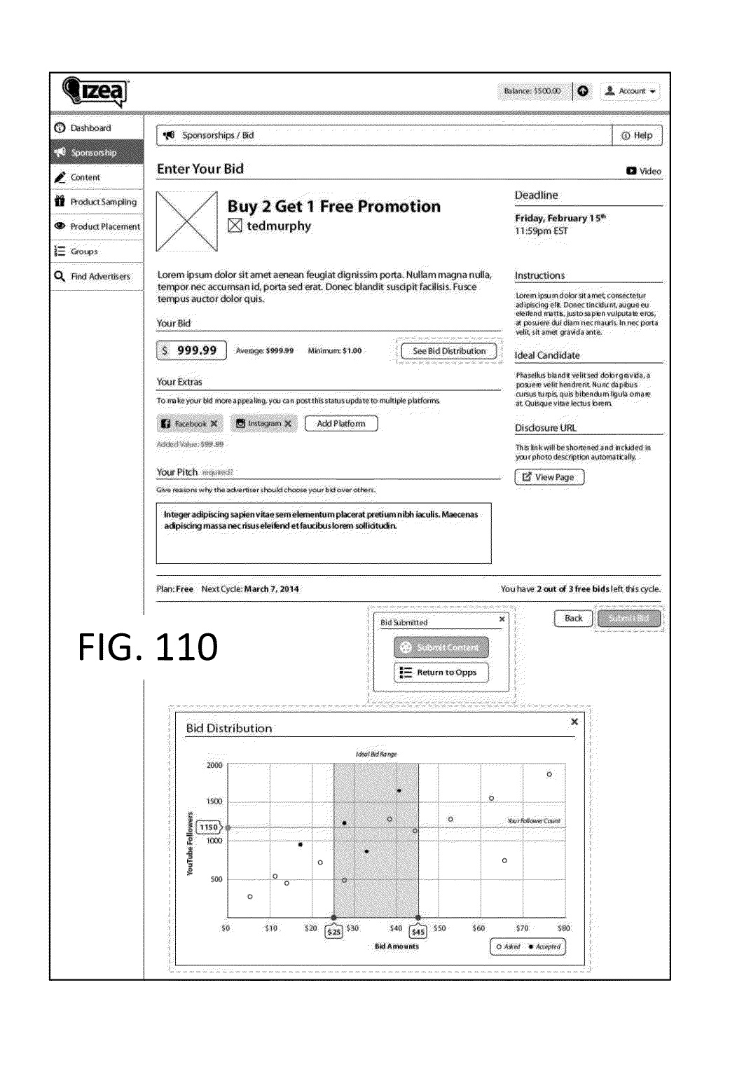

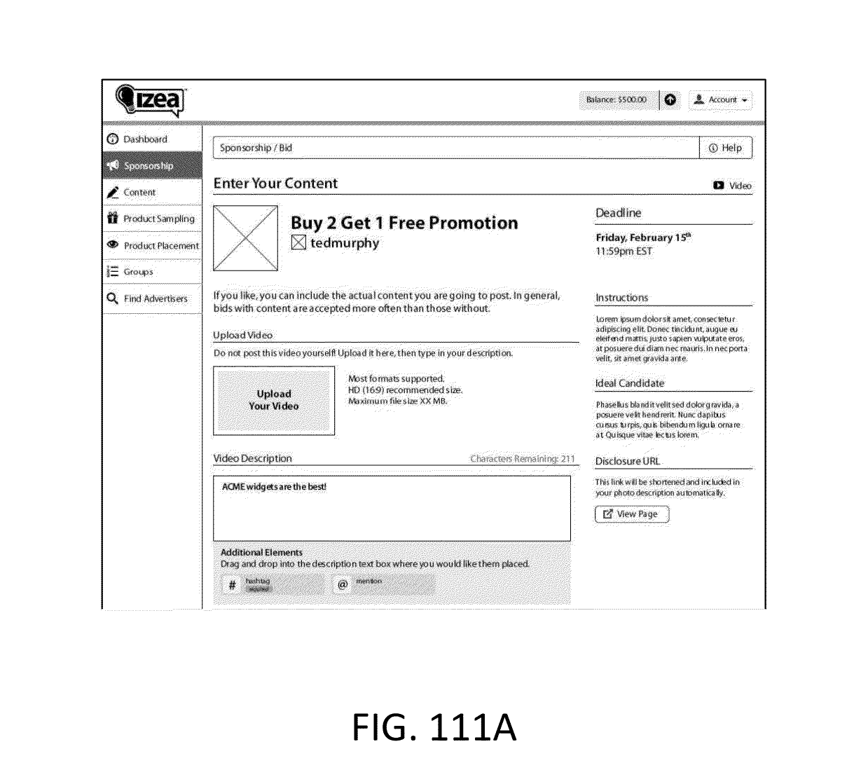

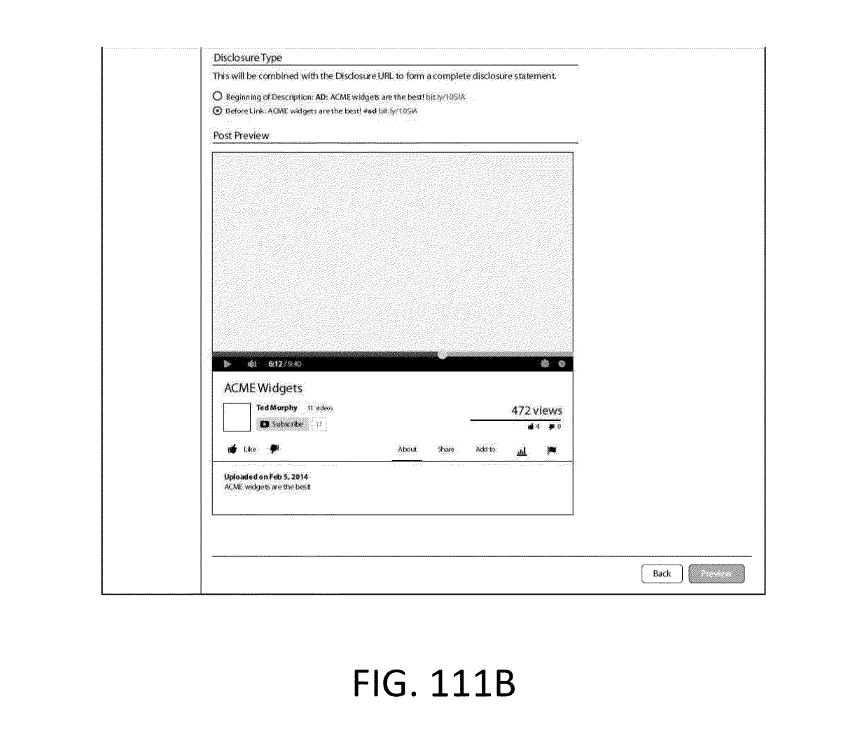

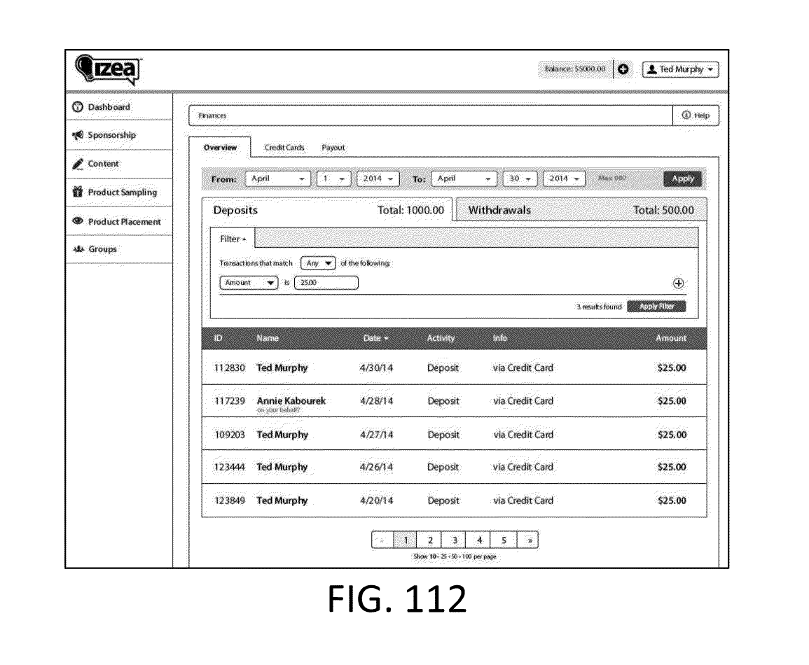

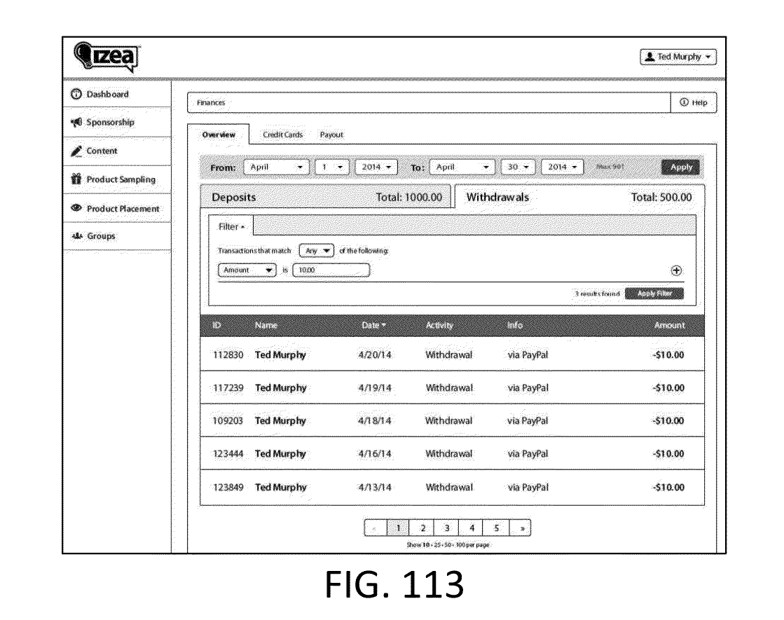

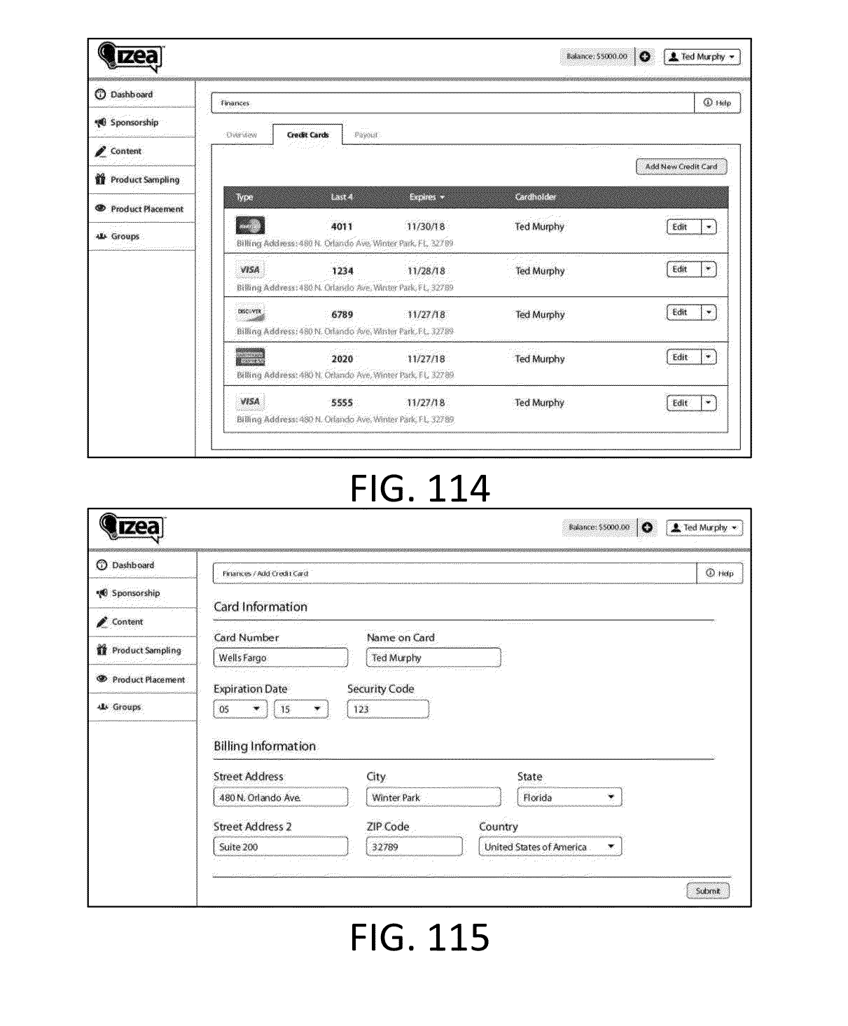

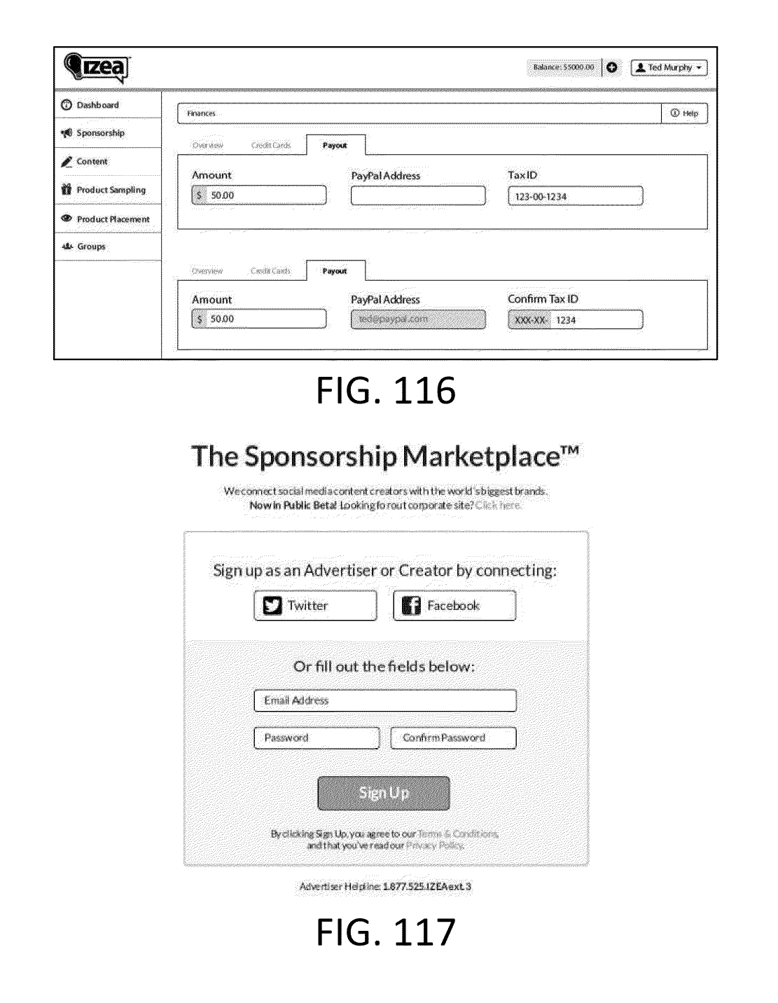

At step 718, the advertiser (e.g., operating an advertiser computing entity 110), may accept on or more bids or modified bids, as illustrated in FIG. 85A. At step 720, the content of the advertisement is published by the influencer/creator/publisher (e.g., the instructions for carrying out the advertising opportunity are carried). For example, an influencer/creator/publisher whose bid was approved/accepted will publish (e.g., post, tweet, update, text, message, share, and/or similar words used herein interchangeably) the blog post, video, status update, photo, and/or the like. At step 722, the enterprise computing entity 100 may track/determine information related to views of published advertisements (e.g., number of views, number of clicks, location of individuals viewing and/or clicking based on IP address or the like, and/or the like). FIGS. 86-88 illustrate some example information/data that may be collected/tracked/stored by the enterprise computing entity 100 and provided to the advertiser via the advertising computing entity 110. In various embodiments, information/data may be collected/tracked for individual influencers/creators/publishers. At step 724, the enterprise computing entity 100 may facilitate payment of the influencers/creators/publishers that participated in the advertising opportunity (and the debiting of an account associated with the advertiser) responsive to determining that the instructions for the advertising computing entity were carried out. FIGS. 112-116 illustrate various example views associated with providing payment to the influencers/creators/publishers. FIGS. 97-111A and 111B illustrate various views that may be provided to an influencer/creator/publisher (e.g., operating an influencer/publisher computing entity 105) by the enterprise entity 100 as the influencer/creator/publisher finds, bids, and/or participates in one or more advertising opportunities.

### IV. CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for providing advertising opportunities, the method comprising:
receiving, via one or more processors, information associated with an advertising opportunity, wherein (a) the information comprises an opportunity type and instructions for carrying out the advertising opportunity and (b) the advertising opportunity is associated with an advertiser profile;
receiving, via the one or more processors, one or more bids associated with the advertising opportunity, wherein each of the one or more bids is associated with an influencer profile;
providing, via the one or more processors, a notification that the one or more bids have been received, the notification provided in accordance with the advertiser profile; and
receiving, via the one or more processors, input indicating advertiser approval of at least one of the one or more bids.

2. The method of claim 1 further comprising providing notifications inviting the one or more influencers to bid on the advertising opportunity.

3. The method of claim 1 further comprising:
receiving a modified bid associated with the advertising opportunity; and
providing a notification of the modified bid in accordance with advertiser profile.

4. The method of claim 1 further comprising:
determining whether the advertising opportunity was carried out by an influencer of an approved bid in accordance with the instructions for carrying out the advertising opportunity; and
responsive to determining that the advertising opportunity was carried out by an influencer of an approved bid in accordance with the instructions for carrying out the advertising opportunity, providing payment to an account associated with the influencer.

5. The method of claim 4 further comprising:
tracking one or more statistics associated with the advertising opportunity for a predetermined time period before providing the payment.

6. A system for providing advertising opportunities, the system comprising:
at least one memory storage area, the at least one memory storage area configured to store at least one or more advertiser profiles and one or more influencer profiles; and
at least one processor, the at least one processor configured to at least:
receive information associated with an advertising opportunity, wherein (a) the information comprises an opportunity type and instructions for carrying out the advertising opportunity and (b) the advertising opportunity is associated with one of the one or more advertiser profiles;
receive one or more bids associated with the advertising opportunity, wherein each of the one or more bids is associated with one of the one or more influencer profiles;
provide a notification that the one or more bids have been received, the notification provided in accordance with the one of the one or more advertiser profiles; and
receive input indicating advertiser approval of at least one of the one or more bids.

7. The system of claim 6, wherein the at least one processor is further configured to provide notifications inviting the one or more influencers to bid on the advertising opportunity.

8. The system of claim 6, wherein the at least one processor is further configured to:
receive a modified bid associated with the advertising opportunity; and
provide a notification of the modified bid in accordance with advertiser profile.

9. The system of claim 6, wherein the at least one processor is further configured to:
determine whether the advertising opportunity was carried out by an influencer of an approved bid in accordance with the instructions for carrying out the advertising opportunity; and
responsive to determining that the advertising opportunity was carried out by an influencer of an approved bid in accordance with the instructions for carrying out the advertising opportunity, provide payment to an account associated with the influencer.

10. The system of claim 9, wherein the at least one processor is further configured to track one or more statistics associated with the advertising opportunity for a predetermined time period before providing the payment.

11. A non-transitory computer program product comprising at least one computer-readable storage medium having computer-readable program code portions embodied therein, the computer-readable portions comprising:
an executable portion configured for receiving a plurality of data, wherein said data comprises:
user profile data associated with one or more advertiser profiles; and
user profile data associated with one or more influencer profiles;
an executable portion configured for receiving information associated with an advertising opportunity, wherein (a) the information comprises an opportunity type and instructions for carrying out the advertising opportunity and (b) the advertising opportunity is associated with one of the one or more advertiser profiles;
an executable portion configured for receiving one or more bids associated with the advertising opportunity, wherein each of the one or more bids is associated with one of the one or more influencer profiles;
an executable portion configured for providing a notification that the one or more bids have been received, the notification provided in accordance with the one of the one or more advertiser profiles; and
an executable portion configured for receiving input indicating advertiser approval of at least one of the one or more bids.

12. The computer program product of claim 11 further comprising an executable portion configured for providing notifications inviting the one or more influencers to bid on the advertising opportunity.

13. The computer program product of claim 11 further comprising:
an executable portion configured for receiving a modified bid associated with the advertising opportunity; and
an executable portion configured for providing a notification of the modified bid in accordance with advertiser profile.

14. The computer program product of claim 11 further comprising:
an executable portion configured for determining whether the advertising opportunity was carried out by an influencer of an approved bid in accordance with the instructions for carrying out the advertising opportunity; and
an executable portion configured for, responsive to determining that the advertising opportunity was carried out by an influencer of an approved bid in accordance with the instructions for carrying out the advertising opportunity, providing payment to an account associated with the influencer.

15. The computer program product of claim 14 further comprising an executable portion configured for tracking one or more statistics associated with the advertising opportunity for a predetermined time period before providing the payment.
